(19) United States
(12) Patent Application Publication
(10) Pub. No.: US 2026/0329872 A1
(43) Pub. Date: Oct. 22, 2026

(54) SYSTEM

(71) Applicant: SoftBank Group Corp., Tokyo (JP)

(72) Inventor: Nobuyoshi KAWAI, Tokyo (JP)

(73) Assignee: SoftBank Group Corp., Tokyo (JP)

(21) Appl. No.: 19/648,516

(22) Filed: Apr. 15, 2026

(30) Foreign Application Priority Data
Apr. 22, 2025 (JP) 2025-070252

(51) Int. Cl. G06F 16/2457; G06F 16/22; G06F 21/62

(52) U.S. Cl. CPC G06F 16/24578; G06F 16/2237; G06F 21/6218

(57) ABSTRACT

The present invention relates to a system for streamlining response to legal revisions and achieving both reduction of a risk of legal violation and creation of a new business opportunity. Using generative AI, related documents such as revised legal texts and guidelines are automatically analyzed to extract and summarize main points, and matched with a business content database of each department in a company to automatically specify an affected department, and a necessary operation change proposal, material modification proposal, new business proposal, material for a briefing session, FAQ, script for a briefing session, and the like are automatically generated for each department. Furthermore, question and answer by a chatbot and progress/history/notification management are also unitarily realized, and all processes of the response to the legal revisions are comprehensively and quickly supported.

### CROSS-REFERENCE TO RELATED APPLICATION

The present application claims priority to and incorporates by reference the entire contents of Japanese Patent Application No. 2025-070252 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is that, every time a legal revision occurs, each department in a company grasps and analyzes the contents of the revised law, determines the impact on the business, considers necessary response measures, and further performs a series of responses such as company-wide dissemination, operation change, material modification, implementation of a briefing session, and question and answer individually and manually, which takes an enormous amount of time and effort, easily causes omission of response and a risk of legal violation, and cannot fully utilize a new business opportunity created by the legal revision. Specifically, it includes a problem that collection, summarization, and analysis work of a wide variety of information such as revised legal texts, guidelines, public comments, and records of discussions during legislation is complicated, it is difficult to accurately grasp a relevance between business contents of each department and legal revision contents to specify an affected department, and it is difficult to quickly and accurately implement necessary operation change and material modification, creation of a dissemination material and a FAQ, creation of a script for a briefing session, question response after the briefing session, and the like for each affected department, a problem that discovery and proposal of a new business opportunity caused by the legal revision are postponed, and an offensive response to the legal revision is not sufficiently performed, and a problem that it is difficult to propose a specific response measure in line with actual conditions of operation and management in the affected department and to eradicate the risk of legal violation, and in order to solve all of these, an object is to automate and streamline all processes of the response to the legal revision utilizing generative AI, and to achieve both a defensive response and an offensive response.

### SUMMARY OF THE INVENTION

A means for solving the problem according to the present invention configures a system for supporting response to legal revisions, the system comprises a legal revision information acquisition unit, an affected department determination unit, and a response plan generation unit, the legal revision information acquisition unit has a function of automatically analyzing a plurality of legal revision-related documents such as revised legal texts, guidelines, public comments, and records of discussions during legislation using generative AI, and extracting and summarizing a purpose of revision, revision points, a time of enforcement, new rules to be complied with, and an impact on an industry, the affected department determination unit has a function of matching a business content database of a plurality of departments registered in a company with main points of the legal revision extracted by the legal revision information acquisition unit using generative AI, collating a relevance between business contents of each department and legal revision contents in units of keywords or business processes, automatically determining a department affected by the legal revision, and preferentially selecting a department with a high degree of impact, and the response plan generation unit has a function of proposing, for each department determined to be affected, an operation change proposal, a material modification proposal, and a modification proposal for an existing operation manual or internal regulations as a specific response plan based on the legal revision using generative AI, further proposing a new business opportunity newly enabled by the legal revision, additionally automatically generating a dissemination material of the legal revision contents, a FAQ draft, a script for a briefing session, and a time allocation proposal for each department, and immediately answering a question after the briefing session by a chatbot using generative AI, whereby all processes of the response to the legal revision are unitarily and efficiently automated, omission of response and a risk of legal violation are reduced, discovery and proposal of a new business opportunity caused by the legal revision are promoted, and both a defensive response and an offensive response are achieved.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

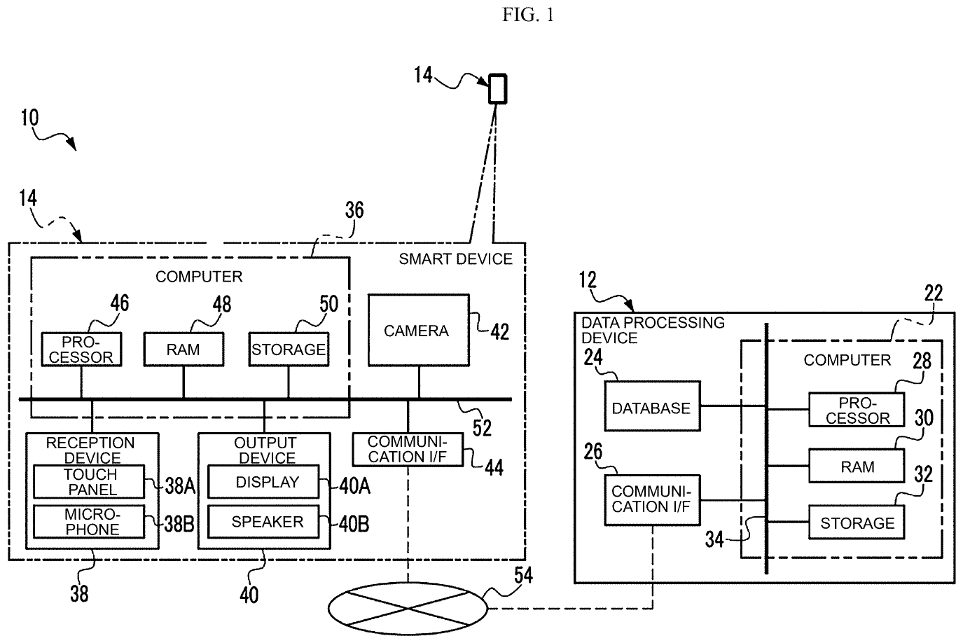

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

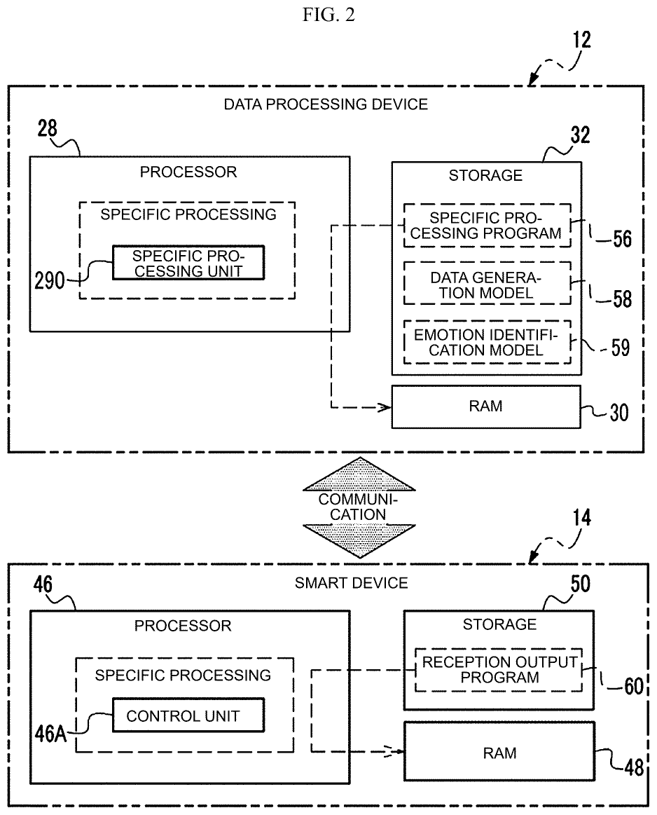

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### (Example 1)

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

Embodiments of the present invention will be described more specifically and in detail. The present invention is a system for supporting response to legal revisions, and is composed of a server and a terminal. The server is configured to include a legal revision information acquisition unit, an affected department determination unit, a response plan generation unit, a database management unit, a generative AI execution unit, a log management unit, a notification management unit, and a history management unit, and the terminal is configured to include a user interface unit, a material browsing/editing unit, a chatbot response unit, a notification receiving unit, and an operation log transmitting unit. Specifically, the present system adopts an advanced information processing architecture that coordinates a plurality of computing nodes in a distributed computing environment. The present server is implemented as a physical or virtual computer resource including a multi-core processor and a large-capacity volatile memory. The present server includes a parallel computing cluster using a graphics processing unit. The present parallel computing cluster accelerates inference processing of a large language model. The present terminal executes encrypted communication with the present server via a network interface. The present system converts an unstructured data group of legal revisions into structured data. The present system quantitatively evaluates an impact on each department in a company using the converted structured data. The present system automatically generates a specific response procedure based on an evaluation result. The present system replaces a cognitive process of document reading and affected range specification performed by a human legal person in charge with a natural language processing algorithm in a high-dimensional vector space. The present system thereby dramatically improves a processing speed. The present system physically eliminates an omission of response to a legal revision caused by a human error. The present system improves accuracy of compliance management. The present system is particularly useful in an industrial field to which strict laws and regulations are applied, such as a financial institution and a medical institution. The present system containerizes each processing unit as a microservice architecture. The present system dynamically scales a computer resource of each processing unit according to a load status. The present system thereby prevents a response delay of the system even when large-scale legal revisions occur continuously.

First, the legal revision information acquisition unit is realized on the server. For example, a legal person in charge, a general affairs person in charge, an information management person in charge, a public relations person in charge, or the like uploads legal revision-related documents such as revised legal texts, guidelines, public comments, records of discussions during legislation, administrative agency interpretation notices, industry association views, reference judicial precedents, administrative guidance documents, and various press materials from the terminal. The upload is possible regardless of a file format (PDF, Word, text, HTML, etc.), and can also be automatically acquired from an external legal database or a website of an administrative agency by API linkage or crawling. The uploaded or automatically acquired document data is transmitted to the server, and the legal revision information acquisition unit receives it. Specifically, the present legal revision information acquisition unit executes a data preprocessing pipeline that converts unstructured data in various formats into a unified machine-readable format. The present legal revision information acquisition unit extracts text data from an imaged document using an optical character recognition algorithm. The present legal revision information acquisition unit executes morphological analysis and syntactic analysis on the extracted text data. The present legal revision information acquisition unit removes unnecessary symbols and spaces that become noise. The present legal revision information acquisition unit periodically transmits a request using a hypertext transfer protocol to the external legal database. The present legal revision information acquisition unit extracts difference information regarding the legal revision from data in a JSON format or an XML format obtained as a response. The present legal revision information acquisition unit analyzes a document object model tree of the website of the administrative agency using a web crawler. The present legal revision information acquisition unit automatically collects a text element surrounded by a specific tag structure. The present legal revision information acquisition unit converts the collected text data into a one-dimensional array token sequence that can be input to a natural language processing model. The present legal revision information acquisition unit divides the token sequence into fixed-length chunks. The present legal revision information acquisition unit adds positional encoding to each chunk. The present legal revision information acquisition unit thereby transfers the data to the subsequent generative AI execution unit while retaining context information of the document. The present legal revision information acquisition unit eliminates a work in which a human manually patrols a website by automating data collection. The present legal revision information acquisition unit prevents an omission of information acquisition. The present legal revision information acquisition unit minimizes a time lag from acquisition of legal revision information to registration in the system. The present legal revision information acquisition unit exhibits an extremely high technical effect in a legal department of a global company that requires real-time compliance response.

The legal revision information acquisition unit cooperates with the generative AI execution unit to analyze the uploaded or acquired document using a natural language processing technology. For example, the generative AI automatically extracts elements such as “newly added obligations”, “deleted provisions”, “enforcement date”, “strengthening of penal provisions”, “exemption provisions”, “transitional measures”, “changes in definitions”, and “newly established notification obligations” from the revised legal texts, and generates a summary. From the guidelines and public comments, “administrative interpretation policies”, “main opinions from the industry”, “issues during legislation”, “answers from administrative agencies”, “practical points to note”, “past violation cases”, and the like are extracted, and the background of the revision and practical points to note are summarized. For example, in the case of a revision of the Act on the Protection of Personal Information, main points such as “record obligation at the time of third-party provision has been strengthened”, “reporting obligation at the time of leakage has been added”, “definition of anonymously processed information has been changed”, and “regulations on cross-border transfer have been newly established” are extracted. From the administrative agency interpretation notices and industry association views, practical guidelines such as “the administrative agency has a policy of requesting a response of B in a case like A” and “the industry association recommends an operation of C” are extracted. From the reference judicial precedents and administrative guidance documents, specific cases such as “a judgment of E was made in a case like D in the past” are extracted. These summaries and extraction results are stored in the database management unit on the server and used for subsequent processing. Specifically, the present generative AI execution unit implements a large language model based on a transformer architecture. The present generative AI execution unit calculates a dependency relationship between each word in the input token sequence using a self-attention mechanism. The present generative AI execution unit receives the one-dimensional array token sequence output from the legal revision information acquisition unit as input data. The present input data is expressed as, for example, a 512-dimensional word embedding vector group. The present generative AI execution unit applies a multi-layer encoder network to the input data. The present generative AI execution unit generates a high-dimensional feature tensor reflecting the context of the legal revision document. The present generative AI execution unit inputs the feature tensor to a decoder network. The present generative AI execution unit outputs a probability distribution of a text span corresponding to a label of an element to be extracted. The present output data is, for example, an array of real values from zero to one indicating a probability that each token belongs to a specific extraction element. The present generative AI execution unit specifies a token sequence whose probability exceeds a predetermined threshold as an extraction result. For example, when receiving a revised document of the Act on the Protection of Personal Information as an input, the present generative AI execution unit extracts a character string of a reporting obligation at the time of leakage with a high probability value. The present generative AI execution unit converts the extracted element into structured data in a key-value format. The present generative AI execution unit transmits the structured data to the database management unit. The present generative AI execution unit executes a masked language modeling task using a large amount of legal documents and judicial precedent data in pre-training. The present generative AI execution unit optimizes a weight parameter of the model using a cross-entropy error function. The present generative AI execution unit executes supervised learning using correct answer data created by a legal expert in fine-tuning. The present generative AI execution unit thereby accurately analyzes difficult expressions and complex syntax peculiar to law. The present generative AI execution unit completes a document reading and summarizing work that takes a human several hours in several seconds. The present generative AI execution unit brings about a remarkable technical effect of speeding up information processing and improving extraction accuracy. The present generative AI execution unit is useful not only for improving business efficiency of the legal department but also in terms of quality control of preventing misinterpretation of legal revision contents.

The affected department determination unit is also realized on the server. The server has a database in which business contents, business processes, areas of charge, past legal revision response histories, organization charts, business flowcharts, managed asset lists, outsourcing contractor lists, related system lists, used data types, various regulations/manuals, training materials, past internal notices, past internal audit findings, and the like of each department are registered. The affected department determination unit matches the main points of the legal revision extracted by the legal revision information acquisition unit with the business content database of each department using generative AI. For example, when an information management department is in charge of “management and operation of personal information”, “database management”, “outsourcing contractor management”, and “access authority management”, it is automatically listed as an affected department because it is directly related to the revision contents of the Act on the Protection of Personal Information. If a legal department is in charge of “contract management”, “specified commercial transactions”, “intellectual property management”, and “litigation response”, it is extracted as an affected department at the time of revision of the Act on Specified Commercial Transactions or the Copyright Act. The generative AI collates a relevance between the business contents of each department and the legal revision contents in units of keywords or business processes, and preferentially selects a department with a high degree of impact. For example, if keywords such as “data utilization”, “outsourcing”, “communication service”, “advertisement distribution”, “customer information management”, “employee information management”, “contract conclusion”, “electronic signature”, and “electronic payment” are included in the business contents of the department, it is determined to be affected by the related legal revision. Furthermore, it analyzes the organization chart and the business flowchart, and automatically detects a case where an affected range expands, such as a business spanning a plurality of departments or a cooperative business with an outsourcing contractor. Specifically, the present affected department determination unit executes a similarity calculation algorithm that compares the main points of the legal revision and attribute information of each department on a high-dimensional vector space. The present affected department determination unit acquires text data indicating the business process and managed assets of each department from the database management unit. The present affected department determination unit inputs the acquired text data to a sentence embedding model. The present affected department determination unit generates, for example, a 768-dimensional fixed-length vector expressing the business contents of each department. The present affected department determination unit similarly inputs the text data of the main points of the legal revision to the sentence embedding model. The present affected department determination unit generates a 768-dimensional fixed-length vector expressing the main points of the legal revision. The present affected department determination unit calculates a cosine similarity between the department vector and the legal revision vector. The present affected department determination unit determines a department whose cosine similarity exceeds a preset threshold as an affected department. The present affected department determination unit further analyzes a network structure of the organization chart or the business flowchart using a graph neural network. The present affected department determination unit constructs graph data in which each department is a node and a business cooperative relationship is an edge. The present affected department determination unit executes a graph convolution operation. The present affected department determination unit quantifies a ripple effect on a department closely cooperating on the business flow even if it is a department with low direct relevance. The present affected department determination unit generates an array of score values from zero to one hundred indicating the degree of impact of each department as output data. The present affected department determination unit outputs, for example, a score of the information management department as 95 and a score of a sales department as 70. The present affected department determination unit sorts the list of affected departments in descending order based on the score values. The present affected department determination unit transmits the sorted list to the subsequent response plan generation unit. The present affected department determination unit replaces an affected range specification work depending on human intuition and experience with an objective evaluation process based on mathematical vector calculation and graph analysis. The present affected department determination unit thereby completely prevents an omission of specification of an affected department. The present affected department determination unit exhibits an extremely high technical effect in accurately and comprehensively specifying the affected range of the legal revision in a large company having a complex organizational structure.

The response plan generation unit is also realized on the server. For each department determined to be affected, a specific response plan based on the legal revision is automatically generated using generative AI. For example, for the information management department, an operation change proposal such as “reviewing an operation flow of a third-party provision record of personal information”, “newly formulating a reporting procedure at the time of leakage”, “modifying a contract template with an outsourcing contractor”, and “revising an access authority management regulation”, and a modification proposal for an existing operation manual or internal regulations are proposed. For the legal department, “addition of a new contract clause”, “revision of an explanatory document regarding specified commercial transactions”, “introduction of a new consent acquisition procedure”, “review of litigation risk evaluation”, and the like are proposed. For the general affairs department, “revision of a general meeting of shareholders operation manual”, “update of employee training materials”, “creation of an internal notice document”, and the like are proposed. For the public relations department, “revision of communication service terms of use”, “modification of explanation materials during external negotiation”, “change of notification procedure to an administrative agency”, and the like are proposed. Specifically, the present response plan generation unit drives a deep learning model that executes a conditional text generation task. The present response plan generation unit receives an identifier and an impact degree score of the affected department output from the affected department determination unit as an input. The present response plan generation unit acquires text data of the existing operation manual and internal regulations of the department from the database management unit. The present response plan generation unit constructs a prompt character string in which the main points of the legal revision and the text data of the existing regulations are combined. The present response plan generation unit inputs the prompt character string to the generative AI execution unit. The present generative AI execution unit analyzes a context of the input prompt character string. The present generative AI execution unit specifies which part of the existing regulations conflicts with the legal revision. The present generative AI execution unit autoregressively generates a specific modified text for resolving the conflicting part. The present generative AI execution unit generates structured data in a JSON format including difference information of the text before and after modification as output data. The present output data includes elements such as, for example, a file name to be modified, a line number of a corresponding paragraph, a character string to be deleted, and a character string to be added. The present response plan generation unit automatically creates an update patch for an existing file based on the generated structured data. The present response plan generation unit further searches past similar legal revision response histories using a vector search engine. The present response plan generation unit acquires text data of past success cases and failure cases. The present response plan generation unit adds the acquired past cases to the prompt character string. The present response plan generation unit thereby improves feasibility and validity of the generated response plan. The present response plan generation unit replaces a work requiring a great deal of labor, such as difference confirmation of regulations and creation of a modification proposal manually performed by a human, with an automatic generation process by a computer. The present response plan generation unit significantly shortens a creation time of the response plan. The present response plan generation unit provides a powerful technical means for completing a reliable compliance response within a limited period until the time of enforcement of the legal revision.

In addition, the generative AI also proposes a new business opportunity newly enabled by the legal revision. For example, a new business proposal from an aggressive viewpoint, such as “launching a new data utilization service”, “developing a consulting business compliant with the revised law”, “developing a service for a new customer segment”, “entering a new market through business alliance with another company”, “introducing a new advertising method”, and “providing an automated service utilizing AI”, is also presented. Furthermore, a dissemination material of the legal revision contents, a FAQ draft, a script for a briefing session, and a time allocation proposal are automatically generated for each department. For example, for the general affairs department, an explanation material about “changes in general meeting of shareholders operation due to revision of the Companies Act”, frequently asked questions, and answer examples thereof are generated. In the script for the briefing session, a proposal including time allocation, such as “overview explanation of revision contents in the first 10 minutes, explanation of specific countermeasures in the next 15 minutes, and question and answer in the remaining 5 minutes”, is made. In the FAQ draft, assumed questions and answers such as “scope of application of new provisions”, “impact on existing business”, “specific procedure for operation change”, “necessity of internal training”, and “response to outsourcing contractors” are automatically generated. Specifically, the present response plan generation unit extracts elements of deregulation and elements of newly established systems included in the main points of the legal revision. The present response plan generation unit multiplies the extracted elements by data of technical assets and a customer base possessed by the company. The present response plan generation unit executes a reinforcement learning algorithm for searching for a potential business opportunity. The present response plan generation unit inputs a special prompt for causing the generative AI execution unit to output an idea of a new business. The present generative AI execution unit generates a multidimensional evaluation matrix including a business concept, an assumed target segment, necessary resources, and an expected revenue scale as output data. The present response plan generation unit further automatically constructs slide material data for presentation using a natural language generation technology. The present response plan generation unit summarizes the main points of the legal revision and the text data of the response plan into a bulleted format. The present response plan generation unit allocates the summarized text to each page of the slide. The present response plan generation unit generates an XML file including layout information of the slide. In generating the script for the briefing session, the present response plan generation unit outputs text data to which metadata of phonetic symbols and pause positions is added so that a text-to-speech system can easily process it. In generating the FAQ, the present response plan generation unit clusters frequently appearing question patterns from a database of past internal inquiry histories. The present response plan generation unit generates an answer sentence based on the legal revision contents for a representative question sentence of each cluster. The present response plan generation unit generates a two-dimensional array composed of pairs of question sentences and answer sentences as output data. The present response plan generation unit dramatically reduces data processing time on a computer required for material creation in the legal department and a planning department by these automatic generation processes. The present response plan generation unit realizes strategic information processing directly linked to strengthening competitiveness of the company, without limiting the legal revision to mere risk response. The present response plan generation unit has extremely high usefulness as a decision-making support system in a corporate planning department and a new business development department.

Utilization of generative AI is essential in all main processes of each unit. For example, in the legal revision information acquisition unit, the generative AI analyzes a large amount of legal revision-related documents in a short time, and extracts and summarizes main points. In the affected department determination unit, the generative AI multilaterally analyzes a relevance between the business contents of each department and the legal revision contents, scores the degree of impact, and prioritizes them. In the response plan generation unit, the generative AI automatically generates an operation change proposal, a material modification proposal, and a new business proposal in line with the actual situation of each department while also referring to past response cases and industry best practices. For example, when there was a similar legal revision in the past, it is also possible to refer to the response history at that time and present an optimal response plan according to the current revision. Furthermore, the generative AI can also learn past question histories of persons in charge of each department and question and answer contents in past briefing sessions, and make proposals and answers more in line with practical business. Specifically, the present system positions the generative AI execution unit as a core inference engine of the entire system. The present system manages an inference request from each processing unit to the generative AI execution unit via an asynchronous messaging queue. The present generative AI execution unit includes an adapter module that dynamically switches a part of weight parameters of a model according to various input tasks. The present generative AI execution unit holds prompt templates optimized for each of a summarization task, a classification task, and a text generation task on a memory. The present generative AI execution unit executes an online learning pipeline for continuously learning past response histories and question and answer contents. The present online learning pipeline collects feedback data from a user. The present online learning pipeline trains a reward model using the feedback data. The present online learning pipeline optimizes an output policy of the generative AI using reinforcement learning. The present generative AI execution unit thereby realizes a self-evolving architecture in which accuracy and validity of output improve as an operation period of the system becomes longer. The present generative AI execution unit receives a text pair of past questions and answers as input data. The present generative AI execution unit generates an updated weight tensor of the model as output data. The present system distributes inference processing of the generative AI to parallel computing cores of a graphics processing unit. The present system thereby maximizes throughput. The present system enables flexible information processing understanding context even for an unknown legal revision pattern that cannot be handled by a conventional rule-based system. The present system causes an artificial intelligence technology to function not merely as an auxiliary tool but as an autonomous computing subject that controls a data flow of the entire system. The present system thereby completely digitalizes complex compliance business at an enterprise level.

The server has a database management unit, and centrally manages all data such as legal revision-related documents, business contents of each department, past response histories, and generated summaries, response plans, materials, FAQs, scripts, and questions and answers. The log management unit records all processing histories of the system, user operation histories, AI output histories, and the like, and is used for later audits and ensuring traceability. The notification management unit automatically distributes notifications such as legal revision information, response plans, material updates, briefing session holding guides, and FAQ updates to each terminal. The history management unit manages past legal revision response histories and response statuses of each department in chronological order, and utilizes them as reference information at the time of future legal revisions. Specifically, the present database management unit adopts a hybrid data store architecture combining a relational database and a NoSQL database. The present database management unit stores structured business data and user information in the relational database. The present database management unit stores document files and output texts of the generative AI, which are unstructured data, in a document-oriented NoSQL database. The present database management unit calculates and assigns a unique hash value to each data. The present database management unit provides a mechanism for detecting data falsification. The present log management unit records all events occurring in the system in a time-series database together with time stamps. The present log management unit saves an input prompt to the generative AI, an output result, a processing time required for inference, and version information of a used model as detailed log data. The present log management unit thereby makes it possible to verify a judgment basis of the AI later. The present notification management unit uses a messaging protocol based on a publish-subscribe model. The present notification management unit transmits a push notification in real time via a WebSocket connection established with each terminal. The present notification management unit tracks a read state of the notification. The present notification management unit automatically executes an escalation process for an unread user. The present history management unit models the response status of each department as a state machine. The present history management unit strictly manages state transitions of unstarted, in progress, waiting for approval, and completed. The present system guarantees data integrity and availability by cooperation of these management units. The present system provides an ability to immediately submit an accurate record in response to an information disclosure request from an auditing firm or a regulatory authority. The present system brings about extremely important technical effects of strengthening corporate governance and automating compliance certification.

On the terminal side, a user interface unit is implemented, and a person in charge of each department can access the server from the terminal and browse/download the generated summary, affected department list, response plan, dissemination material, FAQ, script for a briefing session, and the like. For example, a legal person in charge can confirm “what matters should be responded to by his/her own department in this revision”, “which material should be modified”, “what kind of explanation should be given at a briefing session”, and the like on the terminal. In the material browsing/editing unit, the generated material can be used as it is, or can be added and modified for each department. For example, a person in charge of the information management department can add an operation unique to his/her own department to an AI-generated operation manual modification proposal. Specifically, the present user interface unit is implemented as a single-page application operating on a web browser. The present user interface unit acquires data in a JSON format from the server using asynchronous communication. The present user interface unit binds the acquired data to a virtual document object model. The present user interface unit realizes high-speed drawing processing while minimizing redrawing of a screen. The present user interface unit renders the generated summary and response plan on the screen as a hierarchical tree structure. The present user interface unit dynamically expands detailed information when a user clicks a specific item. The present material browsing/editing unit includes a rich text editor component. The present material browsing/editing unit provides a difference display function of displaying the modification proposal generated by the AI and the original text side by side. The present material browsing/editing unit captures a keystroke event input when the user makes additions and modifications. The present material browsing/editing unit synchronizes change contents with the server in real time. The present material browsing/editing unit implements an exclusive control algorithm. The present material browsing/editing unit prevents a conflict when a plurality of users edit the same material at the same time. The present terminal can also integrate a multimodal interface such as line-of-sight tracking and voice input in order to reduce an operation burden on the user. The present system lowers a hurdle for system use by a legal person in charge or a general affairs person in charge who is a non-engineer by providing an intuitive and highly responsive user interface. The present system dramatically improves interaction efficiency between a human and a computer. The present system seamlessly integrates a human final confirmation and modification process for an AI generation result. The present system maximizes business efficiency while avoiding a risk of full automation.

The chatbot response unit is also realized on the terminal, and when a person in charge inputs a question from the terminal after a briefing session or during daily operations, the content thereof is transmitted to the server, and the generative AI on the server refers to the question content, the main points of the legal revision, the business contents of the department, past Q&A histories, and the like, generates an optimal answer, and returns it to the terminal. For example, the AI immediately returns an answer to a specific question such as “in what case is a new record obligation applied?”, “where should an existing operation manual be modified?”, “at what timing should a notification to an outsourcing contractor be performed?”, and “which part of training materials should be updated?”. Specifically, the present chatbot response unit provides an interactive interface using a natural language. The present chatbot response unit transmits a text character string input by the user to the server as a post request of a hypertext transfer protocol. The generative AI execution unit on the present server adopts a retrieval-augmented generation architecture. The present generative AI execution unit vectorizes the input question character string. The present generative AI execution unit executes a similarity search on a vector database. The present generative AI execution unit extracts text chunks of the main points of the legal revision, the business contents of the department, and past question and answer histories related to the question. The present generative AI execution unit combines the extracted text chunks with the question character string as context information. The present generative AI execution unit inputs the combined prompt to a large language model. The present generative AI execution unit generates an accurate and hallucination-free answer text based on the context information. The present generative AI execution unit generates a JSON object including a character string of the answer text and link information of a reference document that is a basis of the answer as output data. The present chatbot response unit analyzes the received JSON object. The present chatbot response unit draws the answer text on the screen as a balloon-format user interface element. The present chatbot response unit writes a hyperlink to the reference document together. The present system eliminates a time for the user to search and read a huge amount of manuals and legal revision materials by this interactive processing. The present system provides necessary information pinpointly. The present system completely automates internal help desk business. The present system brings about a remarkable technical effect of dramatically reducing a human cost required for inquiry response.

The notification receiving unit receives a notification from the server in real time, and notifies a person in charge by a pop-up, an email, a chat message, or the like. For example, notifications such as “new legal revision information has been added”, “own department has been selected as an affected department”, “a new response plan has been generated”, “invitation to a briefing session”, and “FAQ has been updated” can be immediately received. The operation log transmission unit transmits an operation history on the terminal to the server, and centrally manages a system usage status and a response progress. Specifically, the notification receiving unit uses a service worker resident as a background process. The notification receiving unit cooperates with a push notification API provided by an operating system of the terminal. The notification receiving unit captures a notification event from the server even in a state where a web browser is closed. The notification receiving unit analyzes a payload of the received notification data. The notification receiving unit dynamically changes a display format of the notification based on flag information indicating an importance of the notification. For example, in the case of a notification regarding a response deadline of a legal revision with a high importance, the notification receiving unit displays a modal dialog in the center of the screen to force a user's confirmation operation. The operation log transmission unit collects detailed interaction data such as a user's mouse click, scroll amount, keyboard input, and screen residence time. The operation log transmission unit accumulates the collected data in a local memory until a certain buffer size is reached. The operation log transmission unit compresses the data in order to reduce a network load. The operation log transmission unit asynchronously bulk-transmits the compressed log data to the server. By these functions, the system guarantees reliable information transmission to the user. The system quantitatively visualizes the user's system usage status. The system identifies a bottleneck of the user interface through analysis of the operation log. The system constructs a data-driven feedback loop for continuously improving the usability of the system. The system provides base data for a dashboard function that monitors the progress of compliance response in real time.

Furthermore, for example, even when a plurality of legal revisions occur at the same time, the generative AI can independently analyze each legal revision content, and automatically adjust duplication of affected departments and consistency of response plans. For example, when the Act on the Protection of Personal Information and the Telecommunications Business Act are revised at the same time, it is possible to present a complex operation change proposal and material modification proposal corresponding to both legal revisions to a department affected by both. Also, for example, even when different business processes and management systems exist for each department, the generative AI learns the business flow and past operation history of each department, and individually generates an optimal response plan. For example, even for the same legal revision, “revision of database management regulations” is individually proposed to the information management department, “update of training materials for employees” to the general affairs department, and “modification of external negotiation materials” to the public relations department. Specifically, the system implements a multi-thread parallel processing architecture for processing a plurality of legal revision events. The generative AI execution unit encodes a plurality of input legal revision documents as independent tensors, respectively. The generative AI execution unit generates a feature vector of each legal revision. The generative AI execution unit combines a plurality of feature vectors and inputs them to a cross-attention mechanism. The generative AI execution unit detects an interaction and a contradiction between legal revisions. The generative AI execution unit receives, for example, vectors of both the Act on the Protection of Personal Information and the Telecommunications Business Act as inputs. The generative AI execution unit extracts data protection requirements common to both laws and regulations. The generative AI execution unit outputs a single optimized response plan vector in which overlapping response works are integrated. The response plan generation unit decodes this optimized vector. The response plan generation unit generates text data of a complex operation change proposal. The generative AI execution unit inputs a unique context of each department as a conditioning variable. The generative AI execution unit generates a personalized output for each department using a conditional generative model. The generative AI execution unit increases an appearance probability of a vocabulary related to database management when the context variable of the information management department is input. The generative AI execution unit increases an appearance probability of a vocabulary related to education and training when the context variable of the general affairs department is input. By this advanced context understanding and inference capability, the system minimizes a company's response load to a plurality of complexly intertwined laws and regulations. The system automatically generates an executable response plan in line with the actual situation of each department. The system exhibits an extremely advanced technical effect of simultaneously achieving consistency and efficiency of company-wide compliance response.

Also, for example, progress management of legal revision response can be centralized by the system. When a person in charge of each department inputs a response status from the terminal, the history management unit of the server aggregates the progress, automatically extracts an unresponded department and an uncompleted task, and transmits a reminder notification from the notification management unit. For example, reminders such as “modification of operation manual is uncompleted” and “confirmation of briefing session material is unexecuted” can be automatically distributed. Specifically, the history management unit models the progress status as a directed acyclic graph in which each response task is a node and a dependency relationship between tasks is an edge. The history management unit receives an API request for status update transmitted from the terminal. The history management unit updates a status flag of the corresponding task on the database. The history management unit executes a graph search algorithm. The history management unit identifies a subsequent task that has become executable due to completion of a preceding task. The history management unit periodically executes batch processing. The history management unit compares a current date and time with a deadline date and time set for each task. The history management unit extracts an uncompleted task whose remaining time until the deadline is below a predetermined threshold. The history management unit transmits a list of the extracted tasks to the notification management unit. The notification management unit resolves a destination address based on an identifier of a person in charge of the task. The notification management unit generates and transmits a message payload of the reminder notification. By automating the progress management, the system eliminates a management cost for a project manager to manually confirm the status with each department. The system detects a task delay at an early stage. The system mathematically and systematically reduces a risk of compliance violation against an absolute deadline which is an enforcement date of a legal revision. The system dramatically improves certainty and transparency of project management in a large-scale organization.

Furthermore, for example, it is also possible to open a part of functions of the system to an outsourcing contractor and a group company to strengthen cooperation in legal revision response. The outsourcing contractor can input its own response status from the terminal, and refer to an AI-generated material. For example, “a new contract template for an outsourcing contractor”, “an operation change proposal for a group company”, and the like can be automatically generated and shared among related parties. Specifically, the system adopts a multi-tenant architecture. The system provides a logically separated data area and access authority for each outsourcing contractor and group company. The system implements a role-based access control mechanism. The system permits an external user to access only a task and a material related to its own company. The response plan generation unit receives attribute information and contract content data of the outsourcing contractor as inputs. The response plan generation unit generates a customized contract template and operation change proposal dedicated to the outsourcing contractor using the generative AI. The generative AI execution unit generates text data incorporating different security requirements and reporting obligations, for example, depending on whether a scope of outsourced business is system development or call center business. The system distributes the generated material to a terminal of the external user via a secure file sharing protocol. The system receives a progress report from the external user via a standardized API. The system integrates it into its own progress management graph. The system integrally manages legal revision response across the entire supply chain on a single platform. The system prevents a delay in information transmission and a discrepancy in recognition across companies. The system brings about a powerful technical effect of equalizing a compliance level in the entire ecosystem and blocking a legal risk caused by the outsourcing contractor.

In this way, in the embodiment of the present invention, by essentially utilizing the generative AI for a main processing unit on the server side and realizing a user experience such as a user interface, a chatbot response, notification receiving, material editing, and progress management on the terminal side, all processes of legal revision response can be centrally and efficiently automated, response omissions and legal violation risks can be reduced, discovery and proposal of a new business opportunity caused by a legal revision can be promoted, and coexistence of defensive response and offensive response can be realized. Specifically, the system functions as an information processing apparatus in which natural language processing, high-dimensional vector calculation, graph analysis, and distributed computing technology are highly integrated. The system converts conventional legal compliance business, which has depended on limits of human cognitive ability, into scalable and reproducible algorithmic processing based on computer science. The system constructs a series of processing pipelines of structuring unstructured data, identifying an impact range based on semantic similarity, and generating text with context understanding. The system thereby reduces data processing latency to the utmost limit. The system applies the inference capability of the generative AI not only to simple text generation but also as an advanced analysis engine for deriving a business strategy of a company. The system uses a change in an external environment, which is a legal revision, as input data, and simultaneously generates both a defensive task for risk avoidance and an offensive task for revenue expansion as optimized output data. The system establishes a new paradigm of an enterprise system by efficient use of hardware resources and optimization of software algorithms. The system creates an extremely important technical and economic effect of achieving both sustainable growth of a company and ensuring legal safety through fundamental improvement of information processing technology.

### (System Configuration)

The system according to the present embodiment comprises a legal revision information acquisition unit, an affected department determination unit, a response plan generation unit, a database management unit, a generative AI execution unit, a log management unit, a notification management unit, a history management unit, a user interface unit, a material browsing and editing unit, a chatbot response unit, a notification receiving unit, and an operation log transmission unit. Specifically, each unit constituting the system is implemented as a software module executed on a physical or virtual hardware resource comprising a central processing unit, a random access memory, a solid state drive, and a network interface card. The legal revision information acquisition unit, the affected department determination unit, the response plan generation unit, the database management unit, the generative AI execution unit, the log management unit, the notification management unit, and the history management unit, which are server-side components of the system, perform data communication with each other via a high-speed internal bus or a broadband local area network. The generative AI execution unit directly communicates with dedicated accelerator hardware specialized for tensor calculation, and processes a large-scale matrix multiply-accumulate operation at high speed. The user interface unit, the material browsing and editing unit, the chatbot response unit, the notification receiving unit, and the operation log transmission unit, which are terminal-side components of the system, are executed on a processor of a client device such as a personal computer or a smartphone. The terminal-side components cooperate with the server-side components via a communication channel encrypted by a secure socket layer. By cooperative operation of these hardware and software, the system executes a natural language processing task requiring a huge amount of calculation in real time. The system adopts a redundant configuration for ensuring availability and fault tolerance of the entire system. The system provides a robust architecture capable of continuing processing even when a failure occurs in a specific hardware node.

The legal revision information acquisition unit has a function of receiving a variety of legal revision-related documents such as revised legal texts, guidelines, public comments, records of discussions during legislation, administrative agency interpretation notices, industry association views, reference judicial precedents, administrative guidance documents, and various press materials uploaded from the terminal by a legal person in charge, a general affairs person in charge, an information management person in charge, a public relations person in charge, or the like, and further automatically acquiring them from an external legal database or a website of an administrative agency by API linkage or crawling. For example, it is possible to receive revised legal texts provided in a PDF format, automatically acquire guidelines of an administrative agency published in an HTML format, and allow uploading of industry association views distributed in a Word file. Also, it is possible to automatically collect opinion aggregation results from a public comment solicitation page. The legal revision information acquisition unit passes the received or acquired document to the generative AI execution unit, and generates a prompt sentence for analysis. For example, prompt sentences such as “Summarize the following revised legal texts, and extract main revision points, an enforcement date, added obligations, deleted provisions, strengthening of penal provisions, and transitional measures.”, “Summarize an administrative agency interpretation policy, practical points to note, and an impact on an industry from the following full text of guidelines.”, and “Summarize main opinions and administrative agency answers from the following public comment results.” are generated and input to the generative AI. Specifically, the legal revision information acquisition unit comprises a dedicated parser module group for analyzing a variety of input file formats. For a portable document format file, the legal revision information acquisition unit decodes an internal text stream and extracts text data while retaining layout information. For a hypertext markup language file, the legal revision information acquisition unit constructs a document object model and extracts only text of a node corresponding to a main body. The legal revision information acquisition unit performs character code normalization and unnecessary control character removal on the extracted text data. The legal revision information acquisition unit stores the preprocessed text data in a buffer on a memory. The legal revision information acquisition unit counts the number of characters of the text data. When the number of characters exceeds an input token limit of the generative AI, the legal revision information acquisition unit executes a sliding window algorithm that divides the text into a plurality of chunks at semantic paragraph boundaries. The legal revision information acquisition unit dynamically combines a prompt sentence for each chunk. The legal revision information acquisition unit formats the combined character string as input data to the generative AI execution unit. The input data is, for example, a payload in a JSON format including a system prompt indicating an instruction content and a user prompt indicating text to be analyzed. The legal revision information acquisition unit transmits this payload to an application programming interface of the generative AI execution unit. The legal revision information acquisition unit completely automates processes from data collection to preprocessing and prompt generation. The legal revision information acquisition unit eliminates manual data shaping work by a human. The legal revision information acquisition unit plays an important technical role of stably supplying optimal input data for maximizing accuracy and efficiency of subsequent AI processing.

The affected department determination unit matches a database of business contents, business processes, areas of charge, past legal revision response histories, organization charts, business flowcharts, managed asset lists, outsourcing contractor lists, related system lists, used data types, various regulations/manuals, training materials, past internal notices, past internal audit findings, and the like of each department registered in the server with main points of the legal revision extracted by the legal revision information acquisition unit, and analyzes a relevance using the generative AI. For example, when the information management department in charge of “management and operation of personal information”, “database management”, “outsourcing contractor management”, and “access authority management” is directly related to revision contents of the Act on the Protection of Personal Information, it is automatically listed up as an affected department. For example, the legal department in charge of “contract management”, “specified commercial transactions”, “intellectual property management”, and “litigation response” is extracted as an affected department at the time of revision of the Act on Specified Commercial Transactions or the Copyright Act. For example, the general affairs department in charge of “shareholders meeting operation”, “employee training”, and “internal notice document creation” becomes an affected department at the time of revision of the Companies Act. For example, the public relations department in charge of “revision of communication service terms of use”, “modification of external negotiation materials”, and “change of notification procedure to administrative agency” becomes an affected department at the time of revision of the Telecommunications Business Act. The affected department determination unit analyzes the organization chart and the business flowchart, and automatically detects a case where an impact range expands, such as a business spanning a plurality of departments or a cooperative business with an outsourcing contractor. For the generative AI, a prompt sentence such as “Match the following main points of the legal revision with the business content database of each department, and list up affected departments. Extract highly relevant business processes and managed assets as well.” is used. Specifically, the affected department determination unit executes an advanced matching algorithm using multidimensional attribute data. The affected department determination unit expands attribute information of each department acquired from the database on a memory as a structured JSON object consisting of key-value pairs. The affected department determination unit combines text data of the main points of the legal revision and the JSON object of each department to construct a complex prompt to be input to the generative AI execution unit. The generative AI execution unit analyzes the input complex prompt. The generative AI execution unit infers a semantic relevance between legal requirements included in the main points of the legal revision and business processes and managed assets of each department. The generative AI execution unit generates structured data including an identifier of an affected department, a reliability score from zero to one indicating a degree of relevance, and a list of specific business process names determined to be relevant, as output data. The affected department determination unit further constructs data of the business flowchart on the memory as a directed graph. The affected department determination unit sets a department determined to have a direct impact by the generative AI as a starting point node. The affected department determination unit calculates propagation of an impact to an adjacent node using a graph search algorithm. For example, when a system change in the information management department affects a customer response flow in the sales department, the affected department determination unit automatically extracts the sales department as a secondary affected department. By these processes, the affected department determination unit logically and comprehensively identifies a cross-departmental impact range that a human person in charge tends to overlook. The affected department determination unit accurately visualizes a compliance risk of the entire organization. The affected department determination unit dramatically improves accuracy of scope definition in an initial stage of a legal revision response project.

The response plan generation unit automatically generates a specific response plan based on the legal revision using the generative AI for each department determined to be affected. For example, it proposes an operation change proposal such as “reviewing an operation flow of a third-party provision record of personal information”, “newly formulating a reporting procedure at the time of leakage”, “modifying a contract template with an outsourcing contractor”, and “revising access authority management regulations”, and a modification proposal for an existing operation manual or internal regulations. For example, it proposes “addition of a new contract clause”, “revision of an explanatory document regarding specified commercial transactions”, “introduction of a new consent acquisition procedure”, “review of litigation risk evaluation”, and the like to the legal department. For example, it proposes “revision of a shareholders meeting operation manual”, “update of training materials for employees”, “creation of an internal notice document”, “redesign of an internal training program”, and the like to the general affairs department. For example, it proposes “revision of communication service terms of use”, “modification of an explanation material during external negotiation”, “change of a notification procedure to an administrative agency”, “legal conformity evaluation of a new service”, and the like to the public relations department. Furthermore, the generative AI also proposes a business opportunity newly enabled by the legal revision. For example, it presents “launch of a new data utilization service”, “development of a consulting business compliant with the revised law”, “development of a service for a new customer segment”, “entry into a new market through business alliance with another company”, and the like. It automatically generates a dissemination material of the legal revision contents, a FAQ draft, a script for a briefing session, and a time allocation proposal for each department, and generates, for example, an explanation material about “changes in shareholders meeting operation due to revision of the Companies Act”, frequently asked questions and their answer examples, and a script such as “overview explanation of revision contents in the first 10 minutes, explanation of specific response measures in the next 15 minutes, and question and answer session in the remaining 5 minutes”. Examples of prompt sentences to the generative AI include “Create a necessary operation change proposal, material modification proposal, modification proposal for an existing manual, and new business proposal based on the following main points of the legal revision and business contents of the department.” and “Create a script for a briefing session and a FAQ draft with the following contents.” Specifically, the response plan generation unit applies a prompt engineering technology for maximizing the inference capability of the generative AI. The response plan generation unit includes, in an input prompt, an output format specification, a constraint condition, and an instruction for describing a thinking process step by step. The generative AI execution unit first executes a gap analysis between the main points of the legal revision and the business contents of the department in accordance with the input prompt. The generative AI execution unit next lists specific action items for filling the gap. The generative AI execution unit finally structures each action item as an operation change proposal or a material modification proposal. The generative AI execution unit generates a JSON array including a task name, a priority, an assigned role, and specific modification text as output data. In generating a new business proposal, the response plan generation unit intersects a keyword of deregulation due to the legal revision with a keyword of a core competence of its own company. The response plan generation unit temporarily sets a temperature parameter of a model high in order to prompt the generative AI to output a creative idea. In generating a script for a briefing session, the response plan generation unit automatically calculates a required time from the number of characters of text and a general speaking speed. The response plan generation unit dynamically adjusts an amount of text so as to fit within a specified time allocation. By these advanced generation processes, the response plan generation unit outputs a specific response plan and a deliverable at a level executable immediately by each department in an instant. The response plan generation unit dramatically shortens a lead time required for legal revision response from a unit of several months to a unit of several days. The response plan generation unit provides a powerful technical effect of enhancing agility of a company and fundamentally transforming productivity of a legal department.

The database management unit centrally manages all data such as legal revision-related documents, business contents of each department, past response histories, and generated summaries, response plans, materials, FAQs, scripts, and questions and answers. For example, a modification proposal for an operation manual, a briefing session material, a FAQ, a question and answer history, and the like created at the time of a past legal revision are accumulated and made referable at the time of a future legal revision. For example, a response history when a plurality of legal revisions occur at the same time and a response progress status for each department are also recorded. For example, a cooperation history with an outsourcing contractor or a group company is also managed to facilitate information sharing among related parties. For example, various notification histories and reminder histories are also recorded and utilized to prevent omission of response. Specifically, the database management unit is constructed based on a distributed storage system corresponding to a petabyte-class data scale. The database management unit automatically creates a replication in a plurality of physical nodes when writing data. The database management unit completely prevents data loss at the time of a hardware failure. The database management unit continuously executes an index creation process using a full-text search engine on accumulated text data in the background. The database management unit constructs an inverted index structure. The database management unit thereby provides an ability to search for related data from among millions of past question and answer histories and response histories at a response speed in milliseconds. The database management unit implements a data lifecycle management policy. The database management unit automatically archives old data that has not been accessed for a certain period of time in an inexpensive cold storage. The database management unit optimizes a storage cost. The database management unit adds metadata of a creator, a creation date and time, an update history, and an access authority to each data record. The database management unit executes an authorization process based on a strict access control list. The database management unit physically and logically blocks unauthorized access to highly confidential legal data. The database management unit ensures reliability, availability, and confidentiality of data of the entire system. The database management unit plays an essential technical role of maintaining a high-quality knowledge base for the generative AI to perform accurate inference.

The generative AI execution unit performs natural language processing and knowledge inference based on a prompt sentence and data received from the legal revision information acquisition unit, the affected department determination unit, and the response plan generation unit, and generates various outputs such as summarization, extraction, analysis, proposal, material generation, FAQ generation, script generation, and question answering. For example, it executes a variety of generation tasks such as “extraction of main points of revised legal texts”, “summary of practical interpretation of guidelines”, “analysis of relevance between business contents and legal revision contents”, “automatic generation of an operation change proposal”, “proposal of a new business opportunity”, “automatic creation of a script for a briefing session”, “automatic generation of a FAQ”, and “question answering by a chatbot”. For example, a prompt sentence such as “Summarize the following legal revision-related documents and extract main revision points, an enforcement date, added obligations, penal provisions, and transitional measures”, “Match the following department business contents with main points of the legal revision and list an affected department and a necessary response plan”, “Create a script for a briefing session and a FAQ with the following contents”, or “Answer the following question based on the main points of the legal revision and the department business contents” is input to the generative AI. Specifically, the generative AI execution unit is configured with a large language model having billions to hundreds of billions of parameters as a core. The large language model adopts a transformer architecture provided with a self-attention mechanism. The generative AI execution unit converts input text data into a fixed-length token sequence using a tokenizer. The generative AI execution unit maps the token sequence to a high-dimensional embedding vector space. For example, the generative AI execution unit represents the input data as a dense vector of 512 to 4096 dimensions. The generative AI execution unit receives text data of revised legal texts, text data of a business manual of each department, and text data of a past response history as an input tensor. The generative AI execution unit applies a multi-layer self-attention network to the input tensor. The generative AI execution unit calculates a contextual dependency. The generative AI execution unit weights an importance of each token. The generative AI execution unit generates a summary text, a list of extracted keywords, or structured data of a response plan as an output. For example, the generative AI execution unit outputs a date character string indicating an enforcement date, a bulleted text indicating an added obligation, and numerical data indicating contents of penal provisions as output data. The generative AI execution unit transmits the output text data to the subsequent response plan generation unit or user interface unit. The response plan generation unit automatically formats a modification proposal for internal regulations based on the received text data. With this configuration, the system eliminates a conventional process in which a human manually reads and understands a document. The system specifies a semantic relevance between documents at high speed and with high accuracy by a vector operation in a high-dimensional space. The system dramatically improves an information processing speed in an initial stage of response to a legal revision. The system exhibits a technical effect of minimizing a risk of business suspension at the time of a legal revision in a field where strict compliance is required, such as a financial institution or a medical institution. The large language model is pre-trained in advance using a large amount of legal documents and corporate practice documents. The large language model further undergoes a fine-tuning process specialized for a business domain of a specific company. In the fine-tuning process, the system optimizes weights of the model using a cross-entropy error function. The system updates parameters using a gradient descent method. The system adds a specific instruction sentence to the input text using a prompt engineering technology. The system generates an appropriate output even for an unknown legal revision using a zero-shot learning or few-shot learning method.

The log management unit records all processing histories of the system, user operation histories, AI output histories, and the like, and utilizes them for later audits and ensuring traceability. For example, it records in detail who uploaded which legal revision document and when, which department browsed and edited which response plan, what kind of AI answer was given to which question, which notification was transmitted to whom, and the like. For example, it also manages a progress status of response to a legal revision and an extraction history of unaddressed tasks. For example, it also records user feedback and a modification history for output contents of the AI, and utilizes them to improve accuracy of the AI. For example, it also records a cooperation history with an outsourcing contractor or a group company, and uses it as an evidence of information sharing. Specifically, the log management unit is implemented using a distributed database system and an append-only data structure. The log management unit acquires all events occurring in the system as an event log with a time stamp. The log management unit encrypts the acquired event log using a hash function. The log management unit stores the encrypted event log in a blockchain technology or a tamper-proof storage. The log management unit generates structured data including information on a user identifier, a data identifier of an operation target, a type of operation, and an operation date and time. The log management unit stores a complete pair of an input prompt and an output text of the large language model as log data. The log management unit extracts difference data of a modification made by the user to the output of the large language model. The log management unit formats the difference data as training data for retraining a natural language processing model. The log management unit transfers the formatted training data to a learning data repository. With this configuration, the system constructs a continuous self-improvement loop of an artificial intelligence model beyond mere storage of histories. The system models a user operation history as a multidimensional vector. The system detects unauthorized access or an erroneous operation deviating from a normal operation pattern in real time using an anomaly detection algorithm. The system generates an immediate alert to a system administrator based on a detection result. The system mathematically guarantees completeness of an audit trail. The system completely automates an information security audit and a reporting process to a regulatory authority. The system brings about a technical effect of dramatically improving transparency of compliance management in a large-scale corporate group or an entire supply chain. The log management unit periodically compresses log data and archives it in a cold storage. The log management unit optimizes consumption of a storage capacity. The log management unit dynamically constructs a search index and realizes a search response in milliseconds for petabyte-class log data.

The notification management unit automatically distributes notifications such as legal revision information, a response plan, a material update, a briefing session holding guidance, and a FAQ update to each terminal. For example, notifications such as “New legal revision information has been added”, “Your department has been selected as an affected department”, “A new response plan has been generated”, “Briefing session holding guidance”, and “FAQ has been updated” can be received immediately. For example, a reminder notification to an unaddressed task or an uncompleted department is also automatically distributed. For example, notifications to an outsourcing contractor or a group company can also be distributed in a batch. For example, read/unread management of notification contents and reference to a notification history are also possible. Specifically, the notification management unit adopts an event-driven messaging architecture. The notification management unit executes asynchronous message distribution using a publish-subscribe model. The notification management unit receives an event trigger of a state change from each module in the system. The notification management unit dynamically generates a notification payload based on the received event trigger. The notification management unit acquires user attribute information, an affiliated department, and a current task load status from a profile database. The notification management unit determines an optimal notification timing and notification channel for each user using a machine learning-based recommendation algorithm. For example, the notification management unit transmits a highly urgent legal revision alert to a mobile terminal as a push notification. The notification management unit transmits a low-urgency periodic report as an e-mail. The notification management unit includes an identifier of target legal revision data and a deep link to a corresponding task in the notification payload. The notification management unit directly activates a corresponding work screen when the user clicks the notification. With this configuration, the system reduces a cognitive load on the user due to information overload. The system physically prevents omission of response to an important compliance task. The system exhibits a technical effect of optimizing consumption of a network bandwidth and reducing a communication load of the entire system. The notification management unit tracks a distribution state, an arrival confirmation, and a read state of each notification in real time. The notification management unit automatically generates a secondary notification to an upper administrator in accordance with an escalation rule when an unread state continues for a certain period of time. The notification management unit cooperates with a multilingual translation module to distribute a notification message translated into a local language to an overseas base of a global company in real time. The system realizes unified management of global legal compliance in a multinational company.

The history management unit manages a past legal revision response history and a response status of each department in chronological order, and utilizes them as reference information at the time of a future legal revision. For example, it records in chronological order which department took what kind of response, which material was modified, what kind of questions were frequent, what kind of new business proposal was made, and the like at the time of a past legal revision. For example, a past briefing session material, a FAQ, and a question and answer history are also accumulated and made reusable. For example, a past response progress and a reminder history are also managed and utilized for trend analysis of omission of response. For example, a response history of an outsourcing contractor or a group company is also recorded, contributing to improvement of legal revision response capability in the entire group. Specifically, the history management unit is configured by combining a time-series database and a graph database. The history management unit defines a past legal revision event, a responding department, a modified document, and an occurred question and answer as nodes. The history management unit constructs a knowledge graph expressing a relationship between these nodes as an edge. The history management unit executes a similarity search on the knowledge graph using a graph neural network when new legal revision information is input. The history management unit specifies a similar past legal revision event. The history management unit extracts a sequence of response tasks executed in the specified past event. The history management unit provides the extracted task sequence to the response plan generation unit as a template for a current legal revision response. The history management unit inputs a pattern of a delay or an error occurred in a past response to a machine learning model. The history management unit predicts a bottleneck in a future response process. The history management unit generates an optimal resource allocation proposal based on a prediction result. With this configuration, the system persists tacit knowledge of an organization as an explicit data structure. The system enables an advanced predictive response based on past experiences. The system brings about a technical effect of iteratively reducing human resources and time required for response to a legal revision. The history management unit clusters frequently appearing topics from past question and answer histories using a natural language processing technology. The history management unit automatically updates a general-purpose FAQ database based on a clustering result. The history management unit calculates a response performance of an outsourcing contractor or a group company as a quantitative score. The history management unit outputs the score as a risk evaluation index of an entire supply chain. The system strongly supports a compliance integration process at the time of corporate acquisition or organizational restructuring.

The user interface unit provides a screen on which a person in charge of each department accesses the server from a terminal and can browse and download a generated summary, an affected department list, a response plan, a dissemination material, a FAQ, a script for a briefing session, and the like. For example, a legal person in charge can confirm “what matters the own department should respond to in this revision”, “which material should be modified”, “what kind of explanation should be given at a briefing session”, and the like. For example, a material search/filtering function and a customized display for each department are also possible. For example, feedback input to an AI-generated material and submission of a modification proposal are also possible. For example, a dedicated screen for an outsourcing contractor or a group company can also be provided. Specifically, the user interface unit adopts a single-page application architecture and is implemented as a dynamic web interface. The user interface unit performs asynchronous communication with a server-side application programming interface. The user interface unit dynamically renders a data component to be displayed based on user authentication information and an access authority level. The user interface unit structures and arranges text data generated by the large language model on a visual dashboard. The user interface unit visualizes the affected department list as a network graph. The user interface unit draws a progress status of the response plan in a Gantt chart format. The user interface unit receives a search query from a user. The user interface unit transfers the query to a semantic search engine using natural language processing. The user interface unit presents not only an exact match of a keyword but also a semantically similar material as a search result. The user interface unit collects a user evaluation of a material generated by artificial intelligence in a format of a star rating or a text comment. The user interface unit serializes the collected feedback data and transmits it to the log management unit. With this configuration, the system provides complex legal revision information in an intuitively understandable format. The system minimizes the number of user operation steps and dramatically improves business efficiency. The system exhibits a technical effect of optimizing a drawing load of a client terminal and ensuring comfortable operability even from a low-spec terminal. The user interface unit adopts a responsive design and automatically adapts to access from a smartphone or a tablet terminal. The user interface unit provides a secure sandbox environment that permits access only to a specific data area for an outsourcing contractor. The system realizes seamless collaboration with an external partner while completely eliminating a risk of information leakage.

The material browsing and editing unit provides an editing function capable of using a generated material as it is or adding and modifying it for each department. For example, a person in charge of the information management department can add an operation unique to the own department to an AI-generated modification proposal for an operation manual. For example, the legal department can add a clause unique to the company to an AI-generated contract template. For example, the general affairs department can insert a case of the company into an AI-generated training material. For example, the public relations department can add the latest administrative guidance case to an AI-generated external explanation material. Specifically, the material browsing and editing unit is implemented as a rich text editor component having a real-time collaborative editing function. The material browsing and editing unit adopts an operational transformation algorithm or a conflict-free replicated data type. The material browsing and editing unit mathematically resolves a conflict of editing operations simultaneously performed by a plurality of users on the same document. The material browsing and editing unit expands an initial document generated by the large language model on a memory as a baseline. The material browsing and editing unit captures a keystroke or a text insertion/deletion event by a user in milliseconds. The material browsing and editing unit asynchronously transmits difference data of editing to a server as a difference patch. The material browsing and editing unit distinguishes and manages a proposal text by artificial intelligence and a manually input text by a human with different metadata tags. The material browsing and editing unit is integrated with a version control system. The material browsing and editing unit supports a rollback function to an arbitrary past state of a document. The material browsing and editing unit provides a function of triggering a regeneration request to the large language model through a context menu when a user selects a specific paragraph. With this configuration, the system seamlessly fuses a generation capability of artificial intelligence and a professional judgment of a human. The system dramatically shortens a lead time required for document creation. The system brings about a technical effect of ensuring complete traceability of an editing history and strengthening a quality assurance process of a compliance document. The material browsing and editing unit inputs a text of a unique clause added by the legal department to a natural language processing model. The material browsing and editing unit verifies in real time whether the clause does not contradict an existing law and regulation or internal regulations. The material browsing and editing unit displays a warning highlight on a screen when a contradiction is detected. The system prevents a human error in a creation process of a contract or a manual.

The chatbot response unit is configured such that when a person in charge inputs a question from a terminal after a briefing session or during daily operations, the contents are transmitted to the server, and the generative AI on the server refers to the question contents, main points of the legal revision, business contents of the department, a past Q&A history, and the like, generates an optimal answer, and returns it to the terminal. For example, the AI immediately returns an answer to a specific question such as “In what cases is a new recording obligation applied?”, “Where should an existing operation manual be modified?”, “At what timing should a notification to an outsourcing contractor be performed?”, or “Which part of a training material should be updated?”. As an example of a prompt sentence to the generative AI, “Answer the following question practically and specifically based on main points of the legal revision and department business contents.” and the like can be cited. Specifically, the chatbot response unit is configured as an interactive artificial intelligence system adopting a retrieval-augmented generation architecture. The chatbot response unit receives a natural language question text input from a user terminal. The chatbot response unit inputs the question text to an embedding model and converts it into a high-dimensional question vector. For example, the chatbot response unit represents the question text as a 1024-dimensional floating-point vector. The chatbot response unit executes an approximate nearest neighbor search on a vector database. The chatbot response unit extracts text chunks of main points of the legal revision, a business manual of a department, and a past question and answer history having a high cosine similarity with the question vector. The chatbot response unit combines the extracted text chunks with the question text as context information. The chatbot response unit formats the combined text as an input prompt to the large language model. The chatbot response unit causes the large language model to execute an inference process. The chatbot response unit receives an answer text output from the large language model. The chatbot response unit automatically embeds a hyperlink to a reference source document in the answer text. The chatbot response unit transmits final answer data to the user terminal. With this configuration, the system suppresses a hallucination phenomenon peculiar to a large language model. The system always generates an accurate answer based on the latest and company-specific facts. The system exhibits a technical effect of significantly reducing the number of routine inquiries to a legal department and concentrating resources of specialized personnel on advanced legal judgment operations. The chatbot response unit holds a dialogue history in a memory buffer for an additional question from a user. The chatbot response unit realizes a multi-turn dialogue maintaining a context. The chatbot response unit calculates a reliability score of an answer. The chatbot response unit executes a routing process of automatically escalating a chat session to a human legal person in charge when the reliability score falls below a predetermined threshold.

The notification receiving unit receives a notification from the server in real time and notifies a person in charge by a pop-up, an e-mail, a chat message, or the like. For example, notifications such as “New legal revision information has been added”, “Your department has been selected as an affected department”, “A new response plan has been generated”, “Briefing session holding guidance”, and “FAQ has been updated” can be received immediately. For example, a reminder notification to an unaddressed task or an uncompleted department is also automatically distributed. For example, read/unread management of notification contents and reference to a notification history are also possible. For example, notifications to an outsourcing contractor or a group company can also be distributed in a batch. Specifically, the notification receiving unit is implemented as a background process or a service worker resident on a client terminal. The notification receiving unit establishes a continuous bidirectional communication channel with a server using a WebSocket protocol or Server-Sent Events. The notification receiving unit asynchronously listens to a notification payload transmitted from the server. The notification receiving unit calls a native notification application programming interface of an operating system when receiving the notification payload. The notification receiving unit draws a visual pop-up alert on a screen. The notification receiving unit analyzes a priority flag included in the notification payload. The notification receiving unit activates a voice alert or a vibration function when a priority is high. The notification receiving unit detects an event in which a user clicks a notification. The notification receiving unit executes a routing process to a corresponding task screen in the system triggered by the event. The notification receiving unit records completion of display of a notification and a click operation of a user together with a time stamp. The notification receiving unit feedback-transmits these state data to the notification management unit on the server side. With this configuration, the system guarantees reliable message arrival even in an environment where network delay or disconnection is likely to occur. The system timely transmits important compliance information without interrupting a work context of a user. The system brings about a technical effect of maximizing an initial response speed of response to a legal revision in an entire organization. The notification receiving unit constructs a cache database of a notification history in a local storage. The notification receiving unit enables search and browsing of past notification contents even in an offline state. The notification receiving unit includes a webhook integration module for cooperating with a third-party business chat tool. The system maximizes utilization of a communication infrastructure already introduced by a company.

The operation log transmission unit transmits an operation history on a terminal to the server, and centrally manages a system utilization status and a response progress. For example, it records in detail which person in charge browsed and edited which material, which notification was received, which question was input to the AI, which response plan was approved or rejected, and the like. For example, it automatically aggregates a response progress based on an operation history, and extracts an unaddressed department or task. For example, it also centrally manages an operation history of an outsourcing contractor or a group company, and visualizes a response status of an entire group. For example, analysis of a system utilization status and effectiveness evaluation of an AI proposal are also possible based on an operation log. Specifically, the operation log transmission unit functions as an event tracking module incorporated in a user interface layer of a client terminal. The operation log transmission unit captures a user interaction event such as a mouse click, a keystroke, a scroll amount, a screen stay time, and a focus transition from a document object model. The operation log transmission unit converts captured raw data into a structured log object including a user identifier, a session identifier, a time stamp, and an element identifier of an operation target. The operation log transmission unit temporarily accumulates a plurality of log objects in a buffer on a memory in order to suppress consumption of a network bandwidth. The operation log transmission unit transmits them in a batch to a server as a batch process at a timing when a predetermined time interval or a threshold of a buffer capacity is reached. The operation log transmission unit automatically executes a retransmission process using an exponential backoff algorithm when a network error occurs during transmission. With this configuration, the system reliably collects high-resolution operation data without degrading performance of a client terminal. The system clusters user behavior patterns in a multidimensional space using collected operation data. The system quantitatively calculates a user acceptance rate and a modification frequency for a response plan generated by artificial intelligence. The system exhibits a technical effect of detecting deterioration of inference accuracy of an artificial intelligence model at an early stage and automatically generating a trigger for retraining. The operation log transmission unit hashes or masks personally identifiable information or a highly confidential input text on a client side from a viewpoint of privacy protection. The operation log transmission unit transmits only anonymized data to the server. The system enables advanced analysis of a utilization status of the entire system while complying with strict data protection regulations.

As described above, the system according to the present embodiment can comprehensively and specifically support all operations such as collection and analysis of legal revision information, identification of affected departments, generation of response plans, material creation, briefing session operation, question and answer, progress management, notification distribution, history management, and external linkage by unifying and efficiently automating the entire process of response to legal revisions through cooperation of each unit and essentially utilizing generative AI. Specifically, the system adopts a distributed computing architecture in which a plurality of independent microservices loosely cooperate via an application programming interface. The system encapsulates each processing module using a containerization technology. The system dynamically scales each module on a container orchestration platform. The system models a data flow from input of legal revision information to final completion of response as a directed acyclic graph. The system arranges an artificial intelligence pipeline centered on a large language model in each node. The system integrally executes natural language processing, knowledge graph inference, and a machine learning-based prediction algorithm. The system converts input unstructured text data into machine-readable structured data. The system automatically resolves complex semantic mapping between laws and regulations and corporate business through operations in a high-dimensional vector space. With this configuration, the system fundamentally reconstructs conventional compliance operations that have relied on the limits of human cognitive ability by a computer science approach. The system eliminates a bottleneck in information processing and dramatically shortens the total time required for response to legal revisions from months to days. The system eliminates room for intervention of human errors and brings about a technical effect of mathematically improving the accuracy of compliance observance of the entire company. The system elastically utilizes computing resources in a cloud computing environment. Even when large-scale legal revisions occur simultaneously and frequently, the system processes a huge amount of tasks in real time by parallel distributed processing without degrading system performance. The system provides a robust technical foundation that achieves both sustainable growth of a company and minimization of legal risks.

### (Implementation Steps)

Step 1: Collection and Input of Legal Revision Information A legal person in charge, a general affairs person in charge, an information management person in charge, a public relations person in charge, or the like uploads legal revision-related documents such as revised legal texts, guidelines, public comments, records of discussions during legislation, administrative agency interpretation notices, industry association views, reference judicial precedents, administrative guidance documents, and various press materials from a terminal. Furthermore, it is also possible to automatically acquire them from an external legal database or a website of an administrative agency by API linkage or crawling. For example, documents in various formats such as revised legal texts in PDF format, guidelines in HTML format, and industry association views in Word files are targeted. Specifically, the system activates a multimodal data ingestion pipeline. The system receives a binary data stream transmitted from a user terminal via a secure communication protocol. The system analyzes an extension and a magic number of the received file, and automatically identifies a file format. The system applies an optical character recognition engine and a layout analysis algorithm to a file in a portable document format. The system accurately extracts character string data from imaged text or a complex table structure. The system parses a document object model tree for a file in a hypertext markup language. The system filters unnecessary decoration tags and navigation elements, and extracts only pure text contents. The system periodically issues a request of a representational state transfer application programming interface to an external legal database. The system automatically fetches the latest legal revision data. The system crawls a domain of a specific administrative agency using a web crawler module. The system detects an updated web page and scrapes difference data. With this configuration, the system normalizes unstructured data scattered in various formats into a unified plain text format suitable for subsequent artificial intelligence processing. The system completely eliminates human manual work in a data collection process. The system exhibits a technical effect of dramatically improving comprehensiveness and immediacy of information. The system executes preprocessing such as unification of character codes, removal of noise characters, and normalization of words using morphological analysis on the extracted text data. The system stores the preprocessed text data in a distributed object storage together with metadata. The system guarantees high-speed read access to a large-scale data set.

Step 2: Analysis and Summarization of Legal Revision Information (Utilization of Generative AI) The legal revision information acquisition unit on the server passes the uploaded or automatically acquired document to the generative AI execution unit, and performs analysis using a natural language processing technology. For example, prompt sentences such as “Summarize the following revised legal texts, and extract main revision points, an enforcement date, added obligations, deleted provisions, strengthening of penal provisions, and transitional measures.”, “Summarize administrative agency interpretation policies, practical points to note, and an impact on an industry from the following full text of guidelines.”, and “Summarize main opinions and administrative agency answers from the following public comment results.” are input to the generative AI. The generative AI automatically extracts and summarizes a purpose of revision, revision points, a time of enforcement, new rules to be complied with, an impact on an industry, and the like, and stores them in the database management unit of the server. Specifically, the system tokenizes the preprocessed text data and divides it into chunks of an appropriate size in accordance with a limitation of an input context window of a large language model. The system combines a system prompt including a task-specific instruction for each chunk. For example, the system supplies a text array of revised legal texts extending to tens of thousands of characters as input data to the large language model. The system calculates a long-distance dependency relationship in the text using a self-attention mechanism in a transformer network of the large language model. The system evaluates a contextual meaning of a legal technical term or a complex syntax in a high-dimensional vector space. The system causes structured data to be generated as an output from the large language model. The system extracts, as output data, for example, a character string “Apr. 1, 2024” indicating an enforcement date, a text “creation of a record at the time of third-party provision” indicating an added obligation, and numerical data “fine of one million yen or less” indicating a penal provision. The system calculates a certainty score of information extraction for each extracted element. The system maps and stores data whose certainty score exceeds a threshold value in a relational table of the database management unit. With this configuration, the system completes reading comprehension and point arrangement of a complex legal document, which requires several days for a human, in several seconds to several minutes. The system eliminates omission of information extraction and fluctuation in interpretation, and provides a homogeneous and highly accurate analysis result. The system brings about a technical effect of supplying high-quality structured data for subsequent affected department identification and response plan generation. The system uses a plurality of different large language models as an ensemble. The system integrates output results of each model by a majority vote algorithm or cross-validation. The system strongly prevents mixing of misinformation due to hallucination of a single model. The system vectorizes the extracted summary data and indexes it in a vector database. The system speeds up subsequent similarity search processing.

Step 3: Identification of Affected Department (Utilization of Generative AI) The affected department determination unit matches a database of business contents, business processes, areas of charge, past legal revision response histories, organization charts, business flowcharts, managed asset lists, outsourcing contractor lists, related system lists, used data types, various regulations/manuals, training materials, past internal notices, past internal audit findings, and the like of each department registered in the server with main points of the legal revision extracted by the legal revision information acquisition unit, and analyzes a relevance using generative AI. A prompt sentence such as “Match the following main points of the legal revision with a business content database of each department, and list affected departments. Extract highly relevant business processes and managed assets as well.” is used for the generative AI. The AI automatically determines, for example, that an information management department in charge of “management and operation of personal information” is an affected department of the revision of the Act on the Protection of Personal Information. Specifically, the system inputs text data of the extracted main points of the legal revision to an embedding model, and generates a legal revision feature vector. In parallel, the system similarly vectorizes text data of business contents, managed assets, and various manuals of each department, and generates a set of department profile vectors. The system calculates a cosine similarity or an inner product between the legal revision feature vector and each department profile vector. The system quantitatively evaluates the strength of semantic relevance between the legal revision and business of each department based on a distance in a vector space. The system extracts a department whose similarity score exceeds a predetermined threshold value as a candidate. The system combines profile data of the extracted candidate department and the main points of the legal revision, and constructs an input prompt to the large language model. The system causes the large language model to execute an impact evaluation based on logical inference, not simple keyword matching. The system acquires, as an output from the large language model, structured data including an identifier of an affected department, a name of a specific affected business process, and a risk score indicating a degree of impact. For example, the system generates a set of labels “information management department”, “customer database operation process”, and “high risk” as output data. With this configuration, unlike a conventional search system that relies on superficial word matching, the system realizes advanced matching that deeply understands the actual state of business and the purpose of laws and regulations. The system completely prevents omission of identification of an impact range of a legal revision. The system exhibits a technical effect of automating evaluation of company-wide compliance risks and optimizing prioritization of responses. The system maps a list of identified affected departments as nodes on a graph database. The system traces a business dependency relationship between departments as an edge. The system executes a network analysis algorithm that identifies not only a directly affected department but also an indirectly affected related department in a chained manner.

Step 4: Automatic Generation of Response Plan and Material (Utilization of Generative AI) The response plan generation unit automatically generates a specific response plan based on the legal revision using generative AI for each department determined to be affected. Prompt sentences such as “Create a necessary operation change proposal, material modification proposal, modification proposal for an existing manual, and new business proposal based on the following main points of the legal revision and business contents of a department.” and “Create a script for a briefing session and a FAQ draft with the following contents.” are input to the generative AI. The AI automatically generates an operation change proposal, a material modification proposal, a new business proposal, a script for a briefing session, and a FAQ draft such as “reviewing an operation flow of a third-party provision record of personal information”, “adding a new contract clause”, “revising a general meeting of shareholders operation manual”, and “revising communication service terms of use”, for example. Specifically, the system integrates profile data of the identified affected department, legal revision main point data, and past similar response history data, and dynamically generates a context-rich input prompt. The system inputs the prompt to the large language model. The system executes an autoregressive token generation process in a decoder network of the large language model. The system generates a contextually most appropriate and fluent text sequence using a beam search algorithm or a nucleus sampling method. The system generates a list of specific action items, a difference text of internal regulations to be modified, and a presentation script for a briefing session as an output from the large language model. For example, the system outputs a specific modification instruction “add the following wording to Article 3 of the existing privacy policy” and a text block of the modification proposal as output data. The system converts the generated text data into a structured document format such as a markdown format or a hypertext markup language format. The system registers the generated response plan as a new record in a task management database. With this configuration, the system automatically translates an abstract external factor of a legal revision into a specific business task that can be immediately executed by each department. The system reduces a huge amount of human man-hours required for material creation from scratch. The system brings about a technical effect of dramatically shortening a lead time from planning to execution of a response measure. The system applies a rule-based checker module that verifies whether the generated response plan complies with internal compliance standards and brand guidelines. When an inappropriate expression or contradiction is included, the system automatically runs a feedback loop including a modification instruction to the large language model. The system autonomously ensures final output quality inside the system.

Step 5: Distribution, Viewing, and Editing of Generated Material and Response Plan Through the user interface unit and the material viewing/editing unit, a person in charge of each department can access the server from a terminal, and view and download the generated summary, affected department list, response plan, dissemination material, FAQ, script for a briefing session, and the like. The person in charge can use the AI-generated material as it is, or can add and modify it for each department. For example, the information management department can add its own operation to the AI-generated modification proposal for an existing operation manual, or the legal department can add its own clause to a contract template. Specifically, the system arranges the generated various materials on a distributed file system, and assigns a unique resource identifier to each material. The system evaluates a user authentication token and a role-based access control list. The system establishes a secure data distribution channel that permits access to the material only to a user whose authority has been confirmed. The system provides a high-speed rendering engine using a virtual document object model to a web browser on a client terminal. The system visually distinguishes and displays text generated by artificial intelligence and text manually edited by a user using different color codes and metadata tags. The system captures a change event every time a user changes text on an editor. The system transmits change contents as a difference patch to the server by asynchronous communication. The system applies the difference patch on the server side, and maintains the latest state of the document on a memory. When a plurality of users simultaneously edit the same material, the system resolves an editing conflict in real time using an operational transformation algorithm. With this configuration, the system realizes a hybrid workflow that seamlessly integrates automatic generation by artificial intelligence and professional fine adjustment by a human. The system eliminates complexity of version management of materials. The system exhibits a technical effect of maximizing collaboration efficiency in the entire organization. The system accumulates an editing history by a user as training data of a machine learning model. The system learns a pattern of what kind of modification the user has made. The system fine-tunes parameters of the large language model so as to output text more in line with user intentions and internal customs at the time of next material generation. The system autonomously improves generation accuracy of the entire system through continuous use.

Step 6: Implementation of Briefing Session and Dissemination Activity Each department implements a briefing session, internal training, a briefing session for outsourcing contractors, and the like using a script for a briefing session and a dissemination material automatically generated by AI. For example, the general affairs department holds a briefing session to explain changes in general meeting of shareholders operation, or the information management department conducts internal training on a new personal information management flow. AI-generated FAQs and question and answer materials are also utilized. Specifically, the system includes an export module that automatically converts the automatically generated script for a briefing session and dissemination material into a file format of presentation software or a standard of an e-learning platform. The system automatically generates a narration audio file with a natural human voice from text data using a speech synthesis artificial intelligence model. The system synchronizes the generated audio file and presentation slides, and dynamically constructs multimedia training contents that can be viewed on demand. The system automatically uploads the contents to an internal video distribution server or learning management system via an application programming interface. The system collects a viewing history, a comprehension test score, and an access log to contents of each employee. The system integrates the collected data into a central database. The system transmits an automatic reminder email to an employee who has not taken the course through the notification management unit. With this configuration, the system dramatically reduces physical preparation work and holding costs of group training required for internal dissemination of legal revision contents. The system immediately provides homogeneous and high-quality educational opportunities to all employees. The system brings about a technical effect of bringing an attendance rate of compliance education close to 100% and raising legal literacy of the entire organization. The system acquires audio of questions and answers generated during the briefing session from a microphone. The system converts it into text in real time using a speech recognition model. The system inputs the text-converted question contents to the large language model, immediately generates a draft of an answer, and displays it on a prompter of a presenter. The system has a self-expansion function of strongly supporting progress of the briefing session and automatically adding new question and answer data to a FAQ database.

Step 7: Question and Answer by Chatbot (Utilization of Generative AI) When a person in charge inputs a question from a terminal through the chatbot response unit after a briefing session or during daily operations, the contents are transmitted to the server, and the generative AI on the server refers to the question contents, main points of the legal revision, business contents of a department, past Q&A histories, and the like, generates an optimal answer, and returns it to the terminal. Examples of prompt sentences to the generative AI include “Answer the following question practically and specifically based on main points of the legal revision and business contents of a department.” For example, it immediately answers questions such as “In what cases are new recording obligations applied?” and “Where should an existing operation manual be modified?”. Specifically, the system receives a natural language query character string input from a chat interface of a user terminal. The system executes morphological analysis and stop word removal on the query character string. The system inputs the preprocessed query to a transformer-based encoder model, and generates a dense vector representation. The system applies an approximate nearest neighbor search algorithm to a vector group of main points of the legal revision, business manuals, and past FAQs stored in a vector database. The system searches and extracts top K text chunks having the highest similarity to the query vector at high speed. The system adds the extracted text chunks as a context to the query character string, and dynamically constructs an input prompt to the large language model. The system causes the large language model to execute inference. The system generates structured response data including a direct answer text to the question, an article number of internal regulations serving as a basis, and a hyperlink to a related manual as an output from the large language model. For example, the system generates a text “New recording obligations are applied in all cases where personal data is provided to a third party. For details, please refer to the link of the 5th edition of the operation manual.” as output data. With this configuration, the system completely overcomes obsolescence of knowledge and hallucination of the large language model by using a retrieval-augmented generation technology. The system always provides an accurate answer based on the latest internal rules with a latency in milliseconds. The system exhibits a technical effect of significantly reducing inquiry traffic to a legal department and minimizing business downtime. The system collects binary feedback of “helpful” or “not helpful” from a user. The system continuously optimizes weighting of a search model and generation parameters of the large language model using a reinforcement learning algorithm.

Step 8: Progress, History, and Notification Management The log management unit, the notification management unit, and the history management unit cooperate to centrally manage all processing histories of the system, user operation histories, AI output histories, response progress, notification histories, past legal revision response histories, and the like. The notification management unit automatically distributes legal revision information, response plans, material updates, briefing session holding guidance, FAQ updates, reminders of unhandled tasks, and the like to each terminal. The history management unit records response contents and progress status at the time of past legal revisions in chronological order, and utilizes them as reference information at the time of future legal revisions. Specifically, the system aggregates event logs asynchronously transmitted from each module using a distributed message queuing system. The system executes parsing, filtering, and aggregation processing of log data in real time using a stream processing engine. The system writes the processed data to a time-series database and a data warehouse in parallel. The system manages a status of a response task of each department as a state transition model. The system compares a completion deadline of a task with a current status. The system automatically detects a task with a high risk of exceeding a deadline. The system triggers the notification management unit based on a detection result. The system dynamically generates and distributes a reminder notification according to an escalation level to a corresponding person in charge and his/her superior. The system archives all project data of completed responses to legal revisions in the history management unit. The system constructs metrics such as a required time from start to completion of a project, generated issues, and a usage frequency of artificial intelligence as a multidimensional data cube. With this configuration, the system visualizes a compliance response status of the entire organization in real time on a bird's-eye dashboard. The system discovers a delay in response or a bottleneck at an early stage, and enables proactive intervention. The system brings about a technical effect of reducing overhead of project management to the utmost limit. The system applies machine learning-based regression analysis to accumulated past history data. The system predicts human resources and a required period necessary when a similar legal revision event occurs in the future with high accuracy. The system strongly supports data-driven management decision-making.

### (Specific Use Case)

For example, assume a case where laws and regulations related to personal information protection are revised, and a new recording obligation at the time of third-party provision, a reporting obligation at the time of leakage, a change in the definition of anonymously processed information, strengthening of regulations on cross-border transfer, and the like are introduced for companies. In this case, a legal person in charge uploads revised legal texts, guidelines, public comments, administrative agency interpretation notices, industry association views, reference judicial precedents, administrative guidance documents, related press materials, and the like from a terminal to the system, or automatically acquires them from an external legal database or an administrative agency website by API linkage or crawling. The legal revision information acquisition unit receives these documents in various formats, generates a prompt sentence such as “Summarize the following revised legal texts, and extract main revision points, an enforcement date, added obligations, deleted provisions, strengthening of penal provisions, and transitional measures.” or “Summarize an administrative agency interpretation policy, practical points to note, and an impact on an industry from the following full text of the guidelines.” for the generative AI execution unit, and instructs analysis. Specifically, the present system operates an advanced natural language processing pipeline in a specific use case of the revision of the Act on the Protection of Personal Information. The present system aggregates revised legal texts in PDF format spanning hundreds of pages transmitted from the terminal of the legal person in charge and data acquired from a server of an administrative agency via an application programming interface into a central storage. The present system converts these unstructured data into an array of plain texts using optical character recognition and a document parser. The present system divides the text array into chunks in units of thousands of tokens. The present system formats each chunk as an input tensor of a large language model. The present system gives a specific system prompt for understanding a legal context to the large language model. The present system drives an inference engine of the large language model, and extracts core elements of the legal revision from the input text data. The present system generates, as output data, a name of a new obligation such as “recording obligation at the time of third-party provision”, a compliance requirement such as “reporting obligation at the time of leakage”, and a restriction on international data transfer such as “strengthening of regulations on cross-border transfer” in a format of structured key-value pairs, for example. With this configuration, the present system completely replaces a conventional mental process in which a human reads a huge amount of legal documents and manually extracts and organizes related information. The present system specifies a hidden semantic relationship in the document at high speed by a vector operation in a high-dimensional space. The present system makes it possible to accurately grasp an overall picture of the legal revision within a few minutes. The present system dramatically reduces the time required for initial analysis by a legal department, and exhibits a technical effect of supporting rapid formulation of a response strategy. The present system holds a pointer to a related original legal text or a paragraph of the guidelines as metadata for each extracted element. The present system ensures traceability that allows the user to always refer to a primary source of information with one click in a subsequent process.

The generative AI automatically extracts and summarizes a purpose of revision, revision points, a time of enforcement, new rules to be complied with, an impact on an industry, and the like, and stores main points such as “recording obligation at the time of third-party provision has been strengthened”, “reporting obligation at the time of leakage has been added”, “definition of anonymously processed information has been changed”, and “regulations on cross-border transfer have been newly established” in the database management unit, for example. The affected department determination unit matches a database of business contents, business processes, areas of charge, managed asset lists, outsourcing contractor lists, related system lists, used data types, various regulations/manuals, training materials, past internal notices, past internal audit findings, and the like of each department such as an information management department, a legal department, a general affairs department, and a public relations department registered in the server with the main points of the legal revision extracted by the legal revision information acquisition unit, and inputs a prompt sentence such as “Match the following main points of the legal revision with the business content database of each department, and list affected departments. Extract highly relevant business processes and managed assets as well.” to the generative AI. Specifically, the present system normalizes and inserts the main point data of the legal revision output from the large language model into a dedicated table of a relational database. The present system vectorizes the stored main point data using a natural language processing model, and generates a legal revision feature vector. In parallel, the present system reads a profile data group of each department held in the database management unit. The present system similarly vectorizes text data such as “customer database operation” of the information management department, “contract review” of the legal department, and “employee data management” of the general affairs department, and generates a department profile vector. The present system calculates a cosine similarity in a multidimensional space between the legal revision feature vector and each department profile vector. The present system specifies a pair of a department and a main point of the legal revision whose similarity score exceeds a predetermined threshold. The present system combines data of the specified pair, and dynamically constructs an input prompt to the large language model. The present system causes the large language model to infer a logical causal relationship between the business process and the laws and regulations, rather than a mere keyword match. The present system generates, as an output from the large language model, structured data indicating a list of affected departments, specific affected business processes, and a direction of a necessary response. The present system generates, for example, mapping data indicating that the “information management department” corresponds to the “reporting obligation at the time of leakage” and “revision of an incident response flow” is necessary as the output data. With this configuration, the present system highly integrates siloed business data in an organization and external legal and regulatory data. The present system specifies an impact range of the legal revision cross-sectionally and comprehensively throughout the company. The present system prevents an omission of response in a specific department and a coordination error between related departments in advance. The present system brings about a technical effect of mathematically and systematically reducing a compliance risk of the entire company. The present system visualizes the generated mapping data of the affected departments as a network graph through the user interface unit. The present system provides a decision-making support tool for a management layer and a legal manager to intuitively grasp a company-wide degree of impact and quickly determine optimal allocation of resources.

The generative AI determines that, for example, the information management department in charge of “management and operation of personal information”, “database management”, “outsourcing contractor management”, and “access authority management” is an affected department because it is directly related to the legal revision contents of the Act on the Protection of Personal Information, and determines that the legal department is an affected department requiring modification of a contract template or an explanation document if it is in charge of “contract management”, “specified commercial transactions”, “intellectual property management”, and “litigation response”. The response plan generation unit inputs a prompt sentence such as “Create a necessary operation change proposal, material modification proposal, modification proposal for an existing manual, and new business proposal based on the following main points of the legal revision and business contents of the department.” or “Create a script for a briefing session and a FAQ draft with the following contents.” to the generative AI for each department determined to be affected, and proposes, for example, to the information management department, an operation change proposal such as “reviewing an operation flow of a third-party provision record of personal information”, “newly formulating a reporting procedure at the time of leakage”, “modifying a contract template with an outsourcing contractor”, and “revising an access authority management regulation”, and a modification proposal for an existing operation manual or internal regulations. To the legal department, it proposes “addition of a new contract clause”, “revision of an explanation document regarding specified commercial transactions”, “introduction of a new consent acquisition procedure”, “review of litigation risk evaluation”, and the like. To the general affairs department, it proposes “update of training materials for employees”, “creation of an internal notice document”, “redesign of an internal training program”, and the like. To the public relations department, it proposes “revision of terms of use for communication services”, “modification of an explanation material during external negotiation”, “change of a notification procedure to an administrative agency”, and the like. Specifically, the present system executes advanced inference processing using a large language model. The affected department determination unit inputs a legal revision main point text and a business content text of each department to a natural language processing module. The natural language processing module tokenizes the input text in units of subwords. The module converts a token sequence into a multidimensional word embedding vector. The module inputs the converted vector to a neural network equipped with a self-attention mechanism. The network calculates a semantic relevance between the legal revision main point vector and the business content vector. The network outputs an attention score indicating the relevance. The affected department determination unit specifies the corresponding department as an affected department when the calculated attention score exceeds a predetermined threshold. The response plan generation unit acquires an identifier and the business content vector of the specified affected department. The response plan generation unit combines the legal revision main point vector and the business content vector, and inserts them into a prompt template. The response plan generation unit inputs the generated prompt character string to the large language model. Input data to the large language model is a text tensor expressed as, for example, a 512-dimensional floating-point number array. The input data includes “main points of revision of the Act on the Protection of Personal Information” and “business contents of the information management department”. The large language model calculates an appearance probability distribution of a next word based on the input tensor. The model searches for an optimal word sequence using a beam search algorithm. Output data from the model is an array of token IDs constituting the generated response plan text. The output data is decoded into a character string indicating a specific action such as “reviewing an operation flow”, for example. The response plan generation unit formats the decoded text as structured data. The present system transmits this structured data to the database management unit. The database management unit stores the received data in a response plan table of a relational database. By this processing, the present system automatically generates a comprehensive and accurate response plan through semantic analysis in a high-dimensional vector space without relying on human intuition. This configuration improves comprehensiveness in a legal revision response business. This configuration reduces a risk of compliance violation due to an omission of response. This configuration enables efficient use of computer resources. The present system is particularly effective in fields where strict legal compliance is required, such as financial institutions and medical institutions.

Furthermore, regarding a new business opportunity newly enabled by the legal revision, the generative AI makes a proposal with a prompt sentence such as “Propose a new business plan that can be newly implemented by the legal revision based on the following main points of the legal revision and business contents of the department.”, and presents “launch of a new data utilization service”, “development of a consulting business compliant with the revised law”, “development of a service for a new customer segment”, “entry into a new market through business alliance with another company”, and the like. A dissemination material of the legal revision contents, a FAQ draft, a script for a briefing session, and a time allocation proposal are also automatically generated for each department, and using a prompt sentence “Create a script for a briefing session and a FAQ draft with the following contents.”, a script such as “overview explanation of revision contents in the first 10 minutes, explanation of specific countermeasures in the next 15 minutes, and Q&A in the remaining 5 minutes” and a FAQ such as “scope of application of new provisions”, “impact on existing business”, “specific procedure for operation change”, “necessity of internal training”, and “response to outsourcing contractors” are created, for example. Specifically, the response plan generation unit uses a fine-tuned large language model specialized for searching for a new business opportunity. The response plan generation unit generates an input tensor combining the legal revision main point vector and a management resource vector of its own company. The input tensor is, for example, a 1024-dimensional floating-point number array. The input tensor includes “specific contents of deregulation” and “list of data held by its own company”. The large language model processes the input tensor with a multi-layer transformer block. The model performs inference using a weight parameter pre-trained with a past success case dataset. Output data from the model is structured text data in JSON format including a title, an overview, and an expected revenue effect of the new business plan. The output data includes a character string “consulting business compliant with revised law”, for example. The response plan generation unit inputs the output new business plan to an evaluation module. The evaluation module scores feasibility and a market size. The present system transmits only a proposal whose score satisfies a certain standard to the user interface unit. The response plan generation unit also executes generation processing of the dissemination material and the FAQ. The response plan generation unit drives a summarization model with the legal revision main points and the response plan text as inputs. The summarization model executes an extractive summarization algorithm that extracts an important sentence from a long text. The summarization model executes a generative summarization algorithm that reconstructs the extracted sentence into a natural sentence. Output data from the model is numerical data indicating a timetable of the briefing session and a script text of each session. The output data includes time allocation data such as “10 minutes” and “15 minutes”, for example. The present system can also input the generated script text to a voice synthesis module to generate an automatic voice guidance. By this processing, the present system creates an opportunity for business growth triggered by the legal revision, not limited to mere legal compliance. This configuration significantly reduces human resources and time required for new business planning. This configuration enables a logical business proposal based on objective data. The present system functions as a tool for securing a competitive advantage in a rapidly changing information and communication industry and fintech field.

A person in charge of each department can browse and download the generated summary, affected department list, response plan, dissemination material, FAQ, script for a briefing session, and the like through the user interface unit and the material browsing/editing unit, and can make additions and modifications as necessary. A briefing session, internal training, a briefing session for outsourcing contractors, and the like are also implemented utilizing the AI-generated materials. When the person in charge inputs a question from the terminal after the briefing session or during daily operations, the generative AI on the server generates an optimal answer with a prompt sentence “Answer the following question practically and specifically based on the main points of the legal revision and the business contents of the department.” through the chatbot response unit, and immediately answers questions such as “In what cases is the new recording obligation applied?”, “Where should the existing operation manual be modified?”, “At what timing should notification to outsourcing contractors be performed?”, and “Which part of the training materials should be updated?”. Specifically, the user interface unit is implemented as a single-page application operating on a web browser. The material browsing/editing unit transmits and receives data to and from the server using an asynchronous communication protocol. The material browsing/editing unit executes exclusive control and differential synchronization processing using an operational transformation algorithm to enable simultaneous editing by a plurality of users. The chatbot response unit adopts a retrieval-augmented generation architecture. The chatbot response unit receives a question text input from a user terminal. The chatbot response unit inputs the question text to the natural language processing module, and converts it into a question vector. The question vector is, for example, a 768-dimensional dense vector. The chatbot response unit searches a vector database using the question vector. In the vector database, the main points of the legal revision, internal regulations, and past Q&A data are vectorized and stored. The chatbot response unit extracts top five context texts most similar to the question vector by cosine similarity calculation. The chatbot response unit combines the extracted context texts and the question text, and generates a prompt. The chatbot response unit inputs the generated prompt to an interactive large language model. Input data to the model is a text tensor including a question content and an excerpt of related internal regulations. Output data from the model is structured data including a specific answer text to the question and a document ID of a reference source. The output data includes a specific instruction such as “Please modify Chapter 3, Section 2 of the operation manual”, for example. The chatbot response unit transmits the output answer text to the user terminal, and displays it on a screen. By this processing, the present system provides an accurate and contextual answer reflecting specific internal circumstances to a user's question in real time. This configuration dramatically reduces a load of responding to inquiries to the legal department and a compliance department. This configuration improves a company-wide degree of understanding of the legal revision and a response speed. The present system is extremely useful in a large company having a large number of employees and a manufacturing industry having a complex business process.

Furthermore, the log management unit, the notification management unit, and the history management unit cooperate to centrally manage all processing histories of the system, user operation histories, AI output histories, response progress, notification histories, past legal revision response histories, and the like, and the notification management unit automatically distributes notifications such as “new legal revision information has been added”, “own department has been selected as an affected department”, “new response plan has been generated”, “invitation to hold a briefing session”, and “FAQ has been updated”, and a reminder notification of an unaddressed task. The history management unit records response contents and progress status at the time of past legal revisions in chronological order, and can utilize them as reference information at the time of future legal revisions. Specifically, the log management unit tracks all events in the system using a distributed tracing system. The log management unit asynchronously collects log data output from each microservice via a message queuing system. The log management unit stores the collected log data in a time-series database. The time-series database realizes high-speed writing and retrieval using a time stamp as a primary key. The notification management unit adopts an event-driven architecture based on a publish-subscribe model. The notification management unit detects a data update event in the database management unit. The notification management unit evaluates a predefined routing rule according to a type of the update event. The notification management unit generates a user ID list to be notified based on the routing rule. The notification management unit executes a push notification, an e-mail, or a message transmission to an internal chat tool addressed to the user ID list. The history management unit stores all related documents, task completion states, and communication histories in a graph database for each past legal revision response project. The graph database expresses documents and tasks as nodes, and expresses their dependency relationships as edges. The history management unit searches for a past similar project using a graph neural network when new legal revision information is input. The history management unit extracts a response history of the similar project, and provides it to the response plan generation unit as context information. By this processing, the present system automatically reuses past knowledge, and realizes continuous improvement of a response process. This configuration prevents loss of tacit knowledge due to transfer or retirement of a person in charge. This configuration ensures reliability as an audit trail, and reduces a response load during an external audit. The present system functions as a foundation system for strengthening governance in a listed company or a financial institution where strict record keeping is required.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

Embodiments of the present invention will be described more specifically and in detail, taking a system for supporting response to legal revisions in an electronic payment service field as an example. The system of the present invention is composed of a server and a terminal, and a legal revision information acquisition unit, an affected department determination unit, a response plan generation unit, a database management unit, a generative AI execution unit, a log management unit, a notification management unit, and a history management unit are provided on the server side, and a user interface unit, a material browsing/editing unit, a chatbot response unit, a notification receiving unit, and an operation log transmission unit are provided on the terminal side. Specifically, the present system adopts a scalable distributed processing architecture constructed on a cloud computing environment. The server is an arithmetic cluster composed of a plurality of virtual machine instances. The server deploys each processing unit as an independent microservice using a container orchestration tool. The legal revision information acquisition unit, the affected department determination unit, and the response plan generation unit are each executed in an independent container. The generative AI execution unit is arranged on a dedicated arithmetic node equipped with a plurality of image processing semiconductor devices in order to speed up a large-scale matrix operation. The database management unit is configured as a distributed database cluster spanning a plurality of availability zones in order to enhance availability and fault tolerance. The terminal is an information processing apparatus such as a personal computer, a smartphone, or a tablet terminal. The terminal is connected to the server using a secure encrypted communication protocol. The user interface unit is implemented using a reactive programming method, and updates a screen without delay in response to a user operation. The operation log transmission unit captures an operation event such as a user's mouse movement, click, and keyboard input. The operation log transmission unit summarizes the captured event data into a certain batch size, and transmits it to the server as a background process. With this configuration, the present system provides high processing performance and stability for a huge amount of transaction data and frequent legal revision information peculiar to the electronic payment service field. This configuration makes it possible to continue service provision as a whole even when a failure occurs in a part of the system. The present system exhibits extremely high reliability in a mission-critical financial infrastructure that requires 24-hour, 365-day non-stop operation.

The legal revision information acquisition unit receives a variety of legal revision-related documents such as revised legal texts of the Payment Services Act, the Act on Prevention of Transfer of Criminal Proceeds, consumer protection-related laws, the Act on Preservation of Electronic Books, tax reforms, the Act on the Protection of Personal Information, and the like, guidelines, administrative agency notices, industry association views, reference judicial precedents, administrative guidance documents, public comments, and related press materials uploaded from a terminal by a legal person in charge, a risk management person in charge, a system development person in charge, a customer support person in charge, a sales person in charge, and the like. For example, revised legal texts of the Payment Services Act in PDF format, guidelines in HTML format, industry association views in a Word file, administrative notices automatically acquired from an administrative agency website, aggregated results of public comments, clipping data of newspaper articles, commentary articles in industry specialized magazines, FAQs of administrative agencies, past administrative guidance cases, and the like are targeted. Furthermore, it is also possible to automatically acquire them from an external legal database or an administrative agency website by API linkage or crawling. For example, it is possible to automatically acquire the latest legal revision information from an API of an administrative agency every day, and periodically crawl guidelines and commentary materials from a website of an industry association. The legal revision information acquisition unit passes the received or acquired document to the generative AI execution unit, generates a prompt sentence such as “Summarize the following revised legal texts of the Payment Services Act, and extract main revision points, an enforcement date, added obligations, strengthening of penal provisions, and transitional measures”, “Summarize an administrative agency interpretation policy, practical points to note, and an impact on an electronic payment service from the following full text of the guidelines”, “Summarize major opinions and administrative agency answers from the following public comment results”, and “Extract questions assumed in the field and answers thereto from the following administrative agency FAQ”, for example, and instructs the generative AI to analyze. Specifically, the legal revision information acquisition unit executes a data pipeline that collects unstructured data from various data sources and converts it into structured data. The legal revision information acquisition unit receives a binary file uploaded from the terminal. The legal revision information acquisition unit analyzes an extension and header information of the file using a file format discrimination algorithm. The legal revision information acquisition unit activates an optical character recognition engine for a PDF file or an image file, and extracts text data. The legal revision information acquisition unit includes a web crawler module. The web crawler module periodically transmits an HTTP request based on a preset URL list. The web crawler module analyzes a DOM tree from the acquired HTML document, and extracts a body text. The legal revision information acquisition unit executes authentication protocol processing for linking with an external API. The legal revision information acquisition unit executes preprocessing on the extracted text data. The preprocessing includes deletion of unnecessary symbols, normalization, and removal of stop words. The legal revision information acquisition unit divides the preprocessed text data into chunks. The legal revision information acquisition unit combines the divided text chunk and a prompt template including an extraction instruction. The legal revision information acquisition unit inputs the generated prompt to the generative AI execution unit. Input data to the generative AI execution unit is a text sequence consisting of, for example, thousands of tokens. The input data includes “draft revision of Article 20 of the Payment Services Act” and an instruction “extract an enforcement date”. The generative AI execution unit analyzes the input text sequence, and specifies a text span corresponding to a designated item. By this processing, the present system completely automates a huge amount of document collection and reading work that a human has manually performed. This configuration prevents an omission of information acquisition, and makes it possible to incorporate the latest legal and regulatory trends into the system in real time. This configuration improves accuracy of data input, and ensures quality of subsequent analysis processing. The present system becomes an indispensable information collection foundation for maintaining compliance in a fintech industry where laws and regulations are frequently changed.

The generative AI execution unit automatically extracts and summarizes a purpose of revision, revision points, a time of enforcement, new rules to be complied with, an impact on an industry, added obligations, strengthening of penal provisions, transitional measures, and the like using a natural language processing technology, and stores main points such as “strengthening of identity verification procedure”, “addition of transaction record preservation obligation”, “new AML/CFT requirement”, “change in upper limit amount of electronic payment transaction”, “new user explanation obligation”, “addition of electronic signature requirement”, “certification of new identity verification document”, “change in reporting standard for suspicious transaction”, “strictification of member store examination standard”, “new establishment of reporting obligation at the time of system failure”, and “introduction of user compensation system” in the database management unit, for example. For example, it extracts “extension of preservation period of identity verification document”, “addition of new identity verification method”, “change in reporting standard for suspicious transaction”, and the like from an administrative agency notice. For example, it extracts “proposal for changing industry standard operation flow”, “necessity of strengthening training for member stores”, “recommendation of new API specification”, “strengthening of security requirement”, and the like from an industry association view. For example, it extracts “concerns from users”, “requests from business operators”, “answers from administrative agencies”, “issues of entire industry”, and the like from public comments. Specifically, the generative AI execution unit executes pipeline processing combining a named entity extraction model and a text summarization model. The generative AI execution unit inputs the input text chunk to a bidirectional transformer encoder. The encoder calculates a context-dependent embedding vector of each token. The generative AI execution unit inputs the embedding vector to a conditional random field layer, and calculates a probability that each token belongs to a specific entity class. The generative AI execution unit predicts a label sequence with the highest probability, and extracts a corresponding text span. The generative AI execution unit also inputs the extracted text span to an autoregressive decoder network. The decoder network converts the extracted information into a concise summary sentence. Output data from the generative AI execution unit is a JSON object including a key-value pair of the extracted entity and a summary text. The output data includes data such as a value “Apr. 1, 2024” for a key “time of enforcement” and a value “seven-year preservation of transaction record” for a key “added obligation”, for example. The generative AI execution unit transmits the output JSON object to the database management unit. The database management unit maps the received data to each column of a legal revision main point table and saves it. By this processing, the present system extracts meaningful structured data from an unstructured text with high accuracy. This configuration converts a long and difficult legal document into a data format processable by a computer. This configuration provides foundation data for performing accurate logical inference in subsequent affected department determination and response plan generation processing. The present system realizes accuracy equal to or higher than that of a human expert and overwhelming processing speed in interpretation of financial regulations having a complex legal system.

The affected department determination unit matches databases of business contents, business flows, areas of charge, managed assets, outsourcing contractors, related systems, used data types, existing regulations/manuals, training materials, past legal revision response histories, internal audit findings, external audit reports, outsourcing contracts, system design documents, operation manuals, customer response manuals, member store management ledgers, transaction monitoring rules, risk assessment sheets, internal reporting records, past administrative guidance response histories, and the like of each department such as a service operation department, a system development department, a customer support department, a risk management department, a sales department, an accounting department, a legal department, and an audit department with main points of the legal revision extracted by the generative AI. For example, if the service operation department is in charge of “identity verification”, “member store management”, “payment service operation”, “user compensation response”, and “new service planning”, it is automatically extracted as a department affected by strengthening of identity verification procedures, new user explanation obligations, introduction of a user compensation system, and legal conformity assessment of new services. For example, if the system development department is in charge of “payment system development”, “API management”, “security response”, “failure response”, “database design”, “log management”, and “external system linkage”, it is extracted as a department affected by transaction record preservation obligations, system specification changes, API specification changes, strengthening of security requirements, and failure reporting obligations. For example, if the customer support department is in charge of “customer response”, “identity verification document reception”, “FAQ response”, “complaint processing”, “user compensation reception”, and “identity verification re-procedure guidance”, it becomes a department affected by new explanation obligations to customers, identity verification flow changes, and user compensation system responses. For example, if the risk management department is in charge of “AML/CFT response”, “transaction monitoring”, “legal compliance”, “risk assessment”, “internal audit”, “external audit response”, “suspicious transaction reporting”, and “formulation of risk mitigation measures”, it becomes a department affected by new AML/CFT requirements, monitoring standard changes, review of internal audit procedures, and external audit responses. For example, if the sales department is in charge of “member store cultivation”, “service proposal”, “customer explanation”, “new market research”, “member store examination”, “contract conclusion”, and “holding of new service briefing sessions”, it is necessary to respond to changes in explanation materials for member stores and new service proposals, and strictification of member store examination standards. For example, if the accounting department is in charge of “payment transaction record management”, “book preservation”, “tax return”, and “Act on Preservation of Electronic Books response”, it becomes a department affected by the revision of the Act on Preservation of Electronic Books and tax reforms. For example, if the legal department is in charge of “contract management”, “legal research”, “litigation response”, “administrative response”, and “internal regulation management”, it is necessary to respond to modification of contract templates and new legal obligations. For example, if the audit department is in charge of “internal audit”, “external audit response”, “risk assessment”, and “audit report creation”, it is necessary to add audit items and review audit procedures due to the legal revision. Specifically, the affected department determination unit executes a similarity calculation algorithm in a multidimensional vector space. The affected department determination unit acquires business content texts and related document groups of each department from the database management unit. The affected department determination unit inputs the acquired text groups into an embedding model, and generates a department profile vector representing each department. The department profile vector is, for example, a 2048-dimensional dense vector. The affected department determination unit inputs the legal revision main point text extracted by the generative AI execution unit into the same embedding model, and generates a legal revision main point vector. The affected department determination unit calculates a cosine similarity between the legal revision main point vector and each department profile vector. The affected department determination unit normalizes the calculated similarity score, and calculates it as a degree of impact score for each department. The affected department determination unit specifies a department whose degree of impact score exceeds a preset threshold as an affected department. Input data to the affected department determination unit is a tensor consisting of the legal revision main point vector and a plurality of department profile vectors. Output data from the affected department determination unit is array data including a pair of an identifier of each department and the degree of impact score. The output data includes numerical data such as “system development department: score 0.89” and “risk management department: score 0.92”, for example. The affected department determination unit transmits a list of the specified departments to the response plan generation unit. By this processing, the system evaluates semantic relevance with high accuracy, which cannot be captured by a simple method such as keyword matching. This configuration makes it possible to specify the impact range of the legal revision from the entire organization without omission. This configuration prevents unnecessary notifications to unaffected departments, and optimizes the business efficiency of the entire organization. The system clarifies the demarcation point of responsibility between departments in a large company having a complex matrix organization, and supports the construction of a prompt response system.

The response plan generation unit inputs prompt sentences such as “Create a necessary operation flow change proposal, system specification change proposal, customer notification proposal, modification proposal for an existing manual, new identity verification service proposal, member store examination standard revision proposal, failure response procedure review proposal, user compensation system introduction proposal, FAQ update proposal, training material revision proposal, internal audit checklist modification proposal, outsourcing contractor response proposal, API specification change proposal, database design change proposal, and risk assessment procedure review proposal based on the following main points of the legal revision and business contents of the department”, “Create a script for a briefing session and a FAQ draft with the following contents”, and “Create a customer notification template with the following contents” using the generative AI for each department determined to be affected, and the AI automatically generates, for example, “review of identity verification flow”, “creation of new user explanation text”, “revision of member store management regulations”, “formulation of introduction procedure of user compensation system”, and “addition of legal conformity assessment flow of new service” for the service operation department, “addition of transaction record preservation function”, “API specification change”, “strengthening of security requirements”, “implementation of automatic reporting function at the time of failure”, “review of external system linkage specification”, “database design change”, and “strengthening of log management function” for the system development department, “formulation of new identity verification document reception procedure”, “update of FAQ”, “creation of customer notification template”, “review of complaint processing procedure”, “addition of user compensation reception flow”, and “creation of identity verification re-procedure guidance text” for the customer support department, “introduction of new AML/CFT monitoring standard”, “review of risk assessment procedure”, “update of internal audit checklist”, “revision of suspicious transaction reporting standard”, “formulation of risk mitigation measures”, and “review of external audit response procedure” for the risk management department, “revision of explanation material for member stores”, “creation of new service proposal material”, “response to strictification of member store examination standards”, “review of new market research procedure”, and “creation of script for new service briefing session” for the sales department, “revision of book preservation procedure”, “review of tax return flow”, and “modification of Act on Preservation of Electronic Books response manual” for the accounting department, “modification of contract template”, “creation of response plan to new legal obligations”, “revision of internal regulations”, and “review of administrative response procedure” for the legal department, and “addition of audit items”, “review of audit procedure”, and “modification of audit report format” for the audit department. For example, regarding a service or a business opportunity newly enabled by the legal revision, the generative AI also proposes “launch of new identity verification service”, “new market cultivation of electronic payment transactions”, “new service development by API linkage”, “provision of legal revision response consulting service”, “development of risk assessment service for member stores”, and “new customer acquisition measure utilizing user compensation system” with a prompt sentence “Propose a new business proposal newly executable by the legal revision based on the following main points of the legal revision and business contents of the department”. Specifically, the response plan generation unit executes a conditional text generation algorithm. The response plan generation unit acquires text data of a business manual and a system design document of the corresponding department from the database management unit based on the department identifier received from the affected department determination unit. The response plan generation unit combines the acquired text data and the legal revision main point data, and generates a context vector. The response plan generation unit embeds the context vector into a variable part of a prompt template. The response plan generation unit inputs the generated prompt into a large language model. Input data to the large language model is a token array of several thousand dimensions including, for example, “current API specification of system development department” and “new security requirements”. The large language model autoregressively predicts the next token based on the input token array, and generates a response plan text. The model adjusts a temperature parameter in a generation process, and controls a balance between diversity and accuracy of output. Output data from the model is a structured JSON format text including specific action items, person in charge roles, and estimated deadlines. The output data includes detailed instructions such as “Action: Update encryption method of API endpoint”, “Target system: Payment gateway”, and “Priority: High”, for example. The response plan generation unit inputs the generated response plan text into a syntax analysis module, and verifies validity of a format. The response plan generation unit stores the response plan that has passed the verification in the database management unit. By this processing, the system converts abstract legal revision contents into specific business tasks immediately executable by each department. This configuration dramatically shortens a lead time of a planning phase in the legal revision response. This configuration clarifies tasks requiring cooperation between departments, and improves efficiency of project management. The system supports optimal allocation of development resources in an electronic payment service involving a wide variety of system modifications.

The legal revision notification material, FAQ draft, script for a briefing session, customer notification template, training material, operation manual modification proposal, contract template modification proposal, audit checklist, outsourcing contractor response material, API specification document, database design document, risk assessment sheet, and the like automatically generated by the AI for each department can be viewed, edited, and downloaded by each person in charge through the user interface unit and the material viewing and editing unit. For example, the service operation department can add its own operation to the AI-generated identity verification flow proposal, the system development department can add requirements specific to its own system to the API specification change proposal, the customer support department can add frequently asked questions in the field to the FAQ draft, and the sales department can incorporate its own strengths into the new service proposal material. For example, the audit department can also add its own audit items to the AI-generated audit checklist. Specifically, the material viewing and editing unit includes a rich text editor component and a version control module. The material viewing and editing unit acquires corresponding document data from the database management unit in response to a request from a user terminal. The material viewing and editing unit renders the acquired data into an HTML format, and transmits it to the user interface unit. The user interface unit displays the rendered document on a screen. The material viewing and editing unit captures operation events of text addition, deletion, and format change by the user in real time. The material viewing and editing unit converts the operation events using an operational transformation algorithm, and synchronizes them with master data on the server. The material viewing and editing unit creates a new version of the document every time editing is confirmed, and saves it in the database management unit together with a change difference. The material viewing and editing unit executes a merge process for resolving a conflict when a plurality of users edit the same document at the same time. By this processing, the system provides an environment for seamlessly integrating human expertise and company-specific know-how into a baseline document generated by the AI. This configuration eliminates a start-up work from scratch for document creation, and makes it possible to concentrate human resources on review and elaboration works. This configuration enables complete tracking of a change history, and secures an audit trail of who modified which part and when. The system achieves both improvement of business quality and reduction of working time in a compliance department of a financial institution where strict document management is required.

Briefing sessions, internal training, briefing sessions for member stores, briefing sessions for outsourcing contractors, briefing sessions for group companies, and the like are also implemented utilizing the AI-generated materials, and for example, the service operation department holds an internal briefing session on a new identity verification flow, the customer support department conducts training on a new procedure for customer response, the sales department implements a new service briefing session for member stores, the accounting department conducts internal training on the revision of the Act on Preservation of Electronic Books, the legal department holds a company-wide briefing session on new legal obligations, and the audit department holds a briefing session on changes in audit procedures. When a person in charge inputs a question from the terminal after the briefing session or during daily operations, the generative AI on the server immediately answers questions such as “What are specific contents of new identity verification requirements?”, “In what cases are transaction record preservation obligations applied?”, “At what timing should notification to customers be performed?”, “What are specific contents of API specification changes?”, “What is the basis for adding audit items?”, “To what extent is the target range of the user compensation system?”, “How should response to outsourcing contractors be performed?”, and “What are legal points to note for new market cultivation?” with a prompt sentence “Answer the following question practically and specifically based on the main points of the legal revision and the business contents of the department” through the chatbot response unit. Specifically, the chatbot response unit is implemented as a dialogue system including a session management function and a memory network. When receiving a question text from the user terminal, the chatbot response unit specifies a session ID of the user. The chatbot response unit acquires a past dialogue history and an affiliated department profile of the user from the database management unit based on the session ID. The chatbot response unit combines the question text, the dialogue history, and the department profile, and generates a prompt holding a context. The chatbot response unit inputs the generated prompt into the large language model. Input data to the large language model is a text tensor including a question “What are specific contents of API specification changes?” from “a user of the system development department”, for example. The large language model generates an answer text specialized for an internal system configuration based on the input tensor. Output data from the model is structured data including the answer text and a hyperlink to a related internal document. The output data includes a specific instruction such as “It is necessary to shorten an expiration date of an authentication token. Please refer to the linked design document for details”, for example. The chatbot response unit transmits the output answer data to the user terminal. By this processing, the system provides a highly personalized answer after understanding user attributes and past contexts. This configuration immediately solves complex practical questions that cannot be handled by a general FAQ system. This configuration significantly reduces the number of escalations to the legal department, and prevents company-wide business stagnation. The system functions as a hub for information sharing in a large-scale legal revision project involving a large number of stakeholders.

In addition, the log management unit records all processing histories of the system, operation histories of users, output histories of the AI, and the like, and records in detail, for example, who uploaded which legal revision document and when, which department viewed and edited which response plan, what kind of AI answer was made to which question, which notification was transmitted to whom, which material was modified and how, which progress was completed at which point in time, which outsourcing contractor performed which response, and which group company referred to which material. The notification management unit automatically distributes legal revision information, response plans, material updates, briefing session holding guidance, FAQ updates, reminders of unhandled tasks, and the like to each terminal, and can immediately receive notifications such as “New legal revision information has been added”, “Own department has been selected as an affected department”, “New response plan has been generated”, “Briefing session holding guidance”, “FAQ has been updated”, “There is an unhandled task”, “Response to outsourcing contractor is incomplete”, and “Material distribution to group companies has been completed”, for example. The history management unit records response contents and progress statuses at the time of past legal revisions in chronological order, and can utilize them as reference information at the time of future legal revisions. For example, it records in chronological order which department performed what kind of response, which material was modified, what kind of questions were frequent, what kind of new business proposals were made, which outsourcing contractor performed which response, which group company referred to which material, and the like at the time of past legal revisions. Specifically, the log management unit adopts structured logging and distributed tracing technologies in order to secure observability in a distributed system environment. The log management unit collects event data output from each microservice as a JSON format log entry. The log entry includes a timestamp, a user ID, a session ID, an executed API endpoint, and a status code of processing. The log management unit transfers the collected log entries to a log aggregation infrastructure, and saves them in a searchable state by assigning indexes. The notification management unit adopts an asynchronous communication architecture using a message broker. The notification management unit publishes a notification message to a message queue triggered by a specific event occurring in the system. A subscriber process of the notification management unit acquires the message from the queue, and selects an optimal distribution channel based on notification settings of the user. The history management unit constructs a data warehouse, and stores the accumulated log data and response history data in a format capable of multidimensional analysis. The history management unit applies a machine learning algorithm targeting past project data, and constructs a model for predicting a delay risk of a task and a sign of resource shortage. By this processing, the system completely visualizes an operation status of the entire system, and speeds up troubleshooting. This configuration push-distributes information to an appropriate user at an appropriate timing, and prevents neglect of tasks and omission of responses. This configuration utilizes past data not merely as a record but as prediction data for optimizing future project management. The system satisfies strict audit requirements and strongly supports continuous process improvement of the organization.

Furthermore, for example, even when a plurality of legal revisions occur at the same time, the generative AI can independently analyze each legal revision content, and automatically adjust duplication of affected departments and consistency of response plans. For example, when the Payment Services Act and the Act on the Protection of Personal Information are revised at the same time, it is possible to present a complex operation change proposal and material modification proposal corresponding to both legal revisions to a department affected by both. In addition, even when different business processes and management systems exist for each department, the generative AI learns the business flow and past operation history of each department, and individually generates an optimal response plan. For example, even for the same legal revision, it individually proposes “revision of identity verification flow” to the service operation department, “presentation of API specification change proposal” to the system development department, “presentation of FAQ update proposal” to the customer support department, “introduction proposal of new monitoring standard” to the risk management department, “creation proposal of new service proposal material” to the sales department, “revision proposal of book preservation procedure” to the accounting department, “modification proposal of contract template” to the legal department, and “addition proposal of audit items” to the audit department. Specifically, the generative AI execution unit executes dependency modeling using a graph neural network in order to integrally process a plurality of pieces of legal revision information. The generative AI execution unit constructs a knowledge graph with the main point text of each legal revision as a node and semantic relevance between them as an edge. The generative AI execution unit updates feature amounts of nodes using a graph convolutional network, and learns interactions between legal revisions. The response plan generation unit receives the updated feature amount vector as an input, and solves a constraint satisfaction problem that simultaneously satisfies a plurality of legal regulatory requirements. Input data to the response plan generation unit is a multidimensional tensor combining, for example, a “Payment Services Act revision vector” and an “Act on the Protection of Personal Information revision vector”. The response plan generation unit generates a consistent complex response plan text after taking both vectors into consideration. Output data from the model is structured data including a single business flow change proposal integrating responses to a plurality of legal regulations. The output data includes a specific action such as “Integrate consent acquisition process of personal information acquired at the time of identity verification”, for example. The response plan generation unit also holds a state transition model representing a unique business flow of each department. The response plan generation unit simulates whether the generated response plan is executable in the state transition model of each department. By this processing, the system consistently integrates a plurality of complexly intertwined legal regulatory requirements, and prevents confusion in the field. This configuration allocates the most efficient and feasible task after deeply understanding the context of each department. This configuration completely automates a consistency confirmation work between legal regulations manually performed by the legal department. The system dramatically improves compliance response capability of a company in a modern business environment where a regulatory environment is becoming complex.

In addition, for example, it is also possible to open a part of functions of the system to outsourcing contractors and group companies, and strengthen cooperation in legal revision response. The outsourcing contractor can input its own response status from the terminal, and refer to the AI-generated material. For example, “new contract template for outsourcing contractors”, “operation change proposal for group companies”, “training material for outsourcing contractors”, “FAQ for group companies”, and the like can be automatically generated and shared among related parties. Specifically, the system implements a multi-tenant architecture and a role-based access control mechanism. The system constructs a logically separated tenant environment for each outsourcing contractor and group company. The database management unit applies row-level security, and guarantees data isolation so that each tenant can access only its own data. The user interface unit dynamically switches menus to be displayed and operable functions based on role information of a logged-in user. When generating a material for outsourcing contractors, the response plan generation unit adds a context parameter “for outsourcing contractors” to the prompt. Input data to the response plan generation unit is a tensor including the legal revision main point vector and a contract condition vector with the outsourcing contractor. Output data from the response plan generation unit is a document text in which confidential information is masked and expressions are adjusted for the outside. The output data includes a text such as “Compliance procedure of new security standard in outsourced business”, for example. The system distributes the generated document to the terminal of the outsourcing contractor via a secure file sharing protocol. The system receives a response completion report from the outsourcing contractor via an API, and automatically updates a progress status of the database management unit. By this processing, the system constructs a comprehensive compliance management system involving not only a single company but the entire supply chain. This configuration reduces communication costs with outsourcing contractors, and prevents delays and discrepancies in information transmission. This configuration strengthens governance of the entire group, and effectively reduces third-party risks. The system exhibits an extremely high introduction effect in a platform operator providing services in cooperation with a large number of partner companies.

As described above, in the embodiment of the present invention, by essentially utilizing the generative AI for the main processing unit on the server side and realizing user experiences such as user interface, chatbot response, notification reception, material editing, and progress management on the terminal side, it is possible to centrally and efficiently automate all processes of legal revision response in the electronic payment service field, reduce omission of responses and legal violation risks, promote discovery and proposal of new business opportunities caused by the legal revision, and realize both defensive response and offensive response. Specifically, by integrating an advanced natural language processing model and a distributed computing technology, the system fundamentally reconstructs legal compliance business, which conventionally relied on advanced human cognitive abilities, with a computer science approach. The system pipelines and executes a series of algorithms of structuring unstructured data, semantic similarity calculation in a high-dimensional vector space, and conditional text generation. The system reduces latency of analysis processing for a huge document group to a millisecond unit by parallelizing and executing these processes. The system realizes end-to-end automation without human intervention by directly inputting an inference result of a machine learning model into a subsequent business workflow engine. The system is not merely a business efficiency improvement tool, but an information processing apparatus that captures a change in an external environment, which is a change in legal regulations, as an update event of a data structure inside a company, and autonomously optimizes a state of the entire system. With this configuration, the system compresses human resources and time required for legal revision response to a fraction of conventional ones. This configuration eliminates human oversights and interpretation fluctuations, and mathematically guarantees accuracy of compliance response. This configuration enables data-driven business development by inputting constraints of legal regulations as parameters of a new business. The system provides an indispensable technical foundation for a company to achieve sustainable growth under a complex legal regulatory environment.

### (System Configuration)

The system according to the present embodiment includes a legal revision information acquisition unit, an affected department determination unit, a response plan generation unit, a database management unit, a generative AI execution unit, a log management unit, a notification management unit, a history management unit, a user interface unit, a material viewing and editing unit, a chatbot response unit, a notification receiving unit, and an operation log transmission unit. Specifically, the system is configured as a distributed processing system based on a cloud-native architecture. Each processing unit constituting the system is implemented as a containerized microservice, and operates on a container orchestration platform. The server is an aggregate of physical or virtual computing nodes including a multi-core processor, a large-capacity volatile memory, and a high-speed solid state drive. The generative AI execution unit is arranged on a dedicated computing node equipped with a plurality of image processing semiconductor devices specialized for tensor operations in order to speed up inference processing of a large language model. The database management unit adopts a hybrid configuration combining a relational database and a NoSQL database, and provides an optimal storage hierarchy according to characteristics of data. The terminal is an arbitrary information processing apparatus capable of executing a web browser, and is connected to the server via a secure encrypted communication channel. With this configuration, the system can flexibly scale out computing resources in response to fluctuations in processing load. This configuration eliminates a single point of failure, and realizes high availability and fault tolerance. The system provides a robust infrastructure that simultaneously satisfies enterprise-level security requirements and performance requirements.

The legal revision information acquisition unit has a function of receiving a variety of legal revision-related documents such as revised legal texts of the Payment Services Act, the Act on Prevention of Transfer of Criminal Proceeds, consumer protection-related laws, the Act on Preservation of Electronic Books, tax reforms, the Act on the Protection of Personal Information, and the like, guidelines, administrative agency notices, industry association views, reference judicial precedents, administrative guidance documents, public comments, and related press materials uploaded from a terminal by a legal person in charge, a risk management person in charge, a system development person in charge, a customer support person in charge, a sales person in charge, or the like, and further automatically acquiring them from an external legal database or an administrative agency website by API linkage or crawling. For example, it centrally collects revised legal texts of the Payment Services Act in PDF format, guidelines in HTML format, industry association views in Word files, administrative notices automatically acquired from administrative agency websites, aggregated results of public comments, clipping data of newspaper articles, commentary articles in industry specialized magazines, FAQs of administrative agencies, past administrative guidance cases, and the like. The legal revision information acquisition unit passes the received or acquired document to the generative AI execution unit, generates a prompt sentence such as, for example, “Summarize the following revised legal texts of the Payment Services Act, and extract main revision points, an enforcement date, added obligations, strengthening of penal provisions, and transitional measures”, “Summarize an administrative agency interpretation policy, practical points to note, and an impact on an electronic payment service from the following full text of the guidelines”, “Summarize main opinions and administrative agency answers from the following public comment results”, or “Extract questions assumed in the field and answers thereto from the following administrative agency FAQ”, and instructs the generative AI to analyze it. Specifically, the legal revision information acquisition unit functions as an advanced data pipeline module that executes extraction, transformation, and load processing. The legal revision information acquisition unit establishes secure data linkage using a RESTful API and an OAuth authentication protocol in communication with an external system. The legal revision information acquisition unit executes data cleansing processing such as unification of character codes, removal of unnecessary HTML tags, and noise removal using regular expressions on the acquired unstructured data. The legal revision information acquisition unit divides the cleansed text data into chunks in units of sentences or paragraphs using a natural language processing library. The legal revision information acquisition unit adds metadata (acquisition source URL, acquisition date and time, document type, etc.) to each divided chunk, and generates a structured JSON object. The legal revision information acquisition unit combines the generated JSON object and a prompt template including an extraction instruction. The legal revision information acquisition unit transmits the combined prompt character string to an inference API of the generative AI execution unit. Input data to the generative AI execution unit is character string data including, for example, “a text chunk of the revised legal texts of the Payment Services Act”. Output data from the generative AI execution unit is structured data in which extracted main point items are arranged as key-value pairs. The output data includes data such as, for example, “Enforcement date: Apr. 1, 2024” and “Added obligation: Preservation of transaction records”. By this processing, the system converts a wide variety of external data with irregular formats into a standard data format that can be uniformly processed inside the system. This configuration reduces noise in subsequent AI analysis processing, and dramatically improves extraction accuracy. This configuration realizes full automation of data collection work, and significantly reduces a business load on the legal person in charge. The system provides a robust data foundation in compliance business where freshness and accuracy of information are vital.

The affected department determination unit has a function of matching a database of business contents, business flows, areas of charge, managed assets, outsourcing contractors, related systems, used data types, existing regulations/manuals, training materials, past legal revision response histories, internal audit findings, external audit reports, outsourcing contracts, system design documents, operation procedure manuals, customer response manuals, member store management ledgers, transaction monitoring rules, risk evaluation sheets, internal reporting records, past administrative guidance response histories, and the like of each department such as a service operation department, a system development department, a customer support department, a risk management department, a sales department, an accounting department, a legal department, and an audit department with main points of the legal revision extracted by the generative AI, multilaterally analyzing a relevance between the business contents of each department and legal revision contents to automatically determine an affected department, and preferentially selecting a department with a high degree of impact. For example, if the service operation department is in charge of “identity verification”, “member store management”, “payment service operation”, “user compensation response”, and “new service planning”, it is automatically extracted as a department affected by strengthening of identity verification procedures, a new user explanation obligation, introduction of a user compensation system, and legal conformity evaluation of a new service. For example, if the system development department is in charge of “payment system development”, “API management”, “security response”, “failure response”, “database design”, “log management”, and “external system linkage”, it is extracted as a department affected by a transaction record preservation obligation, a system specification change, an API specification change, strengthening of security requirements, and a reporting obligation at the time of failure. For example, if the customer support department is in charge of “customer response”, “identity verification document reception”, “FAQ response”, “complaint processing”, “user compensation reception”, and “identity verification re-procedure guidance”, it becomes a department affected by a new explanation obligation to customers, an identity verification flow change, and a user compensation system response. For example, if the risk management department is in charge of “AML/CFT response”, “transaction monitoring”, “legal compliance”, “risk evaluation”, “internal audit”, “external audit response”, “suspicious transaction reporting”, and “formulation of risk mitigation measures”, it becomes a department affected by a new AML/CFT requirement, a monitoring standard change, a review of an internal audit procedure, and an external audit response. As an example of a prompt sentence to the generative AI, “Match the following main points of the legal revision with the business content database of each department, and list affected departments. Extract highly relevant business processes and managed assets as well.” is given. Specifically, the affected department determination unit executes clustering and classification algorithms in a multidimensional vector space. The affected department determination unit acquires text data indicating the business contents of each department from the database management unit, and converts it into a department profile vector using a pre-trained language model. The affected department determination unit similarly converts the legal revision main point text received from the generative AI execution unit into a legal revision main point vector. The affected department determination unit probabilistically determines to which department's business area class the legal revision main point vector belongs using a machine learning classifier such as a support vector machine or a random forest. Input data to the affected department determination unit is a feature quantity matrix composed of the legal revision main point vector and the profile vector of each department. Output data from the affected department determination unit is an array of impact probability scores for each department. The output data includes probability values such as, for example, “System development department: 0.95” and “Customer support department: 0.82”. The affected department determination unit sorts the calculated probability scores in descending order, and lists a department exceeding a predetermined threshold as an affected department. The affected department determination unit transmits the list of the specified affected departments and an identifier of a highly relevant business process to the response plan generation unit. By this processing, the system eliminates human subjective judgment, and realizes objective and quantitative impact evaluation based on data. This configuration accurately specifies a range affected by the legal revision, and prevents omission of response. This configuration enables triage for preferentially allocating resources from a department with a high degree of impact. The system speeds up initial launch of a cross-departmental project in a company having a large organizational scale and subdivided business.

The response plan generation unit inputs a prompt sentence such as “Based on the following main points of the legal revision and the business contents of the department, create a necessary operation flow change proposal, system specification change proposal, customer notification proposal, modification proposal for an existing manual, new identity verification service proposal, member store examination standard revision proposal, failure response procedure review proposal, user compensation system introduction proposal, FAQ update proposal, training material revision proposal, internal audit checklist modification proposal, outsourcing contractor response proposal, API specification change proposal, database design change proposal, and risk evaluation procedure review proposal”, “Create a script for a briefing session and a FAQ draft with the following contents”, or “Create a customer notification template with the following contents” using the generative AI for each department determined to be affected, and the AI automatically generates, for example, “review of an identity verification flow”, “creation of a new user explanation text”, “revision of member store management regulations”, “formulation of an introduction procedure of a user compensation system”, “addition of a legal conformity evaluation flow of a new service”, and the like for the service operation department, “addition of a transaction record preservation function”, “API specification change”, “strengthening of security requirements”, “implementation of an automatic reporting function at the time of failure”, “review of an external system linkage specification”, “database design change”, “strengthening of a log management function”, and the like for the system development department, “formulation of a new identity verification document reception procedure”, “update of FAQ”, “creation of a customer notification template”, “review of a complaint processing procedure”, “addition of a user compensation reception flow”, “creation of an identity verification re-procedure guidance text”, and the like for the customer support department, “introduction of a new AML/CFT monitoring standard”, “review of a risk evaluation procedure”, “update of an internal audit checklist”, “revision of a suspicious transaction reporting standard”, “formulation of risk mitigation measures”, “review of an external audit response procedure”, and the like for the risk management department, “revision of an explanation material for member stores”, “creation of a new service proposal material”, “response to strictification of member store examination standards”, “review of a new market research procedure”, “creation of a script for a new service briefing session”, and the like for the sales department, “revision of a book preservation procedure”, “review of a tax return flow”, “modification of a manual for responding to the Act on Preservation of Electronic Books”, and the like for the accounting department, “modification of a contract template”, “creation of a response plan to a new legal obligation”, “revision of internal regulations”, “review of an administrative response procedure”, and the like for the legal department, and “addition of an audit item”, “review of an audit procedure”, “modification of an audit report format”, and the like for the audit department. Specifically, the response plan generation unit executes a text generation pipeline provided with a feedback loop using reinforcement learning. The response plan generation unit incorporates a department identifier and legal revision main point data received from the affected department determination unit into a prompt template. The response plan generation unit inputs the generated prompt to a large language model. Input data to the large language model is a tensor including a vector indicating a current business flow state of the department and a vector indicating a constraint condition due to the legal revision. The large language model generates a text token sequence indicating a change procedure of the business flow based on the input tensor. Output data from the model is a structured JSON format text including a task name, a role in charge, and a specific work procedure. The output data includes data such as, for example, “Task: Update of API specification document” and “Procedure: Change an authentication method of an endpoint to OAuth 2.0”. The response plan generation unit includes a module that calculates an automatic evaluation index such as a BLEU score or a ROUGE score in order to evaluate quality of the generated text. The response plan generation unit fine-tunes a weight parameter of a generation model using modification history data by a past user as a reward signal. By this processing, the more the system is used, the more it generates a highly accurate response plan adapted to its own business process. This configuration specializes a general-purpose AI model to a specific corporate domain, and maximizes utility value in practice. This configuration dramatically shortens time required for creating a response plan from several days to several minutes. The system speeds up an initial response to a legal revision, and becomes a powerful engine for a company to agilely respond to a regulatory change.

The database management unit centrally manages all data such as legal revision-related documents, business contents of each department, past response histories, generated summaries, response plans, materials, FAQs, scripts, questions and answers, training materials, contract templates, audit checklists, outsourcing contractor response materials, API specification documents, database design documents, and risk evaluation sheets. For example, it accumulates an operation manual modification proposal, a briefing session material, a FAQ, a question and answer history, an outsourcing contractor response history, a group company response history, and the like created at the time of a past legal revision, and makes them referable at the time of a future legal revision. Specifically, the database management unit adopts a hybrid storage architecture for integrally handling structured data and unstructured data. The database management unit uses a relational database that guarantees ACID properties for transaction data such as user information and authority settings. The database management unit uses a distributed NoSQL database for large-capacity and schemaless data such as generated documents and log data. The database management unit integrates a full-text search engine having an inverted index structure in order to realize high-speed text search. The database management unit includes a vector database module that stores vectorized document data and enables approximate nearest neighbor search. The database management unit dynamically updates an index using a B-tree or a log-structured merge-tree at the time of writing data. The database management unit executes backup processing by periodic snapshot acquisition and asynchronous replication in order to prevent data loss. By this processing, the system safely and efficiently manages a huge amount of legal and business data of a petabyte class. This configuration guarantees a response speed in milliseconds to a search request from a user. This configuration perpetuates an intellectual asset of a company, which is a past response history, as a knowledge base for future decision-making without dissipating it. The system functions as a robust data foundation for realizing data-driven compliance management.

The generative AI execution unit performs natural language processing and knowledge inference based on the prompt sentence and data received from the legal revision information acquisition unit, the affected department determination unit, and the response plan generation unit, and generates various outputs such as summarization, extraction, analysis, proposal, material generation, FAQ generation, script generation, and question answering. For example, it executes a variety of generation tasks such as “extraction of main points of revised legal texts”, “summary of practical interpretation of guidelines”, “relevance analysis between business contents and legal revision contents”, “automatic generation of an operation change proposal”, “proposal of a new business opportunity”, “automatic creation of a script for a briefing session”, “automatic generation of FAQ”, and “question answering by a chatbot”. A prompt sentence such as “Summarize the following legal revision-related documents, and extract main revision points, an enforcement date, added obligations, penal provisions, and transitional measures”, “Match the following department business contents with main points of the legal revision, and list affected departments and necessary response plans”, “Create a script for a briefing session and a FAQ with the following contents”, or “Answer the following question based on the main points of the legal revision and the department business contents” is input to the generative AI. Specifically, the generative AI execution unit includes a large language model provided with a self-attention mechanism. The model is configured as a deep neural network having hundreds of billions of parameters. The processing unit converts input text data into a fixed-length token sequence using a tokenizer. The processing unit maps each token to a high-dimensional embedding vector. Input data to the model is a text vector including a prompt sentence and a related document. The number of dimensions of the input data is, for example, 4096 dimensions. Element contents of the input data include a distributed representation of a word and positional encoding information. As contents of the preprocessing, the processing unit executes removal of unnecessary symbols and normalization of text. As a specific example of the input data, first, text data of revised legal texts is given. Second, text data of a business manual of each department is given. Third, a question text in natural language from a user is given. The model applies a multi-layer transformer encoder and decoder to the input vector sequence. The model calculates a contextual dependency relationship. Output data from the model is a probability distribution vector of a word to be generated next. A format of the output data is an array of floating-point numbers having the number of dimensions equal to a vocabulary size. Each output value means a probability that a specific word appears next. As a specific example of the output data, first, a summarized main point text of the legal revision is given. Second, list data of affected departments is given. Third, text data of a generated FAQ is given. The subsequent processing unit applies a beam search algorithm based on the output probability distribution. The subsequent processing unit determines a text sequence with the highest probability. The subsequent processing unit transfers the generated text to the response plan generation unit or the user interface unit. With this configuration, the system substitutes for manual document analysis by a human expert. The system dramatically improves a speed of document processing. The system exhibits a technical effect of improving accuracy of information arrangement in an initial stage of response to a legal revision. The present technology is applicable to a use case in a legal tech field in which a huge amount of legal documents is rapidly analyzed and a practical response plan is automatically generated.

The log management unit records all processing histories of the system, operation histories of users, output histories of the AI, and the like, and records in detail, for example, who uploaded which legal revision document and when, which department browsed/edited which response plan, what kind of AI answer was made to which question, which notification was transmitted to whom, which material was modified and how, which progress was completed at which point in time, which outsourcing contractor performed which response, which group company referred to which material, and the like. Specifically, the log management unit is implemented using a distributed database system. The processing unit collects all events occurring in the system via an asynchronous messaging queue. The processing unit adds a unique time stamp to the collected event data. The processing unit formats the event data as a structured log record. The processing unit applies a cryptographic hash function to the log record. The processing unit includes a hash value of an immediately preceding log record in a current log record. The processing unit constructs a hash chain. With this configuration, the system makes it possible to mathematically detect falsification of log data. The processing unit stores the log data in a time-series database. The processing unit adds an index to the log data. The processing unit enables a high-speed search query. The processing unit periodically compresses the log data. The processing unit archives the compressed log data in inexpensive cold storage. With this configuration, the system optimizes consumption of storage capacity. The system enables retention of an audit trail over a long period of time. The system exhibits technical effects of improving efficiency of data management and improving security. The present technology is applicable to a use case of an audit response system in an industry where strict compliance requirements are demanded, such as a financial institution or a medical institution.

The notification management unit automatically distributes legal revision information, a response plan, a material update, a briefing session holding guidance, a FAQ update, a reminder of an unresponded task, and the like to each terminal, and can immediately receive a notification such as, for example, “New legal revision information has been added”, “Own department has been selected as an affected department”, “A new response plan has been generated”, “Guidance on holding a briefing session”, “FAQ has been updated”, “There is an unresponded task”, “Response to an outsourcing contractor is incomplete”, or “Material distribution to a group company has been completed”. Specifically, the notification management unit adopts a publish-subscribe messaging architecture. The processing unit receives a state change event from each module in the system. The processing unit analyzes the received event. The processing unit determines an appropriate notification topic based on a type of the event. The processing unit refers to an attribute and affiliated department information of each user. The processing unit dynamically specifies a user group to be a destination of the notification. The processing unit generates a notification message for the specified user group. The processing unit uses a WebSocket communication protocol. The processing unit establishes a persistent bidirectional communication channel with a client terminal. The processing unit push-distributes the generated notification message to the client terminal in real time. The processing unit detects a case where the client terminal is offline. The processing unit holds an untransmitted notification message in a temporary queue. The processing unit retransmits the notification message when the client terminal returns online. With this configuration, the system realizes a robust notification mechanism resistant to network delay or disconnection. The system transmits important legal revision information and task updates to a user without delay. The system exhibits a technical effect of preventing stagnation of business and improving a response speed of the entire organization. The present technology is applicable to a use case of an internal communication foundation that reliably and rapidly transmits highly urgent information to a large number of employees in a large-scale organization.

The history management unit records response contents and progress statuses at the time of a past legal revision in chronological order, and can utilize them as reference information at the time of a future legal revision. For example, it records in chronological order which department performed what kind of response, which material was modified, what kind of questions were frequent, what kind of new business proposal was made, which outsourcing contractor performed which response, which group company referred to which material, and the like at the time of a past legal revision. Specifically, the history management unit includes a multidimensional time-series database engine. The processing unit hierarchizes and stores data for each past response project. The processing unit adds metadata to each response action. The metadata includes an executor ID, an execution date and time, a target law/regulation ID, and an impact degree score. The processing unit applies a natural language processing model to the stored history data. The processing unit extracts a feature vector from the history data. The processing unit stores the extracted feature vector in a vector database. The processing unit detects when new legal revision information is input. The processing unit similarly generates a query vector from the new legal revision information. The processing unit calculates a cosine similarity between the query vector and the feature vector in the vector database. The processing unit extracts a past response history having a similarity exceeding a predetermined threshold. The processing unit provides the extracted past response history to the user interface unit as reference information. With this configuration, the system makes past tacit knowledge reusable as quantitative data. The system significantly shortens time for formulating a response plan to a similar legal revision. The system exhibits a technical effect of improving quality of response by automatically presenting past success cases and failure cases. The present technology is applicable to a use case of a knowledge management system that accumulates and utilizes past response know-how as an organizational knowledge base in a legal department or a compliance department of a company.

The user interface unit provides a screen on which a person in charge of each department accesses a server from a terminal and can browse/download a generated summary, affected department list, response plan, dissemination material, FAQ, script for a briefing session, customer notification template, training material, contract template, audit checklist, outsourcing contractor response material, API specification document, database design document, risk evaluation sheet, and the like. For example, it can also provide a search/filtering function for materials, a customized display for each department, feedback input or submission of a modification proposal to an AI-generated material, and a dedicated screen for an outsourcing contractor or a group company. Specifically, the user interface unit is constructed as a single-page application using a virtual document object model. The processing unit executes asynchronous RESTful API communication with the server. The processing unit dynamically updates contents without accompanying reloading of the entire screen. The processing unit evaluates an access control list based on authentication information of a user. The processing unit renders a dedicated view according to an authority level of the user. The processing unit applies a virtual scroll technology in order to efficiently display a large amount of material data. The processing unit expands only a data element existing in a visible area of the screen on a memory. The processing unit receives a search query from the user. The processing unit transmits the query to a full-text search engine using an inverted index. The processing unit acquires a search result in milliseconds, and reflects it on the screen. The processing unit collects feedback of the user to the AI-generated material. The processing unit structures feedback data and transmits it to the server. With this configuration, the system suppresses memory consumption of a client terminal. The system realizes high-speed drawing and responsiveness to a large amount of data. The system exhibits a technical effect of reducing an operation burden on the user and improving business efficiency. The present technology is applicable to a use case of a portal site for enterprises in which complex authority management and a large amount of document management are demanded.

The material browsing/editing unit provides an editing function capable of using a generated material as it is or making additions and modifications for each department. For example, the service operation department can add its own unique operation to an AI-generated identity verification flow proposal, the system development department can add a requirement specific to its own system to an API specification change proposal, the customer support department can add a question frequently appearing in the field to a FAQ draft, and the sales department can incorporate its own strengths into a new service proposal material. The audit department can also add its own unique audit item to an AI-generated audit checklist. Specifically, the material browsing/editing unit implements a real-time collaborative editing protocol. The processing unit permits a plurality of users to simultaneously perform an editing operation on the same document. The processing unit integrates the editing operation of each user using an operational transformation algorithm. The processing unit automatically resolves an editing conflict. The processing unit stores a change history of the document as difference data in a version management database. The processing unit applies Myers' diff algorithm. The processing unit calculates a minimum edit distance between texts before and after change. The processing unit accurately specifies an added text and a deleted text. The processing unit visually highlights the specified difference information. The processing unit distinguishes and holds an original text generated by the AI and a text modified by the user. The processing unit extracts modification contents of the user as learning data. The processing unit adds the extracted data to a data set for fine-tuning of the generative AI. With this configuration, the system guarantees data consistency of collaborative work by a plurality of persons. The system constructs a loop that feeds back tacit knowledge of the user to the system. The system exhibits a technical effect of continuously improving accuracy of a future AI product. The present technology is applicable to a use case of a document management system in which experts of a plurality of departments collaboratively review and modify a legal document, a technical specification document, or the like.

The chatbot response unit, when a person in charge inputs a question from a terminal after a briefing session or during daily operations, transmits the contents to the server, and the generative AI on the server refers to the question contents, the main points of the legal revision, the business contents of the department, past Q&A histories, and the like, generates an optimal answer, and returns it to the terminal. For example, it immediately answers questions such as “What are the specific contents of the new identity verification requirements?”, “In what cases is the transaction record preservation obligation applied?”, “At what timing should the customer notification be performed?”, “What are the specific contents of the API specification change?”, “What is the basis for adding the audit item?”, “To what extent is the target range of the user compensation system?”, “How should the response to the outsourcing contractor be performed?”, and “What are the legal points to note for developing a new market?”. An example of a prompt text to the generative AI is “Answer the following question practically and specifically based on the main points of the legal revision and the business contents of the department.” Specifically, the chatbot response unit adopts a retrieval-augmented generation architecture. The processing unit receives a question text from a user. The processing unit inputs the question text into a natural language processing model. Input data to the model is a numerical vector obtained by tokenizing the question text. The number of dimensions of the input data is, for example, 768 dimensions. Element contents of the input data are floating-point numbers expressing the intention and context of the question. As the preprocessing contents, the processing unit executes removal of stop words and stemming. As a specific example of the input data, first, a question vector regarding the identity verification requirements is given. Second, a question vector regarding the transaction record preservation obligation is given. The processing unit searches a vector database using the question vector. The processing unit extracts related main points of the legal revision and past Q&A histories based on cosine similarity. The processing unit combines the extracted context information and the question text. The processing unit inputs the combined data into a generative AI model. Output data from the model is a probability distribution of tokens constituting an answer text. The format of the output data is a multidimensional tensor. Each output value means a generation probability of each word of the answer. As a specific example of the output data, first, text data explaining a specific identity verification procedure is given. Second, text data indicating a criterion for the notification timing is given. The subsequent processing unit formats the generated answer text. The subsequent processing unit transmits the answer text to the client terminal. With this configuration, the system realizes advanced information retrieval that understands the context, rather than a mere keyword search. The system exhibits a technical effect of immediately solving a user's question and preventing business stagnation. The present technology is applicable to a use case of an interactive AI system that automates internal help desk operations and customer support operations.

The notification receiving unit receives a notification from the server in real time, and notifies the person in charge by a pop-up, an email, a chat message, or the like. For example, it can immediately receive notifications such as “New legal revision information has been added”, “Your department has been selected as an affected department”, “A new response plan has been generated”, “Information on holding a briefing session”, “The FAQ has been updated”, “There is an unaddressed task”, “The response to the outsourcing contractor is incomplete”, and “The material distribution to the group companies has been completed”. Specifically, the notification receiving unit resides as a background process on the client terminal. The processing unit monitors a persistent connection established with the server. The processing unit intercepts a data packet push-distributed from the server. The processing unit decodes a payload of the received data packet. The processing unit evaluates an importance flag of the notification included in the payload. The processing unit dynamically changes a display format of the notification based on the importance flag. The processing unit calls a native notification API of an operating system. The processing unit draws a pop-up window on the forefront of the screen. The processing unit registers a callback function when the user clicks the notification. The processing unit directly transitions the user to a screen of the corresponding material or task through the callback function. The processing unit detects a case where the network connection is temporarily disconnected. The processing unit attempts reconnection using an exponential backoff algorithm. With this configuration, the system ensures reachability of the notification even under a situation where the communication environment is unstable. The system appropriately arouses the user's attention. The system exhibits a technical effect of preventing an oversight of an important task and supporting reliable execution of business. The present technology is applicable to a use case of a push notification system that reliably delivers a highly urgent alert to a user in a mobile terminal or a desktop environment.

The operation log transmission unit transmits an operation history on the terminal to the server, and centrally manages a usage status of the system and a response progress. For example, it records in detail which person in charge viewed/edited which material, which notification was received, which question was input to the AI, which response plan was approved/rejected, which outsourcing contractor performed which response, which group company referred to which material, and the like. Based on the operation history, the response progress can be automatically aggregated, and an unaddressed department or task can be extracted. Specifically, the operation log transmission unit works in conjunction with all event listeners in a user interface on the client terminal. The processing unit captures minute operation events such as a mouse click, a keystroke, a scroll amount, and a screen staying time. The processing unit temporarily accumulates the captured event data in a local in-memory buffer. The processing unit detects a point in time when a data amount in the buffer reaches a predetermined threshold value, or a point in time when a predetermined time has elapsed. The processing unit serializes the accumulated data into a JSON format payload. The processing unit applies a data compression algorithm to the payload. The processing unit collectively transmits the compressed data to the server as an asynchronous HTTP request. The processing unit clears the local buffer after confirming that the transmission is successful. With this configuration, the system minimizes consumption of a network bandwidth. The system collects comprehensive operation logs while reducing a processing load on the client terminal. The system calculates a task completion rate of each department in real time based on the collected log data. The system exhibits a technical effect of automatically identifying a department that is a bottleneck and issuing a warning to an administrator. The present technology is applicable to a use case of a task management system that analyzes a usage status of a large-scale system or quantitatively evaluates business performance of an employee.

As described above, the system according to the present embodiment comprehensively and specifically supports all operations such as collection and analysis of legal revision information, identification of an affected department, generation of a response plan, material creation, briefing session operation, question and answer, progress management, notification distribution, history management, and external cooperation by centrally and efficiently automating the entire process of response to legal revisions in the electronic payment service field through cooperation of each unit and essentially utilizing generative AI. Specifically, the system operates on a distributed computing environment based on a microservices architecture. The system deploys each functional module as an independent container. The system dynamically optimizes resource allocation of each module using a container orchestration tool. The system manages a series of data flows from input of legal revision information to final completion of response as an event-driven state machine. The system executes data transfer between each step at high speed via an in-memory data grid. The system offloads inference processing of the generative AI to a parallel computing cluster using a GPU. With this configuration, the system executes a natural language processing task requiring enormous computing resources with low latency. The system systematizes and automates a process of complex legal interpretation and business impact evaluation, which has depended on human cognitive ability, by a computer science algorithm. The system exhibits technical effects of eliminating human errors, dramatically improving processing speed, and raising a compliance response capability of the entire organization. The present technology is applicable to a use case of an integrated risk management platform in highly regulated industrial fields facing frequent changes in laws and regulations, such as finance, medical care, and communications.

### (Implementation Steps)

Step 1: Collection and Input of Legal Revision-Related Information A legal person in charge, a risk management person in charge, a system development person in charge, a customer support person in charge, a sales person in charge, or the like uploads revised legal texts of the Payment Services Act, the Act on Prevention of Transfer of Criminal Proceeds, consumer protection-related laws, the Act on Preservation of Electronic Books, tax reforms, the Act on the Protection of Personal Information, and the like, guidelines, administrative agency notices, industry association views, reference judicial precedents, administrative guidance documents, public comments, related press materials, and the like from a terminal. Furthermore, it is also possible to automatically acquire them from an external legal database or an administrative agency website by API linkage or crawling. For example, documents in various formats such as revised legal texts in PDF format, guidelines in HTML format, industry association views in Word files, administrative notices automatically acquired from administrative agency websites, aggregated results of public comments, and clipping data of newspaper articles are targeted. Specifically, the system activates a multimodal data ingestion pipeline. The processing unit receives a binary data stream transmitted from a user terminal. The processing unit analyzes a file extension and a magic number. The processing unit automatically determines a file format of the data. The processing unit applies an optical character recognition engine to a PDF file. The processing unit converts imaged text into machine-readable character string data. The processing unit analyzes a document object model tree for an HTML file. The processing unit filters unnecessary decoration tags and navigation elements, and extracts only body text. The processing unit controls a headless browser in crawling an external site. The processing unit scrapes text after rendering a dynamically generated web page. The processing unit executes character code unification and normalization processing on all the extracted text data. With this configuration, the system converts unstructured data having different formats into a unified structured text format. The system constructs a foundation on which a subsequent natural language processing model can accurately interpret data. The system exhibits technical effects of reducing work time and improving input accuracy by automating data input. The present technology is applicable to a use case of an information collection system that collects a large amount of documents from various information sources and constructs an integrated database.

Step 2: Analysis and Summarization of Legal Revision Information (Utilization of Generative AI) The legal revision information acquisition unit passes the uploaded or automatically acquired document to the generative AI execution unit, and analyzes it using a natural language processing technology. For the generative AI, prompt texts such as “Summarize the following revised legal texts of the Payment Services Act, and extract main revision points, an enforcement date, added obligations, strengthening of penal provisions, and transitional measures”, “Summarize an administrative agency interpretation policy, practical points to note, and an impact on an electronic payment service from the following full text of the guidelines”, “Summarize main opinions and administrative agency answers from the following public comment results”, and “Extract questions assumed in the field and answers thereto from the following administrative agency FAQ” are generated, and the AI is instructed to perform analysis. The AI automatically extracts and summarizes a purpose of the revised law, revision points, a time of enforcement, new rules to be complied with, an impact on an industry, added obligations, strengthening of penal provisions, transitional measures, and the like, and stores them in the database management unit. Specifically, the legal revision information acquisition unit transfers the structured text data to the generative AI execution unit. The generative AI execution unit activates an encoder-decoder type deep learning model. Input data to the model is a tensor of a token sequence obtained by combining the extracted text data and the instruction prompt. The number of dimensions of the input data has, for example, an 8192-dimensional context window. Element contents of the input data are an embedding vector and an attention mask of each word. As the preprocessing contents, the processing unit divides a long text into appropriate chunks in accordance with a maximum input length of the model. As a specific example of the input data, first, chunk data of the revised legal texts of the Payment Services Act is given. Second, text data of a specific chapter of the guidelines is given. The model calculates a long-distance dependency relationship in the text using a self-attention mechanism. Output data from the model is a probability distribution of tokens constituting a summarized text. The format of the output data is a set of summary vectors for each chunk. Each output value means an importance score of the extracted legal requirement. As a specific example of the output data, first, date data indicating an enforcement date is given. Second, text data in which added obligations are itemized is given. Third, structured data indicating changes in penal provisions is given. The subsequent processing unit integrates summary results of each chunk. The subsequent processing unit generates a final summary document. The subsequent processing unit stores the generated summary document in a predetermined table of a relational database. With this configuration, the system analyzes a lengthy legal document at a speed far exceeding human reading speed. The system exhibits a technical effect of preventing an omission in extracting an important legal requirement and ensuring comprehensiveness of analysis. The present technology is applicable to a use case of legal due diligence that automatically extracts a risk clause from an enormous amount of contracts and legal documents.

Step 3: Identification of Affected Department (Utilization of Generative AI) The affected department determination unit matches a database of business contents, business flows, areas of charge, managed assets, outsourcing contractors, related systems, used data types, existing regulations/manuals, training materials, past legal revision response histories, internal audit findings, external audit reports, outsourcing contracts, system design documents, operation procedure manuals, customer response manuals, member store management ledgers, transaction monitoring rules, risk evaluation sheets, internal reporting records, past administrative guidance response histories, and the like of each department such as a service operation department, a system development department, a customer support department, a risk management department, a sales department, an accounting department, a legal department, and an audit department with the main points of the legal revision extracted by the AI, and inputs a prompt text such as “Match the following main points of the legal revision with the business content database of each department, and list affected departments. Extract highly relevant business processes and managed assets as well.” to the generative AI. The AI multilaterally analyzes a relevance between the business contents of each department and the legal revision contents, automatically determines an affected department, and preferentially selects a department with a high degree of impact. Specifically, the affected department determination unit executes a relationship analysis algorithm using a graph neural network. The processing unit constructs a knowledge graph in which business contents and managed assets of each department are nodes and their dependency relationships are edges. Input data to the model is a text vector of the main points of the legal revision and an adjacency matrix of the knowledge graph. The number of dimensions of the input data is a multidimensional tensor depending on the number of nodes and a feature amount dimension. Element contents of the input data are an attribute vector of each node and a weight of an edge. As the preprocessing contents, the processing unit extracts a keyword from a document group of each department using a named entity extraction model, and generates a feature vector of a node. As a specific example of the input data, first, vector data of an API specification managed by the system development department is given. Second, vector data of a response manual of the customer support department is given. The model propagates information between nodes using a message passing algorithm. Output data from the model is an array of impact degree scores for each department node. The format of the output data is a list of floating-point numbers taking continuous values from 0 to 1. Each output value means a probability that a specific department is forced to change business due to the legal revision. As a specific example of the output data, first, an impact degree score of 0.95 for the service operation department is given. Second, an impact degree score of 0.20 for the accounting department is given. The subsequent processing unit identifies a department whose impact degree score exceeds a predetermined threshold value as an affected department. The subsequent processing unit sorts the departments in descending order of the score, and generates a priority list. With this configuration, the system realizes advanced impact evaluation considering not only superficial keyword matching but also potential dependency relationships of business processes. The system exhibits a technical effect of preventing an omission in identifying an impact range and optimizing an initial response of an organizational response. The present technology is applicable to a use case of an impact range analysis tool at the time of a large-scale system change or organizational restructuring.

Step 4: Automatic Generation of Response Plan and Material (Utilization of Generative AI) The response plan generation unit inputs, for each department determined to be affected, prompt texts such as “Create a necessary operation flow change proposal, system specification change proposal, customer notification proposal, modification proposal for an existing manual, new identity verification service proposal, member store examination standard revision proposal, failure response procedure review proposal, user compensation system introduction proposal, FAQ update proposal, training material revision proposal, internal audit checklist modification proposal, outsourcing contractor response proposal, API specification change proposal, database design change proposal, and risk evaluation procedure review proposal based on the following main points of the legal revision and business contents of the department”, “Create a script for a briefing session and a FAQ draft with the following contents”, and “Create a customer notification template with the following contents” using the generative AI, and the AI automatically generates an optimal response plan and material for each department. Specifically, the response plan generation unit drives a conditional text generation model. Input data to the model is a profile vector of the identified affected department, a vector of the main points of the legal revision, and metadata defining a template structure of a material to be generated. The number of dimensions of the input data is a high-dimensional tensor obtained by combining a plurality of vectors. Element contents of the input data include a department-specific constraint condition and an output format indicator. As the preprocessing contents, the processing unit searches for response plan data in a past similar case, and adds it to the input data as a context. As a specific example of the input data, first, prompt data instructing an API specification change for the system development department is given. Second, generation instruction data of a customer notification template for the sales department is given. The model generates text autoregressively using a transformer decoder. Output data from the model is a generated response plan text and a structured task list. The format of the output data is a markdown format text and a JSON format task object. Each output value means a specific action item and an execution procedure thereof. As a specific example of the output data, first, a draft of an SQL script describing a schema change of a database is given. Second, text of a message of an email for a customer is given. Third, an item array of an audit checklist is given. The subsequent processing unit executes a syntax check of the generated text. The subsequent processing unit stores the generated material in a dedicated directory of each department. With this configuration, the system instantaneously generates a practical response plan perfectly adapted to the context of each department. The system exhibits a technical effect of reducing enormous man-hours required for material creation from scratch and dramatically improving business efficiency. The present technology is applicable to a use case of an automation tool for planning in consulting business or project management.

Step 5: Distribution, Viewing, and Editing of Generated Material and Response Plan Through the user interface unit and the material viewing/editing unit, a person in charge of each department can access the server from a terminal, and view and download the generated summary, affected department list, response plan, dissemination material, FAQ, script for a briefing session, customer notification template, training material, contract template, audit checklist, outsourcing contractor response material, API specification, database design document, risk evaluation sheet, and the like. The person in charge can use the AI-generated material as it is, or can make additions and modifications for each department. Specifically, the system efficiently distributes the generated material to each client terminal using a content delivery network. The processing unit caches the generated material data in an edge server. The processing unit responds with data from a server geographically closest to a request from a user. The processing unit strictly verifies a viewing authority of the material based on a role-based access control model. The processing unit blocks an access request from an unauthorized user. The processing unit applies optimistic concurrency control to an editing operation of the material. The processing unit prevents data inconsistency when a plurality of users edit the same material at the same time. The processing unit adds a digital signature to the edited material. The processing unit cryptographically guarantees authenticity and completeness of the material. With this configuration, the system establishes a safe and high-speed information sharing infrastructure within a large-scale organization. The system distributes a load on a network bandwidth. The system exhibits a technical effect of preventing falsification of a material and realizing secure document management satisfying compliance requirements. The present technology is applicable to a use case of a secure file sharing system for a company handling highly confidential design data and financial data.

Step 6: Implementation of Briefing Sessions and Dissemination Activities Each department implements briefing sessions, internal training, briefing sessions for member stores, briefing sessions for outsourcing contractors, briefing sessions for group companies, and the like using the script for a briefing session and the dissemination material automatically generated by the AI. For example, a service operation department holds an internal briefing session on a new identity verification flow, a customer support department conducts training on a new procedure for customer response, and a sales department implements a new service briefing session for member stores. Specifically, the system activates a multimedia data generation module. The processing unit inputs text data of the automatically generated script for a briefing session into a speech synthesis model. The processing unit generates speech waveform data imitating natural human speech from the text data. The processing unit automatically generates slide images for presentation from the text and structured data of the dissemination material. The processing unit synchronizes the generated speech data and the slide images. The processing unit encodes a video file for on-demand distribution. The processing unit uploads the generated video file to a streaming server. The processing unit automatically transmits a viewing URL of the video to a person in charge of each department. The processing unit embeds a tracking code in a video player. The processing unit collects operation logs of a viewing start time, a viewing completion rate, and a pause of each user. With this configuration, the system eliminates physical constraints and time costs associated with holding face-to-face briefing sessions. The system scales homogeneous and high-quality information transmission to the entire organization. The system exhibits a technical effect of enabling quantitative measurement of the degree of penetration of dissemination activities by analyzing viewing logs. The present technology is applicable to use cases of e-learning platforms and intra-company compliance training systems.

Step 7: Question and Answer by Chatbot (Utilization of Generative AI) When a person in charge inputs a question from a terminal through a chatbot response unit after a briefing session or during daily operations, the contents thereof are transmitted to a server, and a generative AI on the server refers to the question contents, main points of the legal revision, business contents of a department, a past Q&A history, and the like, generates an optimal answer, and returns the answer to the terminal. An example of a prompt sentence to the generative AI is “Answer the following question practically and specifically based on the main points of the legal revision and the business contents of the department.” Specifically, the chatbot response unit functions as an interactive AI system equipped with a session management mechanism. The processing unit holds a dialogue history for each user in an in-memory database. Input data to the model is a current question text vector and a context vector of a past dialogue history. The number of dimensions of the input data is a tensor dynamically expanded according to the number of turns of the dialogue. Element contents of the input data include a transition of a user's intention and referenced entity information. As contents of the preprocessing, the processing unit extracts an important keyword from the dialogue history and adjusts a weight of an input vector. As specific examples of the input data, first, a question vector including a pronoun “What are the details of the procedure?” can be cited. Second, a vector of an additional confirmation question for an immediately preceding answer can be cited. The model calculates a relevance between the question and the context using a cross-attention mechanism of a transformer. Output data from the model is a probability distribution of an answer text considering a context. A format of the output data is character string data of a natural language. Each output value means a direct solution to a user's question. As specific examples of the output data, first, text data guiding a corresponding page of a specific manual can be cited. Second, text data explaining a specific system operation procedure step by step can be cited. The subsequent processing unit dynamically embeds a URL link of an internal system in the answer text. With this configuration, the system realizes a continuous dialogue maintaining a complex context, not limited to a single question and answer. The system exhibits a technical effect of improving a user's self-resolution rate and reducing a load on a support department. The present technology is applicable to use cases of operation support for complex business systems and internal help desks requiring specialized knowledge.

Step 8: Progress, History, and Notification Management A log management unit, a notification management unit, and a history management unit cooperate to centrally manage all processing histories of the system, user operation histories, AI output histories, response progress, notification histories, past legal revision response histories, and the like. The notification management unit automatically distributes legal revision information, response plans, material updates, briefing session holding guidance, FAQ updates, reminders of unaddressed tasks, and the like to each terminal, and the history management unit records response contents and progress statuses at the time of past legal revisions in chronological order, and utilizes them as reference information at the time of future legal revisions. Specifically, the system operates an event-driven integrated management engine. The processing unit aggregates log data asynchronously transmitted from each module by a central message broker. The processing unit analyzes data in real time using a stream processing engine. The processing unit monitors a status of a task assigned to each department. The processing unit calculates a remaining time until a deadline of the task. The processing unit automatically fires an escalation event when the remaining time falls below a predetermined threshold. The processing unit instructs the notification management unit to generate a reminder message based on the escalation event. The processing unit commits data of a completed task to a time-series database in the history management unit. The processing unit calculates a progress rate of the entire project. The processing unit formats the calculated progress rate as data for drawing a graph on a dashboard. With this configuration, the system visualizes dependencies and progress statuses of a large number of complexly intertwined tasks. The system detects a delay in response at an early stage and enables proactive intervention. The system exhibits a technical effect of reducing an overhead of project management and ensuring a reliable response to legal revisions. The present technology is applicable to use cases of large-scale system migration projects and progress management tools for company-wide compliance audit programs.

### (Specific Use Case)

For example, a case is assumed where a major revision of the Payment Services Act is announced, and electronic payment service providers are required to strictly enforce new identity verification procedures, add an obligation to preserve transaction records, change reporting criteria for suspicious transactions, introduce a user compensation system, strengthen security requirements during API linkage, and the like. In this case, a legal person in charge or a risk management person in charge uploads revised legal texts, guidelines, administrative agency notices, industry association views, public comments, administrative agency FAQs, related press materials, and the like from a terminal to the system, or automatically acquires them from an external legal database or an administrative agency website by API linkage or crawling. The legal revision information acquisition unit receives these documents, generates prompt sentences such as “Summarize the following revised legal texts of the Payment Services Act, and extract main revision points, an enforcement date, added obligations, strengthening of penal provisions, and transitional measures”, “Summarize an administrative agency's interpretation policy, practical points to note, and an impact on electronic payment services from the following full text of the guidelines”, “Summarize major opinions and administrative agency's answers from the following public comment results”, and “Extract questions assumed in the field and answers thereto from the following administrative agency FAQs” to a generative AI execution unit, and instructs the AI to analyze them. Specifically, the system applies a natural language processing pipeline to the input wide variety of document groups. The processing unit extracts text data from the document groups and constructs a corpus. The processing unit executes a named entity extraction algorithm on the corpus. Input data to the model is a word vector sequence of text including technical terms related to the Payment Services Act. The number of dimensions of the input data is, for example, 1024 dimensions. Element contents of the input data are part-of-speech information and contextual embedding representations of each word. As contents of the preprocessing, the processing unit executes morphological analysis using a custom dictionary specialized for a financial domain. As specific examples of the input data, first, a text vector including a phrase “strict enforcement of identity verification procedures” can be cited. Second, a text vector including a phrase “security requirements during API linkage” can be cited. The model performs sequence labeling using a bidirectional long short-term memory network and a conditional random field. Output data from the model is a probability distribution of an entity label for each word. A format of the output data is an array of tags according to a BIO format. Each output value means which category such as “obligation”, “penalty”, or “date” a specific word belongs to. As specific examples of the output data, first, date data to which an “enforcement date” label is assigned can be cited. Second, text data of an action item to which an “added obligation” label is assigned can be cited. The subsequent processing unit maps the extracted entities to a schema of a relational database. With this configuration, the system automatically constructs a structured legal requirement database from unstructured documents. The system exhibits a technical effect of eliminating manual data input by humans and dramatically improving information extraction accuracy. The present technology is applicable to use cases of RegTech solutions that monitor changes in financial regulations and automatically evaluate impacts on internal systems.

The generative AI extracts main points such as “strengthening of identity verification procedures”, “addition of an obligation to preserve transaction records”, “new AML/CFT requirements”, “strengthening of security standards during API linkage”, “introduction of a user compensation system”, “change in reporting criteria for suspicious transactions”, “strict enforcement of member store screening criteria”, and “new establishment of a reporting obligation at the time of system failure”, and stores them in a database management unit. The affected department determination unit matches a database of business contents, business flows, areas of charge, managed assets, outsourcing contractors, related systems, used data types, existing regulations/manuals, training materials, past legal revision response histories, internal audit findings, external audit reports, outsourcing contracts, system design documents, operation procedure manuals, customer response manuals, member store management ledgers, transaction monitoring rules, risk evaluation sheets, internal reporting records, past administrative guidance response histories, and the like of each department such as a service operation department, a system development department, a customer support department, a risk management department, a sales department, an accounting department, a legal department, and an audit department with the main points of the legal revision extracted by the AI, and inputs a prompt sentence “Match the following main points of the legal revision with the business content database of each department, and list affected departments. Extract highly relevant business processes and managed assets as well.” to the AI. Specifically, the affected department determination unit activates a high-dimensional similarity calculation engine using a vector space model. The processing unit inputs each extracted main point of the legal revision into a sentence encoder. The processing unit converts the main points of the legal revision into dense semantic vectors. The processing unit similarly converts a huge amount of business document groups stored in the database of each department into semantic vectors. Input data to the model is a vector of the main points of the legal revision and a vector group of the business documents of each department. The number of dimensions of the input data is, for example, a 512-dimensional floating-point array. Element contents of the input data are coordinate values in a latent space expressing semantic features of text. As contents of the preprocessing, the processing unit calculates a weight of an important phrase in a document using a TF-IDF method, and corrects a vector representation. As specific examples of the input data, first, a main point vector “strengthening of security standards during API linkage” can be cited. Second, a document vector of an “external API connection specification” of the system development department can be cited. The model comprehensively calculates a cosine similarity between the main point vector and each document vector. Output data from the model is a matrix of matching scores for each department. A format of the output data is a two-dimensional numerical matrix with departments as rows and main points of the legal revision as columns. Each output value means a strength of an impact that a specific department receives from a specific main point of the legal revision. As specific examples of the output data, first, a similarity score of 0.92 between the system development department and the strengthening of security standards can be cited. Second, a similarity score of 0.88 between the customer support department and the introduction of the user compensation system can be cited. The subsequent processing unit analyzes the score matrix. The subsequent processing unit extracts a pair of a department and a main point having a score exceeding a threshold. The subsequent processing unit automatically generates an affected department list and a mapping table of related business processes based on the extracted pairs. With this configuration, the system instantaneously collates a document group of a scale that cannot be visually confirmed by a human. The system accurately identifies hidden dependencies and impact ranges between departments. The system exhibits a technical effect of minimizing a risk of compliance violation due to omission of response. The present technology is applicable to use cases of tools for analyzing duplication and impacts of business processes at the time of large-scale corporate mergers and business integrations.

For example, if the service operation department is in charge of “identity verification”, “member store management”, “payment service operation”, “user compensation response”, and “new service planning”, the AI automatically extracts it as a department affected by the strengthening of identity verification procedures and the introduction of the user compensation system. If the system development department is in charge of “payment system development”, “API management”, “security response”, “failure response”, “database design”, “log management”, and “external system linkage”, it is extracted as a department affected by the obligation to preserve transaction records, API specification changes, and strengthening of security requirements. If the customer support department is in charge of “customer response”, “identity verification document reception”, “FAQ response”, “complaint processing”, “user compensation reception”, and “identity verification re-procedure guidance”, it becomes a department affected by a new explanation obligation to customers, identity verification flow changes, and user compensation system response. If the risk management department is in charge of “AML/CFT response”, “transaction monitoring”, “legal compliance”, “risk evaluation”, “internal audit”, “external audit response”, “suspicious transaction reporting”, and “formulation of risk mitigation measures”, it becomes a department affected by new AML/CFT requirements and monitoring criteria changes. Specifically, the affected department determination unit executes a hybrid inference engine combining a large language model based on a transformer architecture and a graph neural network. The inference engine quantifies a hidden semantic relevance between the business contents of each department and the main points of the legal revision on a high-dimensional vector space. The system receives, as input data, a legal revision main point text output from the legal revision information acquisition unit and a business profile text of each department acquired from the database. The system tokenizes these texts using a natural language processing technology. The system executes data cleansing including removal of unnecessary stop words and stemming processing. The system inputs the preprocessed token sequence into a multi-layer self-attention mechanism. The system converts the input text into, for example, a 768-dimensional dense vector. As specific input examples to the system, there are a text vector indicating the strengthening of identity verification procedures and a text vector indicating anti-money laundering requirements. As other input examples to the system, there are a text vector indicating the business contents of the service operation department and a text vector indicating the business contents of the system development department. The inference engine calculates a cosine similarity and a Euclidean distance between the legal revision main point vector and the department business vector. The inference engine further weights inter-departmental dependencies within the organization using the graph neural network. For example, the inference engine expresses a strength of data linkage between the system development department and the service operation department as an edge weight of a graph. The inference engine integrates these calculation results. The inference engine calculates, as output data, an impact degree score indicating a probability that each department is affected by a specific main point of the legal revision. The inference engine generates, as output data, an impact category label classifying a nature of the impact. As specific output examples from the system, there are an impact degree score of 0.95 and a category label “operation flow change” for the service operation department. As other output examples from the system, there are an impact degree score of 0.88 and a category label “system modification” for the system development department. The affected department determination unit compares the calculated impact degree score with a preset threshold as subsequent processing. The affected department determination unit identifies a department having a score exceeding the threshold as an affected department. The affected department determination unit transmits an identifier of the identified affected department and related legal revision main point data to the response plan generation unit. The affected department determination unit assigns a flag as a department requiring attention to a department close to a boundary value even if the score is less than the threshold. With this configuration, the system extracts an implicit business relevance that tends to be overlooked by a keyword search manually performed by a human with high accuracy. The system completely automates a process of identifying an affected department. The system significantly shortens an analysis time in an initial stage of response to legal revisions. The system exhibits a technical effect of efficiently utilizing calculation resources of an information processing apparatus and executing a complex impact analysis in a large-scale organization at high speed. The present technology is suitably applied to a compliance management system in a company having a wide variety of business departments, such as a financial institution or a telecommunications carrier.

The response plan generation unit inputs prompt sentences such as “Create a necessary operation flow change proposal, system specification change proposal, customer notification proposal, modification proposal for an existing manual, new identity verification service proposal, member store screening criteria revision proposal, failure response procedure review proposal, user compensation system introduction proposal, FAQ update proposal, training material revision proposal, internal audit checklist modification proposal, outsourcing contractor response proposal, API specification change proposal, database design change proposal, and risk evaluation procedure review proposal based on the following main points of the legal revision and the business contents of the department”, “Create a script for a briefing session and a FAQ draft with the following contents”, and “Create a customer notification template with the following contents” using the generative AI for each department determined to be affected, and the AI automatically generates, for example, “review of an identity verification flow”, “creation of a new user explanation text”, “revision of member store management regulations”, and “formulation of an introduction procedure for a user compensation system” for the service operation department, “addition of a transaction record preservation function”, “API specification change”, “strengthening of security requirements”, and “implementation of an automatic reporting function at the time of failure” for the system development department, “formulation of a new identity verification document reception procedure”, “FAQ update”, and “creation of a customer notification template” for the customer support department, and “introduction of new AML/CFT monitoring criteria”, “review of a risk evaluation procedure”, and “update of an internal audit checklist” for the risk management department. Specifically, the response plan generation unit drives a calculation module implementing an autoregressive text generation model. The calculation module utilizes a dedicated neural network model fine-tuned using past legal revision response history data. The response plan generation unit generates, as input data, a structured prompt integrating the legal revision main point data received from the affected department determination unit, the business profile of the target department, and past similar case data. The response plan generation unit clarifies an instruction to the model using a prompt engineering technology. The response plan generation unit converts this structured prompt into a token sequence. The response plan generation unit inputs the token sequence into the neural network model as an input sequence of up to 4096 tokens. As a specific input example to the model, there is a prompt text instructing a specification change of an application programming interface for the system development department. As another input example to the model, there is a prompt text instructing an introduction procedure of anti-money laundering criteria for the risk management department. The neural network model analyzes a context of the input token sequence by a multi-layer attention mechanism. The neural network model sequentially predicts a next token based on a probability distribution. The neural network model generates, as output data, structured text data including a list of specific response tasks. As a specific output example from the model, there is a data set including a task name “change of authentication token specification”, a priority score “0.9”, and an estimated man-hour “40 hours”. As another output example from the model, there is a data set including a task name “creation of notification text for customers”, a priority score “0.8”, and an estimated man-hour “15 hours”. The response plan generation unit parses the output structured text data as subsequent processing. The response plan generation unit registers an analysis result as a new record in a task management database. The response plan generation unit generates a drawing command for displaying the registered task data on a user interface of each department. The response plan generation unit analyzes dependencies between the generated tasks and automatically calculates a critical path. With this configuration, the system automatically generates an executable task plan in line with the company's past response history and actual business conditions, rather than mere general text generation. The system suppresses hallucination of the generative model. The system reduces human resources required for formulating a response plan. The system exhibits a technical effect of improving accuracy of project management by quantitatively presenting priorities and man-hours of tasks. The present technology is extremely useful as a progress management tool for a company-wide legal revision response project led by a legal department or a compliance department.

Legal revision notification materials, FAQ drafts, scripts for a briefing session, customer notification templates, training materials, operation manual modification proposals, contract template modification proposals, audit checklists, outsourcing contractor response materials, API specifications, database design documents, risk evaluation sheets, and the like automatically generated by the AI for each department can be viewed, edited, and downloaded by each person in charge through a user interface unit and a material viewing/editing unit. For example, the service operation department can add its own unique operation to the AI-generated identity verification flow proposal, the system development department can add requirements specific to its own system to the API specification change proposal, the customer support department can add frequently asked questions in the field to the FAQ draft, and the sales department can incorporate its own strengths into the new service proposal material. Specifically, the material viewing/editing unit includes a data management module implementing a distributed version control algorithm. The data management module stores the generated various document data in a storage as tree-structured data objects. The user interface unit receives an editing operation event transmitted from a terminal of a person in charge in real time. The material viewing/editing unit acquires, as input data, a difference data array indicating addition, deletion, and change of text by the person in charge. As a specific input example to the system, there is character string data indicating addition of a specific authentication parameter to an application programming interface specification. As another input example to the system, there is character string data indicating addition of an answer regarding a specific error code to a draft of frequently asked questions. The material viewing/editing unit analyzes the acquired difference data array using a comparison algorithm such as Myers' diff algorithm. The material viewing/editing unit clearly distinguishes and records an original text portion generated by an artificial intelligence model and a text portion edited by a human person in charge. The material viewing/editing unit classifies an intention of editing contents by natural language processing. The material viewing/editing unit generates, as output data, complete text data of an updated document, a unique version hash value, and metadata of an edited portion. As a specific output example from the system, there is a metadata set including an updated specification text, a hash value “a1b2c3d4”, and an editor identifier. As another output example from the system, there is a metadata set including an updated question answer text, a hash value “e5f6g7h8”, and a time stamp. The material viewing/editing unit transfers the extracted difference data and metadata to a learning data repository as subsequent processing. The system reuses the accumulated editing history data as teacher data for reinforcement learning and prompt optimization of a generative artificial intelligence model. The system identifies a frequently modified portion and automatically adjusts a weighting parameter at the time of next document generation. With this configuration, the system efficiently returns tacit knowledge possessed by human experts and specific requirements in the field to a knowledge base inside the system. The system forms a feedback loop that continuously improves generation accuracy of the model. The system saves storage capacity by storing only difference data. The system exhibits a technical effect of preventing a conflict during simultaneous editing by a plurality of persons and ensuring data consistency. The present technology exhibits high usefulness in a collaborative work platform where a large number of departments collaborate to create and review documents.

Briefing sessions, internal training, briefing sessions for member stores, briefing sessions for outsourcing contractors, briefing sessions for group companies, and the like are also implemented utilizing AI-generated materials. For example, the service operation department holds an internal briefing session on a new identity verification flow, the customer support department conducts training on a new procedure for customer response, and the sales department implements a new service briefing session for member stores. When a person in charge inputs a question from a terminal after a briefing session or during daily operations, the generative AI on the server immediately answers questions such as “What are specific contents of new identity verification requirements?”, “In what cases is an obligation to preserve transaction records applied?”, “At what timing should notification to customers be performed?”, “What are specific contents of an API specification change?”, “What is a basis for adding an audit item?”, “To what extent is a target range of a user compensation system?”, “How should response to outsourcing contractors be performed?”, and “What are legal points to note for pioneering a new market?” through the chatbot response unit with a prompt sentence “Answer the following question practically and specifically based on the main points of the legal revision and the business contents of the department”. Specifically, the chatbot response unit functions as an advanced question answering system adopting a retrieval-augmented generation architecture. The system includes a vector database storing internal regulations, legal revision information, and past response histories as multidimensional vectors. The chatbot response unit receives, as input data, a question text character string in a natural language transmitted from a terminal of a person in charge. The chatbot response unit converts the question text character string into, for example, a 1024-dimensional dense feature vector using an embedding model. As a specific input example to the system, there is a feature vector converted from a question text “What are specific contents of an application programming interface specification change?”. As another input example to the system, there is a feature vector converted from a question text “What is a basis for adding an audit item?”. The chatbot response unit searches the vector database using the generated question vector. The chatbot response unit extracts a plurality of chunks of a document most relevant to the question based on a distance measure such as a cosine similarity. The chatbot response unit combines the extracted document chunks and the original question text to construct an input prompt to a generative artificial intelligence model. The generative artificial intelligence model infers an answer based on the provided context. The chatbot response unit generates, as output data, an answer text in a natural language, an identifier of a reference source document, and a probability score indicating a certainty factor of the answer. As a specific output example from the system, there are an answer text explaining details of a specification change, a reference source “System Development Guidelines 3rd Edition”, and a certainty factor score of 0.92. As another output example from the system, there are an answer text explaining changes in audit criteria, a reference source “Internal Audit Manual Revised Edition”, and a certainty factor score of 0.88. The chatbot response unit evaluates the calculated certainty factor score as subsequent processing. The chatbot response unit suspends transmission of the answer text when the certainty factor score falls below a preset threshold. The chatbot response unit automatically generates an escalation request to a human expert and notifies a related department. The chatbot response unit collects feedback from a user regarding the answer and dynamically updates a weight of a search algorithm. With this configuration, the system prevents factual errors that can occur with a large language model alone. The system always provides an accurate answer based on the latest internal information in real time. The system significantly reduces a time required for information search by a person in charge. The system exhibits a technical effect of reducing a load of inquiry response work and improving business efficiency of the entire organization. The present technology is optimal for a help desk system or an internal portal site handling complex internal rules and frequently changed legal information.

In addition, the log management unit, the notification management unit, and the history management unit cooperate to centrally manage all processing histories of the system, user operation histories, AI output histories, response progress, notification histories, past legal revision response histories, and the like, and the notification management unit automatically distributes notifications such as “New legal revision information has been added”, “Your department has been selected as an affected department”, “A new response plan has been generated”, “Information on holding a briefing session”, “FAQ has been updated”, “There is an unaddressed task”, “Response to an outsourcing contractor is incomplete”, and “Material distribution to group companies has been completed”, and reminder notifications for unaddressed tasks. The history management unit records response contents and progress statuses at the time of past legal revisions in chronological order, and can utilize them as reference information at the time of future legal revisions. Specifically, the log management unit, the notification management unit, and the history management unit communicate with each other via an asynchronous messaging system based on an event-driven architecture. The log management unit continuously writes all events occurring in the system to a time-series database as structured log data with time stamps. The history management unit executes an analysis engine including a machine learning-based anomaly detection model and a task delay prediction model. The analysis engine acquires a feature vector indicating a progress status of a task extracted from the time-series database as input data. As a specific input example to the system, there is a numerical vector including an elapsed time since a specific task was created, a login frequency of a person in charge to the system, and the number of updates of related documents. As another input example to the system, there is numerical data indicating a difference between an average completion time in past similar tasks and a current elapsed time. The analysis engine processes these input data using a recurrent neural network or a gradient boosting decision tree algorithm. The analysis engine quantifies a risk that each task is not completed within a deadline. The analysis engine generates a delay probability score for each task and a corresponding alert level classification as output data. As a specific output example from the system, there are a delay probability score of 0.85 and an alert level “high” for a task identifier “TSK-1024”. As another output example from the system, there are a delay probability score of 0.42 and an alert level “low” for a task identifier “TSK-2048”. The notification management unit monitors the output delay probability score as a subsequent process. When detecting that the score exceeds a prescribed threshold, the notification management unit automatically generates and transmits a push notification message prompting an immediate response to terminals of the person in charge and a manager of the corresponding task. The notification management unit tracks an opening status of the notification and subsequent task progress, and dynamically adjusts a re-notification schedule as necessary. The history management unit aggregates log data of completed tasks and calculates a response performance index for each department. With this configuration, the system proactively predicts a delay risk of a project by a data-driven approach, not limited to mere information recording or routine reminders. The system enables the manager to take measures before a problem occurs. The system minimizes a risk of compliance violation in a project in which a deadline is strictly set, such as a response to a legal revision. The system exerts a technical effect of visualizing an operating status of the entire system and optimizing resource allocation. The present technology plays an extremely important role in an enterprise project management system that manages a large-scale and complex workflow.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

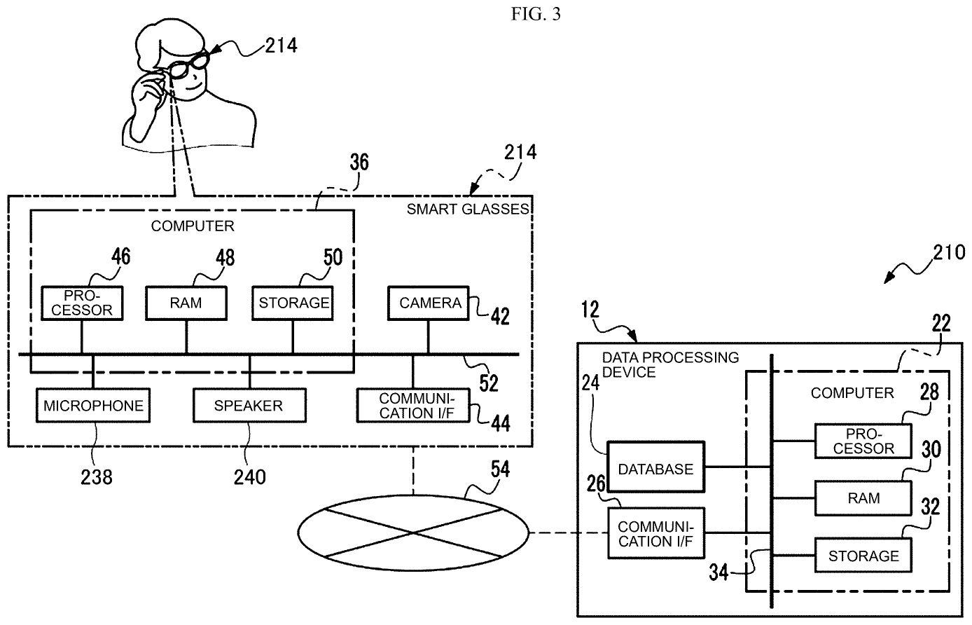

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

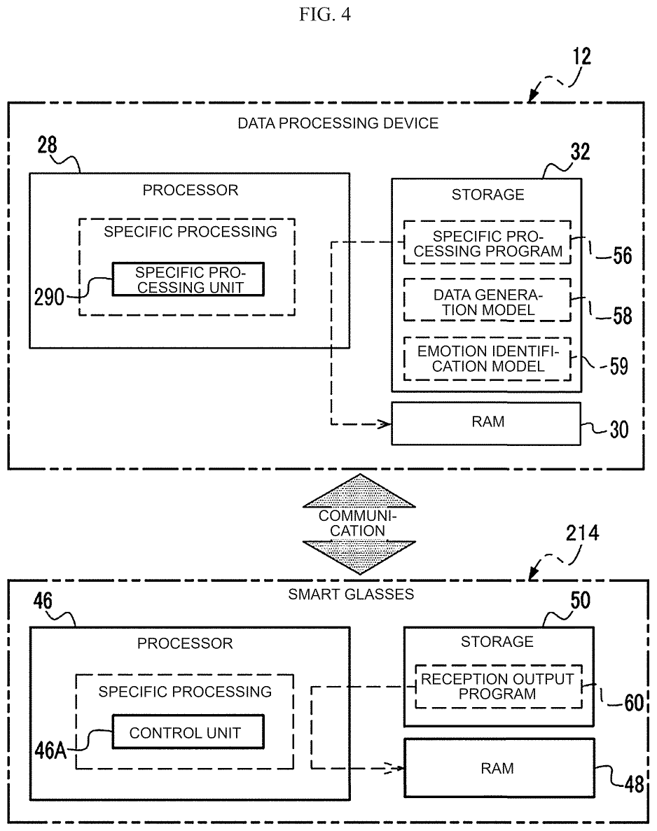

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### (Example 1)

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

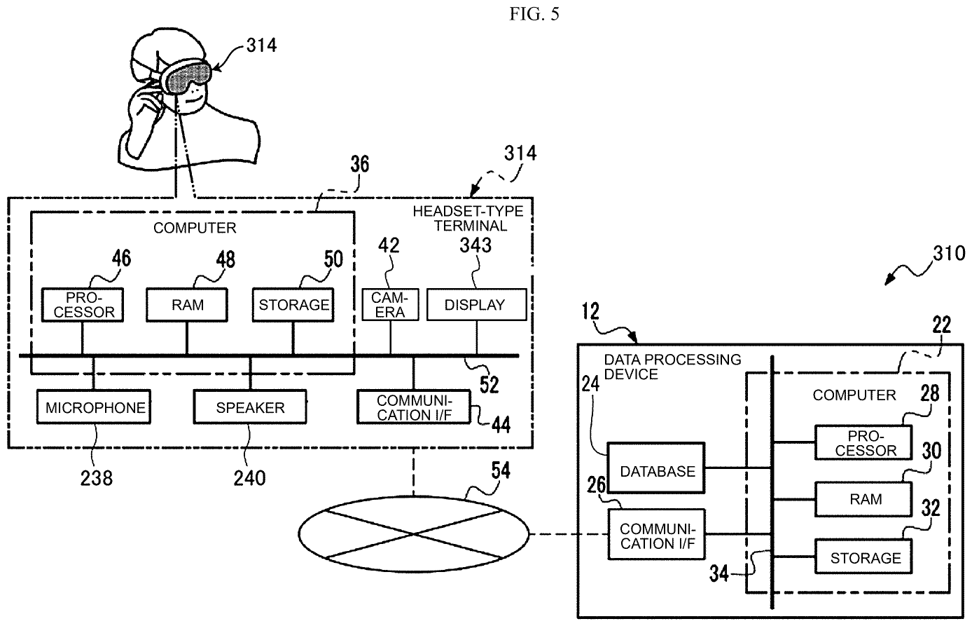

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

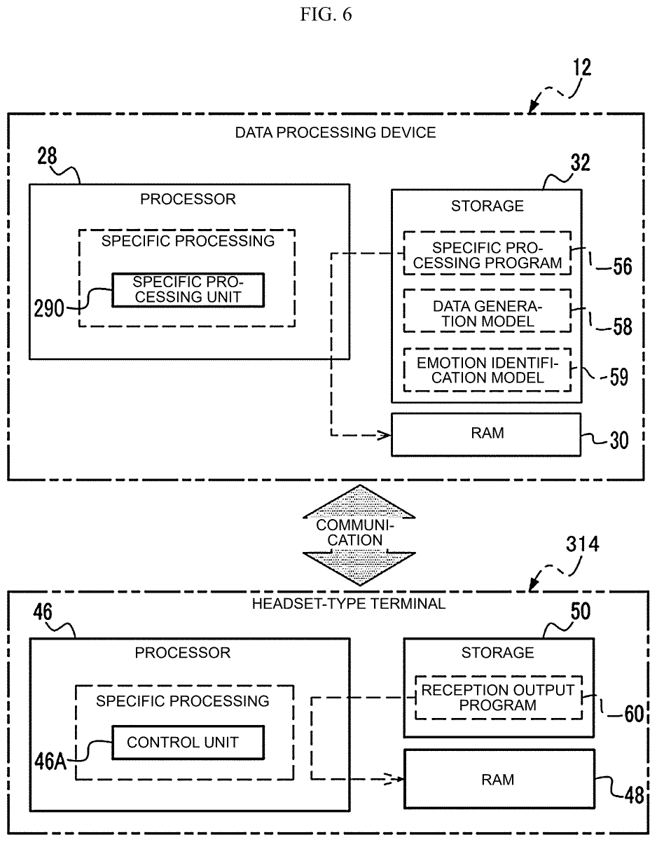

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

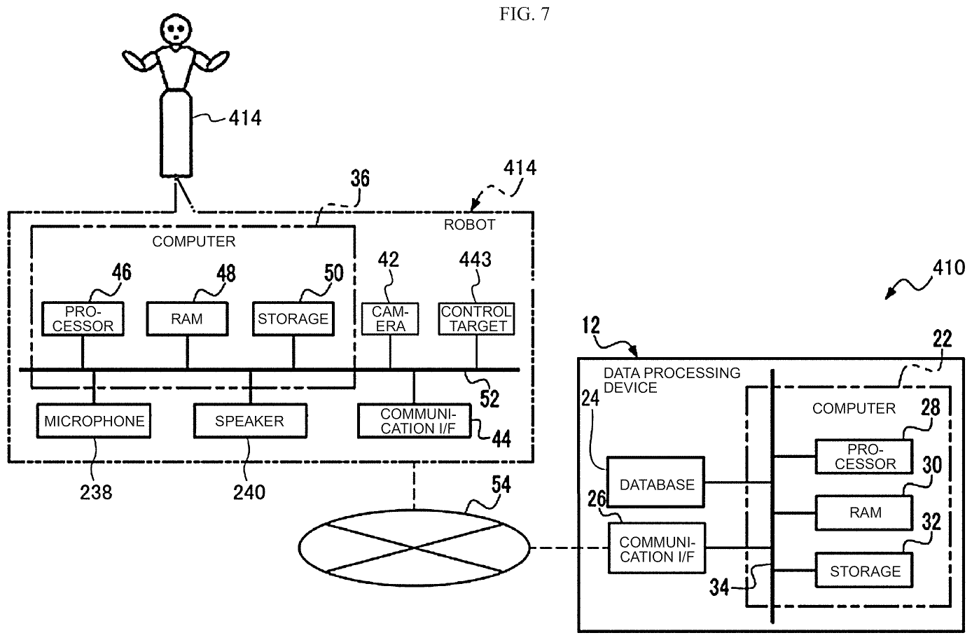

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

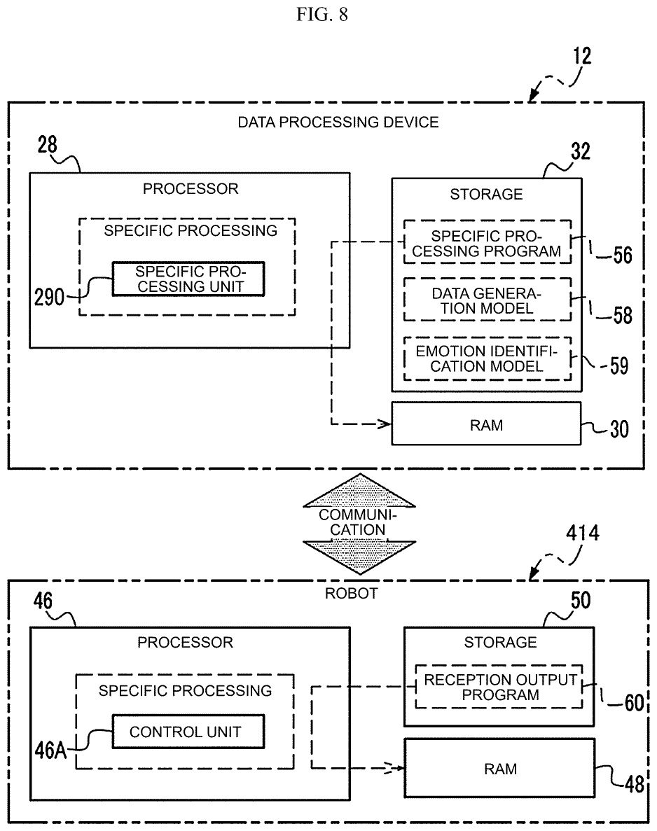

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

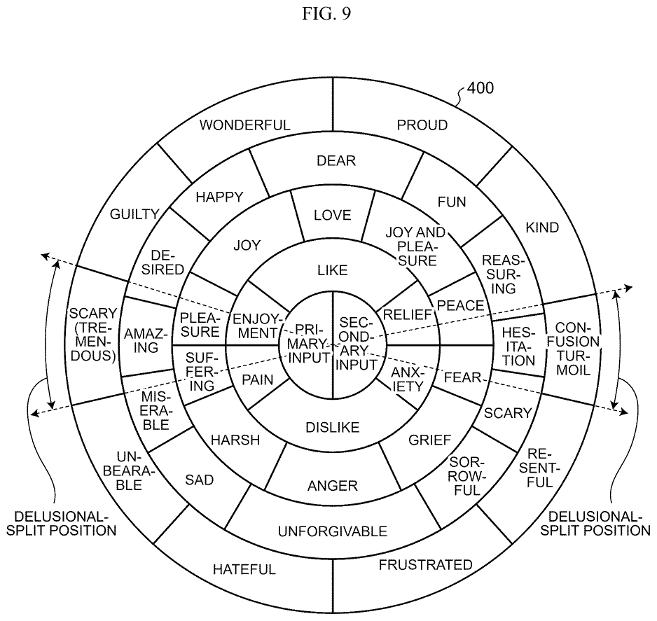

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

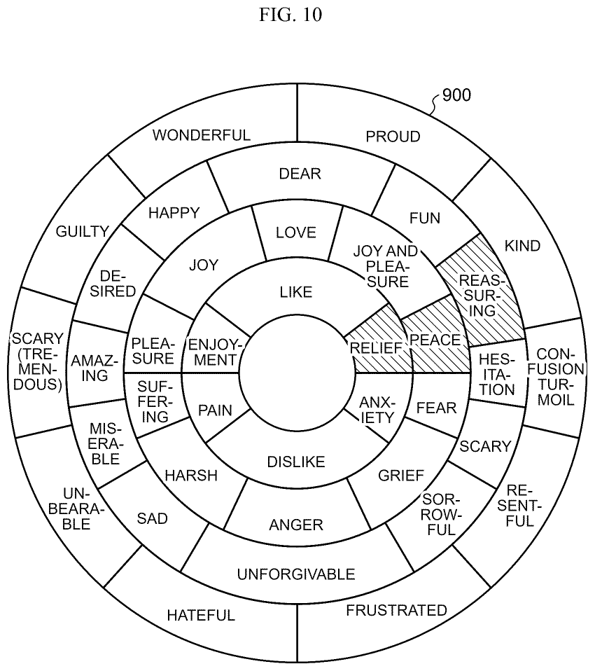

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### (Supplementary Note 1)

A system for supporting response to legal revisions in an electronic payment service, comprising: a legal revision information acquisition unit; an affected department determination unit; and a response plan generation unit, wherein the legal revision information acquisition unit has a function of automatically analyzing a variety of legal revision-related documents such as revised legal texts of a plurality of laws and regulations related to the electronic payment service including the Payment Services Act, the Act on Prevention of Transfer of Criminal Proceeds, consumer protection-related laws, the Act on Preservation of Electronic Books, tax reforms, and the Act on the Protection of Personal Information, guidelines, administrative agency notices, industry association views, reference judicial precedents, administrative guidance documents, and public comments using generative AI, and extracting and summarizing a purpose of revision, revision points, a time of enforcement, new rules to be complied with, an impact on an industry, added obligations, strengthening of penal provisions, transitional measures, and the like; the affected department determination unit has a function of matching a database of business contents, business flows, areas of charge, managed assets, outsourcing contractors, related systems, used data types, existing regulations/manuals, training materials, past legal revision response histories, and the like of each department such as a service operation department, a system development department, a customer support department, a risk management department, and a sales department with main points of the legal revision extracted by the legal revision information acquisition unit using generative AI, multilaterally analyzing a relevance between the business contents of each department and legal revision contents to automatically determine an affected department, and preferentially selecting a department with a high degree of impact; and the response plan generation unit has a function of automatically generating, for each department determined to be affected, an operation flow change proposal, a system specification change proposal, a customer notification proposal, a modification proposal for an existing manual, a new identity verification service proposal, and the like as a specific response plan based on the legal revision using generative AI, further proposing a new business opportunity newly enabled by the legal revision, additionally automatically generating a dissemination material of the legal revision contents, a FAQ draft, a script for a briefing session, and a customer notification template for each department, and immediately answering a question after the briefing session or during daily operations by a chatbot using generative AI.

### (Supplementary Note 2)

The system according to Supplementary Note 1, wherein the response plan generation unit has a function of analyzing contents of operation and management implemented in the affected department using generative AI, specifically proposing which material or operation flow should be modified and how, automatically generating an operation explanation material and a customer notification template after modification, and further proposing a possibility of a new business caused by the legal revision for each department.

### (Supplementary Note 3)

The system according to Supplementary Note 1, wherein the legal revision information acquisition unit has a function of automatically analyzing a plurality of legal revision-related documents such as revised legal texts, guidelines, administrative agency notices, industry association views, and public comments using generative AI, extracting and summarizing a purpose of revision, revision points, a time of enforcement, new rules to be complied with, an impact on an industry, added obligations, strengthening of penal provisions, transitional measures, and the like, and further automatically linking a summary result thereof to the affected department determination unit and the response plan generation unit.

What is claimed is:

1. A system comprising:
circuitry configured to:
receive, via a communication interface coupled to a packet-switched network, reference document data comprising regulatory revision texts, guideline records, and commentary documents from external data service endpoints, and store the reference document data in a storage device;
apply a natural language processing model to the reference document data to extract revision point feature vectors, effective date parameters, applicability scope labels, and impact classification labels, and index the extracted data as reference record embedding vectors in a vector database;
apply the natural language processing model to organizational process data records stored in the storage device to generate process embedding vectors, compute cosine similarity scores between the process embedding vectors and the reference record embedding vectors, and generate an affected process record set comprising process identifiers having cosine similarity scores exceeding a relevance threshold;
apply a generative neural network model to the affected process record set and context data retrieved from the vector database to generate response plan data records comprising operation modification sequences and document update sequences for each affected process identifier; and
transmit the affected process record set and the response plan data records to terminal devices via the communication interface.

2. The system according to claim 1, wherein the circuitry is configured to monitor external regulatory data service endpoints via periodic polling to detect new reference document data, compute a change detection score between new reference record embedding vectors and existing reference record embedding vectors for matching document identifiers using cosine similarity, and trigger a re-analysis pipeline when the change detection score falls below a change threshold parameter.

3. The system according to claim 2, wherein the circuitry is configured to apply a named entity recognition model to the new reference document data to extract effective date parameters and applicability scope labels, compare the extracted effective date parameters against a current timestamp, and generate an urgency classification label indicating a time-to-compliance interval.

4. The system according to claim 1, wherein the circuitry is configured to apply a multi-stage retrieval process to generate the affected process record set by first selecting candidate process identifiers using approximate nearest neighbor indexing, then reranking using a cross-encoder relevance model jointly encoding the revision point feature vector and each candidate process embedding vector.

5. The system according to claim 4, wherein the circuitry is configured to compute a relevance score for each process identifier in the affected process record set by applying the cross-encoder relevance model, sort the affected process record set in descending order of relevance score, and incorporate relevance scores as priority weights in the response plan data record generation process.

6. The system according to claim 1, wherein the circuitry is configured to generate the response plan data records by constructing a retrieval-augmented generation prompt comprising the revision point feature vectors, the affected process record set, and historical response plan records retrieved from the vector database, and generating operation modification sequences and document update sequences by autoregressive decoding.

7. The system according to claim 6, wherein the circuitry is configured to store generated response plan data records in the storage device with a version identifier, document the basis of each operation modification sequence by including source reference identifiers from the reference document data, and generate a confirmation receipt data record when a terminal device returns an acknowledgment response.

8. The system according to claim 1, wherein the circuitry is configured to apply the generative neural network model to incoming query text data from a terminal device relating to a specific response plan data record, retrieve relevant reference document sections from the vector database by cosine similarity search, and generate a natural language explanation text comprising a rationale and regulatory basis for the queried response plan data record.

9. The system according to claim 1, wherein the circuitry is configured to store all reference document data updates, affected process record sets, and response plan data records with timestamps in an audit log data structure in the storage device, and generate a compliance history report from the audit log data structure for transmission to terminal devices associated with administrative user identifiers.

10. The system according to claim 1, wherein the circuitry is configured to receive document file data from terminal devices via the communication interface, apply the natural language processing model to generate document embedding vectors, compute cosine similarity between the document embedding vectors and reference record embedding vectors to identify applicable regulatory references, and generate a compliance assessment data record indicating whether the document satisfies the applicable regulatory requirements.

11. The system according to claim 10, wherein the circuitry is configured to generate a document modification proposal data record by applying the generative neural network model to the compliance assessment data record and the document file data, the document modification proposal data record comprising specific section modification recommendations with associated regulatory reference identifiers.

12. The system according to claim 1, wherein the circuitry is configured to deploy each processing unit as an independent microservice in a containerized orchestration environment, execute the natural language processing model on dedicated computation nodes equipped with graphics processing units, and route requests between microservices via a message queue using a publish-subscribe model.

13. The system according to claim 1, wherein the circuitry is configured to transmit notification message data to terminal devices associated with each affected process identifier via the communication interface when a new affected process record set is generated, the notification message data comprising a summary of revision impact and a compliance deadline parameter derived from the effective date parameter.

14. The system according to claim 1, wherein the circuitry is configured to update the generative neural network model by generating training pairs from historical response plan data records and corresponding validated compliance outcome records, and fine-tune the generative neural network model on the training pairs to improve response plan accuracy for specific regulatory domain patterns.

15. The system according to claim 1, wherein the circuitry is configured to enforce a role-based access control policy by associating reference record categories with required user role parameters, and restrict the retrieval set to reference records within the permission scope of the requesting terminal device user role parameter.

16. The system according to claim 1, wherein the circuitry is configured to generate a cross-organization impact summary data record by aggregating affected process record sets across all organizational unit identifiers, computing aggregate impact scores by category, and transmitting the cross-organization impact summary data record to terminal devices associated with senior administrative user identifiers.

17. The system according to claim 1, wherein the reference document data comprises regulatory revision texts and associated commentary records from external regulatory data service endpoints, and the organizational process data records describe operational procedures and documentation for a plurality of organizational units.

18. A system comprising:
circuitry configured to:
receive, via a communication interface coupled to a packet-switched network, reference document data from external regulatory data service endpoints;
apply a natural language processing model to extract revision point feature vectors, effective date parameters, and applicability scope labels, and index extracted data as reference record embedding vectors in a vector database;
compute cosine similarity scores between process embedding vectors derived from organizational process data and the reference record embedding vectors, and apply a cross-encoder reranking model to generate a relevance-sorted affected process record set;
apply a generative neural network model to generate response plan data records comprising operation modification sequences by retrieval-augmented generation from the vector database; and
transmit the affected process record set and response plan data records to terminal devices, and generate natural language explanation text for queried response plan data records.

19. The system according to claim 18, wherein the circuitry is configured to monitor external regulatory data service endpoints via periodic polling to detect new reference document data, compute change detection scores between new and existing reference record embedding vectors, and trigger a re-analysis pipeline when the change detection score falls below a change threshold parameter.

20. A method comprising:
receiving, via a communication interface coupled to a packet-switched network, reference document data from external data service endpoints, and storing the reference document data in a storage device;
applying a natural language processing model to extract revision point feature vectors, effective date parameters, applicability scope labels, and impact classification labels, and indexing the extracted data as reference record embedding vectors in a vector database;
computing cosine similarity scores between process embedding vectors generated from organizational process data and the reference record embedding vectors, and generating an affected process record set comprising process identifiers having cosine similarity scores exceeding a relevance threshold;
applying a generative neural network model to generate response plan data records for each affected process identifier by retrieval-augmented generation from the vector database; and
transmitting the affected process record set and response plan data records to terminal devices via the communication interface.
